(19) United States
(12) Patent Application Publication
(10) Pub. No.: US 2015/0055961 A1
(43) Pub. Date: Feb. 26, 2015

(54) SYSTEM AND METHOD FOR QUANTUM BASED INFORMATION TRANSFER

(71) Applicant: U.S. Army Research Laboratory, Adelphi, MD (US)

(72) Inventors: Ronald E. MEYERS, Columbia, MD (US); Keith S. DEACON, Coumbia, MD (US)

(73) Assignee: U.S. Army Research Laboratory, Adelphi, MD (US)

(21) Appl. No.: 14/510,464

(22) Filed: Oct. 9, 2014

Related U.S. Application Data
(63) Continuation-in-part of application No. 13/948,660, filed on Jul. 23, 2013.
Application No. 13/948,660 is a continuation-in-part of application No. 12/705,566, filed on Feb. 12, 2010, now Pat. No. 8,503,885.
Application No. 12/705,566 is a continuation-in-part of application No. 11/196,738, filed on Aug. 4, 2005, now Pat. No. 7,660,533.
(60) Provisional application No. 60/598,537, filed on Aug. 4, 2004.

(51) Int. Cl. H04B 10/70; H04B 10/60; H04B 10/50

(52) U.S. Cl. CPC H04B 10/70; H04B 10/50; H04B 10/60
USPC 398/140

(57) ABSTRACT

A system for communicating data comprising sender and receiver subsystems; at least one data input; at least one entangled photon source; first photons of the pairs of entangled photons outputted by the at least one photon source being processed by one of the sender or receiver subsystem; second photons of the pairs of entangled photons being processed by the other of the sender or receiver subsystem; a photonic element configured to receive the first photons of the pairs of entangled photons and enable interference therebetween; at least one absorber configured to absorb the first photons after passage through the beam splitter, the absorbance of the first photons operating to transfer the properties of the entanglement to the second photons of the pairs of entangled photons; and a Bell state measurement element operatively associated with the receiver subsystem configured to measure the second photons of the pairs of entangled photons.

### CROSS REFERENCE TO RELATED APPLICATIONS

This application claims priority to and the benefit of U.S. patent application Ser. No. 13/948,660 (ARL 04-62CIP2), filed Jul. 23, 2013 by Ronald E. Meyers and Keith S. Deacon, entitled Quantum Based Information Transfer System And Method,” which is a continuation-in-part of and claims priority to application Ser. No. 12/705,566 (ARL 04-62 CIP), entitled “Quantum Based Information Transmission System and Method,” filed Feb. 12, 2010, which issued as U.S. Pat. No. 8,503,885 on Aug. 6, 2013, by Ronald E. Meyers and Keith S. Deacon the inventors herein, which in turn claims priority to U.S. application Ser. No. 11/196,738 (ARL 04-62), filed Aug. 4, 2005, which issued as U.S. Pat. No. 7,660,533 on Feb. 9, 2010, by Ronald E. Meyers and Keith S. Deacon, and U.S. Provisional Patent Application Ser. No. 60/598,537 filed Aug. 4, 2004, all four of which are incorporated herein by reference.

### GOVERNMENT INTEREST

The invention described herein may be manufactured, used, and licensed by or for the United States Government without the payment of a royalty.

### BACKGROUND OF THE INVENTION

This invention relates in general to methods and apparatus for processing, compression, and/or transmission of data based upon quantum properties. Quantum properties include quantum entanglement and quantum teleportation of information, which is linked to the property of quantum entanglement. Quantum entanglement can exist between any two quantum systems such as between two photons, two atomic/ionic systems, or between a photon and an atom/ion based quantum system. The prior art system depicted in FIG. 1A is a layout for the demonstration of the Duan, Lukin, Cirac and Zoller (DLCZ) protocol 1 wherein laser beams through atomic ensembles L and R generate optical fields 1 and 2 from spontaneous Raman scattering. These optical fields 1 and 2 interfere on a Beam Splitter BS resulting in L and R atomic ensembles becoming entangled. A Bell state measurement is performed with detection by detectors D1 and D2. In FIG. 1B a phase stable scheme is proposed for entangling distant atomic ensembles through two-photon Hong-Ou-Mandel type interference. Note that a Bell state measurement is depicted in the center of FIG. 1B.

Quantum communications may sometimes be used in conjunction with compression techniques involving the usage of qubits, as shown in FIGS. 2A-2D. Qubits are units of quantum information that may be visualized by a state vector in a two-level quantum-mechanical system. Unlike a binary classical bit, a qubit can have the values of zero or one, or a superposition of both. A qubit may be measured in basis states (or vectors) and a conventional Dirac symbol is used to represent the quantum state values of zero and one herein, as for example, |0 [symbol] and |1 [symbol] . For example, on a physical qubit this may be implemented by assigning the value “0” to a horizontal photon polarization and the value “1” to the vertical photon polarization. The “pure” qubit state is a linear superposition of those two states which can be represented as a combination of |0 [symbol] and |1 [symbol] or qₖ=Aₖ|0 [symbol] +Bₖ|1 [symbol] , or in generalized form as Aₙ|0 [symbol] and Bₙ|1 [symbol] where Aₙ and Bₙ represent the corresponding probability amplitudes and Aₙ²+Bₙ²=1. FIG. 2A is a diagrammatic visualization of a three-qubit quantum binary tree, which has an information storage index space equivalency to eight classical bits; i.e., 3 qubits provide an index space of 8. Unlike classical bits, a qubit can exhibit quantum properties such as quantum entanglement, which allows for higher correlation than that possible in classical systems. A pair of photons which are entangled can be referred to as an entangled photon pair. When one photon of an entangled photon pair is measured, the determination of the state of that photon (such as polarization or angular momentum) in effect determines the state of the other photon of the entangled photon pair, since entangled photon pairs are the conjugates of one another. In this example, each photon of the entangled pair may be considered a half of the entangled photon pair.

### SUMMARY OF THE INVENTION

The present invention is directed to a preferred embodiment system for communicating data comprising a sender subsystem; a receiver subsystem; at least one data input configured to input data into the sender subsystem; at least one entangled photon source configured to output entangled photon pairs; first photons of the pairs of entangled photons outputted by the at least one photon source being processed by one of the sender or receiver subsystem; second photons of the pairs of entangled photons being processed by the other of the sender or receiver subsystem; a photonic element configured to receive the first photons of the pairs of entangled photons and enable interference therebetween; at least one absorber configured to absorb the first photons of the pairs of entangled photons after passage through the beam splitter, the absorbance of the first photons of the pairs of entangled photons operating to transfer the properties of the entanglement to the second photons of the pairs of entangled photons; and a Bell state measurement element operatively associated with the receiver subsystem; the Bell state measurement element configured to measure the second photons of the pairs of entangled photons.

Optionally, either the at least one entangled photon source or the reception of first photons of the pairs of entangled photons by the first beam splitter may be controlled by an operator or computer to enable the transmission of a message. Optionally, the photonic element may take the form of a beam splitter and the at least absorber may be at least one detector that is configured to measure the Bell state of the first photons of the pairs of entangled photons passing through the first beam splitter. This measurement would correlate to the Bell state measured by the Bell state measurement element operatively associated with the receiver.

As a further option, the system may comprise an interrupt, such as a shutter, for example, controlled by the operator or a computer configured to prevent one or more of the first photons of the pairs of entangled photons from being inputted into the first beam splitter thereby operating to transmit an encoded message. The sender subsystem may further comprise at least one processor operatively associated with the interrupt and the at least one detector and at least one delay element, the at least one delay element configured to delay photons such that photons emitted from the at least one entangled photon source at different times are inputted synchronously into the first beam splitter operatively associated with the sender and the Bell state measurement element operatively associated with the receiver.

Optionally, the at least one entangled photon source comprises first and second entangled photon sources, the first entangled photon source being operatively associated with the sender subsystem and the second entangled photon source being operatively associated with the receiver subsystem. In addition, the at least one absorber may comprise at least one detector configured to measure the Bell state, such that the measurement of the Bell state of the first photons of the pairs of entangled photons occurs at substantially the same time as the measurement by the Bell state measurement element operatively associated with the receiver subsystem. Optionally, delay elements may be positioned within at least one of the sender or receiver subsystems to ensure coincidence of measurements of the Bell states. Optionally, sender subsystem further comprises a second beam splitter operatively associated with the at least one entangled photon source, the second beam splitter configured to split the first photons into first and second paths, the first and second paths operating to pass photons from the second beam splitter to the first beam splitter, the second path comprising a first delay element, the first delay element being configured such that first photons from the first and second paths enter the first beam splitter synchronously. Optionally, the receiver subsystem may further comprise a third beam splitter operatively associated with the at least one entangled photon source the third beam splitter configured to split the second photons into third and fourth paths, the third and fourth paths operating to pass photons from the third beam splitter to the Bell state measurement element operatively associated with the receiver subsystem, the fourth path comprising a second delay element, the second delay element being configured such that second photons from the third and fourth paths enter the Bell State measurement element synchronously.

The present invention is also directed to an alternate preferred embodiment system for communicating data comprising a transmitter subsystem; a receiver subsystem; at least one data input configured to input data into the transmitter subsystem; first, second and third entangled photon sources configured to output entangled photon pairs; first photons of the pairs of entangled photons outputted by the first, second and third entangled photon sources being processed by one of the transmitter or receiver subsystems; second photons of the pairs of entangled photons outputted by the first, second and third entangled photon sources being processed by the other of the transmitter or receiver subsystems; a first Bell state measurement element operatively associated with the transmitter; the first Bell state measurement element configured to measure the first photons of the pairs of entangled photons from the first and second entangled photon sources; a second Bell state measurement element operatively associated with the receiver system; the Bell state measurement element configured to measure the second photons of the pairs of entangled photons from the first and second entangled photon sources; a data source for the input of information; a third Bell state measurement element operatively associated with the transmitter, receiver and the data source, the third Bell state measurement element operative to measure photons representing data from the data source in conjunction with the one of pairs of photons from the third photon source; a unitary transform device operatively associated with the receiver subsystem, the unitary transform device configured to receive the other of the pairs of photons from the third entangled photon source and to output photons representing data from the data source; and an output measurement element operatively associated with the receiver; the output measurement element configured to measure the outputted photons from the unitary transform device representing data from the data source.

As an option, the alternate preferred embodiment may comprise at least one processor operatively connected to the unitary transform device and the second Bell state measurement element wherein upon being measured at the Bell state measurement element the entanglement is transferred from the first of the first photons of the pairs of entangled photons from the first and second photon sources to the second photons of the pairs of entangled photons from the first and second photon sources, and wherein the second Bell state measurement element measures the results of the swapped entanglement and transfers the results to the at least one processor which supplies the Bell state measured by the second Bell state measurement element to the unitary transform device which is used to output data from the data source. As a further option, the first, second and third entangled photon sources may be synchronously emitted. Optionally, the alternate preferred embodiment comprises an interrupt configured to prevent one or more of the first photons of the pairs of entangled photons from being measured by the first Bell state measurement device, the interrupt being operable to send an encoded message from the sender subsystem to the receiver subsystem.

The present invention is also directed to an alternate preferred embodiment system for communicating data comprising a transmitter subsystem; a receiver subsystem; a data source configured to input information in the form of qubits; the information to be transmitted from the transmitter to the receiver subsystem; at least one entangled photon source configured to output entangled photon pairs; first photons of the at least one entangled photon sources being inputted into the transmitter subsystem and second photons of the at least one entangled photon source being inputted into to the receiver subsystem; a first photonic element having two inputs; one input configured for input of a qubit from the data source and one input configured for input of a first photons of pairs of entangled photons from the at least one entangled photon source; the first photonic element having two outputs; first and second Bell state measurement elements operatively associated with the transmitter subsystem, each having first and second inputs and each of the first inputs operatively connected to one of the output ports of the first photonic element; the second inputs of the first and second Bell state measurement elements configured to receive first photons from the at least one entangled photon source; at least one processor operatively associated with the receiver subsystem; and at least one receiver Bell state measurement element operatively associated with the receiver subsystem; the at least one receiver Bell state measurement element configured to receive as an input at least one of the second photons of the pairs of photons from the at least one entangled photon source and provide a measurement to the at least one processor; whereby through the process of entanglement swapping, information is transferred from the first photons to the second photons of the pairs of photons from the at least one entangled photon source, and though measurement by the at least one receiver Bell state measurement element, information is transferred from the transmitter to the receiver subsystem.

Optionally, the first photonic element is a beam splitter and the first and second Bell state measurement devices each comprise at least one beam splitter and at least two detectors. The receiver subsystem may comprise a unitary transform device operatively associated with the at least one processor that is configured to receive as input second photons of the pairs of photons from the at least one entangled photon source; the second photons having swapped entanglement from the first photons of the pairs of photons from the at least one entangled photon source, such that qubits of data are transferred from the transmitter subsystem to the receiver subsystem through the process of swapped entanglement. When measurement is undertaken at the second Bell state measurement element, entanglement is swapped to the second photons of the first entangled photon source at the unitary transform device and the second photons of the second and third entangled photon sources inputted into the receiver Bell state measurement element; and the unitary transform device processes the information contained in the second photons from the first entangled photon source in conjunction with information outputted from the receiver Bell state measurement device to derive the information contained in the qubits.

As a further option, the alternate preferred embodiment comprises at least one delay element controlled by the at least one processor, the first, second and receiver Bell state measurement devices are synchronously operated, and the at least one processor comprises a first processor operatively associated with the transmitter subsystem and a second processor operatively associated with the receiver subsystem and wherein the first and second processors operate to control the at least one delay element.

### BRIEF DESCRIPTION OF THE DRAWINGS

FIG. 1A is a prior art layout for the demonstration of DLCZ protocol 1 wherein atoms L and R are entangled and a Bell state measurement is performed with detection by detectors D1 and D2.

FIG. 1B illustrates a prior art phase stable scheme for entangling distant atomic ensembles through two-photon Hong-Ou-Mandel type interference.

FIG. 2A is a schematic depicting a three qubit quantum binary tree to illustrate an information storage index space equivalency to eight classical bins.

FIG. 2B is schematic depiction of the first level branching of the three qubit quantum binary tree of FIG. 2A.

FIG. 2C is schematic depiction of the second level branching of the three qubit quantum binary tree of FIG. 2A.

FIG. 2D is schematic depiction of the third level branching of the three qubit quantum binary tree of FIG. 2A.

FIG. 3 is a schematic illustration of an optical bench configured as a quantum computer system using a Type-II nonlinear optics crystal and a polarization Mach-Zehnder interferometer to perform a quantum Fourier transform (QFT).

FIG. 4 is a schematic illustration of an optical bench configured as a quantum computer system using a Type-II nonlinear optics crystal and a polarization Michelson interferometer to perform a QFT.

FIG. 5 is a schematic illustration of an optical bench configured as a quantum computer system using a Type-I nonlinear optics crystal and a polarization Sagnac interferometer to perform a QFT.

FIG. 6 is a schematic illustration of an optical bench configured as a quantum computer system using a Type-I nonlinear optics crystal and a polarization Mach-Zehnder interferometer to perform a QFT.

FIG. 7 is a schematic illustration of an optical bench configured as a quantum computer system using a Type-I nonlinear optics crystal and a polarization Michelson interferometer to perform a QFT.

FIG. 8 is a schematic illustration of an optical bench configured as a quantum computer system using a Type-I nonlinear optics crystal and a polarization Sagnac interferometer to perform a QFT.

FIG. 9 is a series of 32 normalized sound spectrum samples depicted as a quantized histogram of amplitudes, black line and gray line overlies denoting classical and quantum Fourier transforms of the sample, respectively.

FIG. 10A is a schematic depiction of an alternate preferred embodiment system wherein a qubit of converted data is transferred to the receiver as a photon state and wherein a classical channel transmits two bits to indicate how to measure the remaining photon.

FIG. 10B is a schematic depiction of an alternate preferred embodiment system of the present invention resembling in configuration FIG. 10A using a distant entangled atom pair and wherein a classical channel transmits two bits to indicate how to measure the remaining entangled atom system.

FIG. 11A is a schematic depiction of an alternate preferred embodiment system of the present invention resembling in configuration FIG. 10B wherein the interference products P2-Q1 from Beam splitter 251 are sent to detectors 252A and 253A at the receiver.

FIG. 11B is a schematic depiction of an alternate preferred embodiment system of the present invention resembling in configuration FIG. 10B further comprising a second entangled source.

FIG. 12 is a schematic depiction of a preferred embodiment system used for exfiltration from a sensor of remotely generated information comprising an entangled photon source and a distant sensor that modulates an entangled photon.

FIG. 13 is a schematic depiction of an alternate preferred embodiment utilizing a Mach-Zehnder configuration, wherein a single qubit of quantum information is frequency/wavelength converted prior to transmission, detection, or manipulation to a more favorable frequency/wavelength.

FIG. 14 is a schematic depiction of an alternate preferred embodiment of FIG. 13 with the inclusion of an optical delay line to fine tune the overlap of the wavefunction components on PBS 2.

FIG. 15 is a schematic depiction of an alternate preferred embodiment system 300B utilizing a Sagnac configuration, wherein a single qubit of quantum information encoded into a photon is frequency/wavelength converted prior to transmission, detection, or manipulation to a more favorable frequency/wavelength.

FIG. 16 is a schematic of an optical bench configured as a quantum computer system according to the present invention using a Type-II nonlinear optics crystal and a polarization Sagnac interferometer to perform a QFT operatively connected to two Quantum Frequency Conversion (QFC) devices to help mitigate photonic qubit losses due to propagation through media between the sender and receiver;

FIG. 17 is a schematic depicting a two Bell state quantum quad tree to illustrate an information storage index space equivalency to sixteen classical bins.

FIG. 18 is a schematic block diagram illustration of an alternate preferred embodiment information transfer system for transference of data from a sender to a receiver using at least two entangled photon sources and a quantum quad-tree decomposition of a message or signal and comprising coincidence electronics 42 used to reconstruct a data set, such as determining the next branch of a quantum tree.

FIG. 19A schematically illustrates an alternate preferred embodiment which resembles the embodiment shown in FIG. 18. FIG. 19A further includes, inter alia, a third entangled photon source for transfer of qubits of information from the sender to a receiver.

FIG. 19B is a flow chart explaining some of the significant operations and/or steps associated with the embodiment of FIG. 19A.

FIG. 19C schematically illustrates an alternate preferred embodiment which includes some of the elements of FIG. 19A, including a third entangled photon source for transfer of qubits of information from the sender to a receiver, and further includes, inter alia, a beam splitter 251B located with the sender.

FIG. 19D is a flow chart explaining some of the significant operations and/or steps associated with the embodiment of FIG. 19C

FIG. 20 is a schematic block diagram illustration of an alternate preferred embodiment information transfer system for transference of information from a sender to a receiver using at least two entangled photon sources and comprising a polarizing element 530 to set the polarization of input photon P1 to a specified value and Elements 531A and 531B on the receiver end which are polarization analyzers comprised of polarizers, half wave plates, and quarter wave plates that are operative to set photons P3 and P4 to specified polarizations for measurement by detectors 84 and 86 for quantum state tomography.

FIG. 21 is a schematic block diagram illustration of an alternate preferred embodiment information transfer system for transference of information from a sender to a receiver using at least two entangled quantum memories and an optional shutter device 520 or controller 526 for encoding information to be transmitted.

FIG. 22 is a schematic block diagram illustration of an alternate preferred embodiment information transfer system for transfer of information from a sender to a receiver using a single entangled photon source where photons are entangled with later occurring photons due to delaying techniques.

FIG. 23 is a schematic block diagram illustration of an alternate preferred embodiment information transfer system for transfer of information from a sender to a receiver using, inter alia, two pairs of entangled quantum memories 546A, 546B, and an optional shutter 525.

### DETAILED DESCRIPTION OF THE PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skilled in the art to practice the embodiments of the invention. Accordingly, the examples should not be construed as limiting the scope of the embodiments of the invention.

This description and the accompanying drawings that illustrate inventive aspects and embodiments should not be taken as limiting-the claims define the protected invention. Various changes may be made without departing from the spirit and scope of this description and the claims. In some instances, well-known structures and techniques have not been shown or described in detail in order not to obscure the invention. Additionally, the drawings are not to scale. Relative sizes of components are for illustrative purposes only and do not reflect the actual sizes that may occur in any actual embodiment of the invention. Like numbers in two or more figures represent the same or similar elements. Elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

The terminology used herein is for the purpose of describing particular embodiments only and is not intended to limit the full scope of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that, although the terms first, second, etc. may be used herein to describe various elements, components, regions, layers and/or sections, these elements, components, regions, layers and/or sections should not be limited by these terms. For example, when referring first and second entangled photon regions, these terms are only used to distinguish one entangled photon source, region, element, component, layer or section from another source, region, element, component, layer or section. Thus, a first source, region, element, component, layer or section discussed below could be termed a second source, region, element, component, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

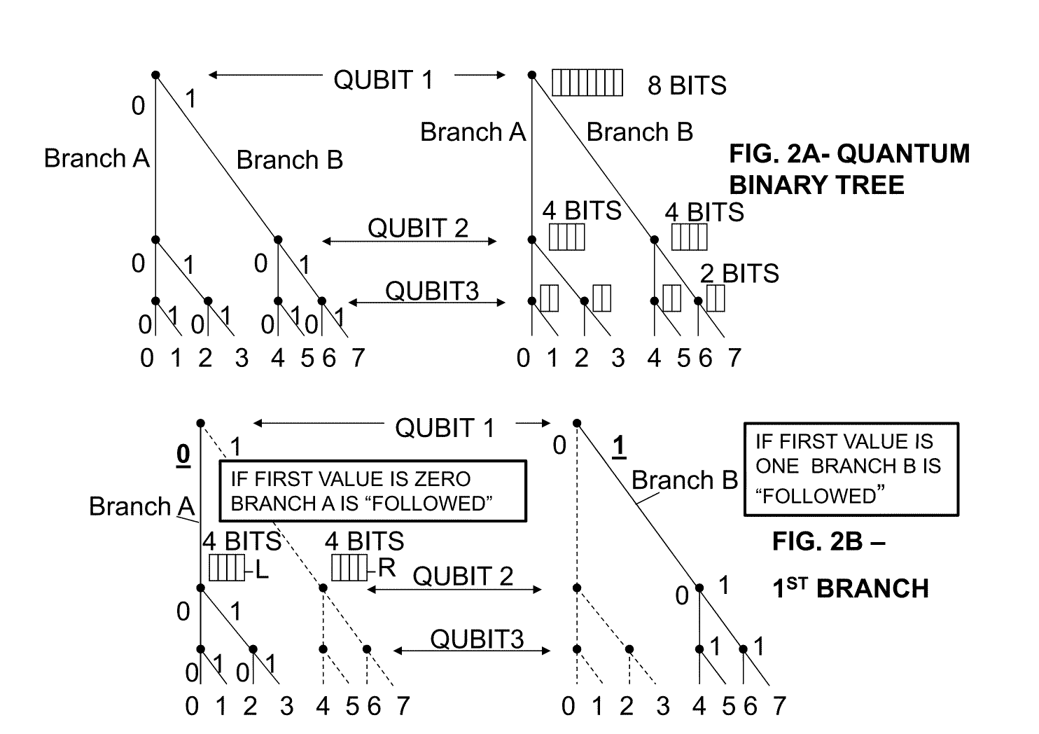

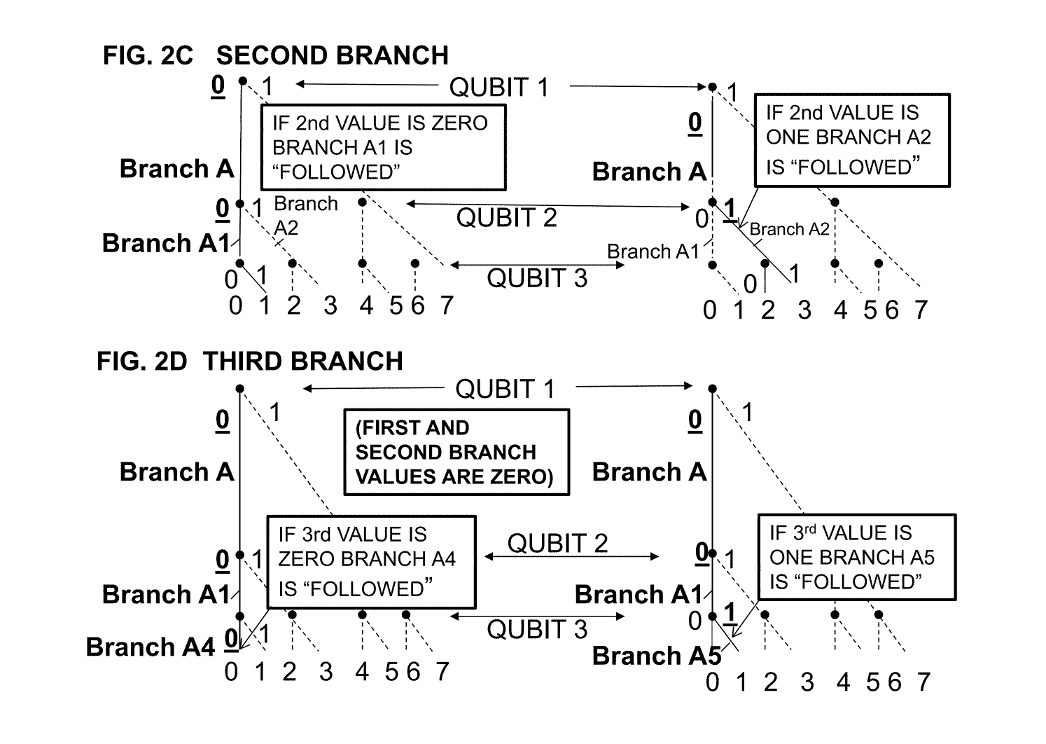

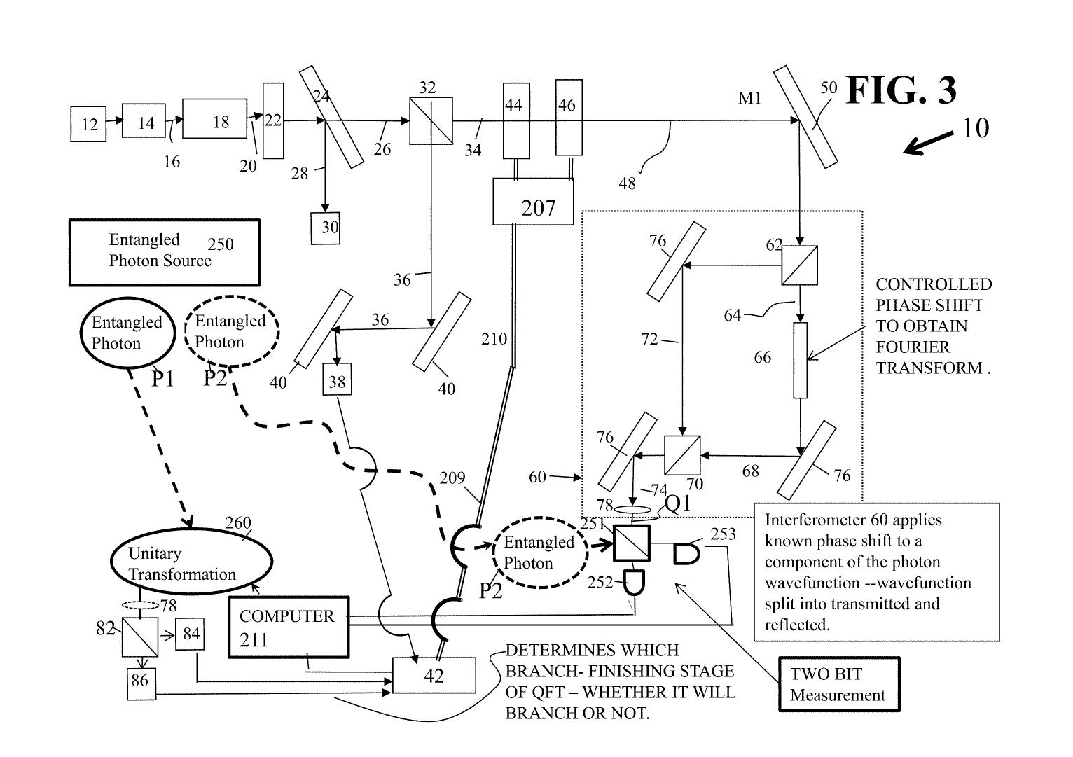

A quantum tree for the communication of information using qubits is depicted in FIGS. 2A, 2B, 2C and 2D. In the example shown, 3 qubits represent 8 classical data bins. The number of qubits may be changed without departing from the scope and principles of the present invention. As the first qubit is transmitted, a measurement takes place and the result is inputted into computer 207, such as that illustrated in FIG. 3, et seq. Based upon this measurement, as illustrated by the decision tree of FIG. 2B, either the left (L) or right (R) portion of qubit 2 is not used (or transmitted). Following the transmission of the portion of qubit 2, another measurement takes place and the result is inputted into computer 207. Based upon this measurement, as illustrated by the decision tree of FIG. 2C, either branch A1 or A2 is followed. In the example shown in FIG. 2D, where the first and second measured values were zeroes, the qubit portions represented by the nodes at the dotted line branches are unused and not transmitted.

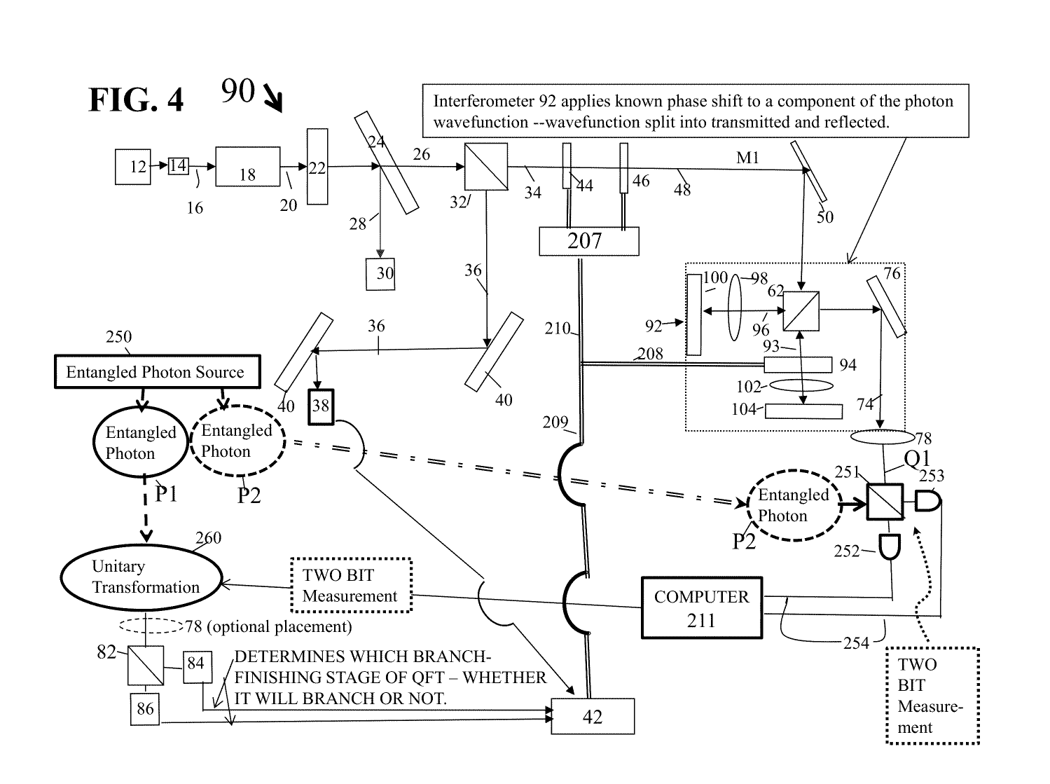

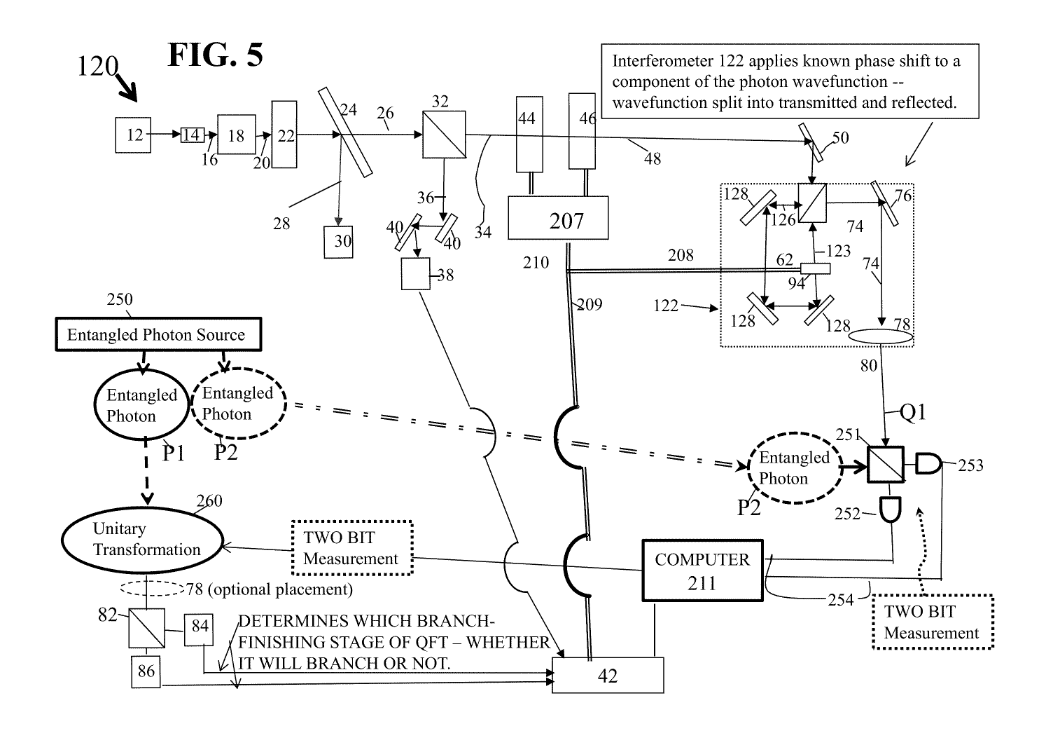

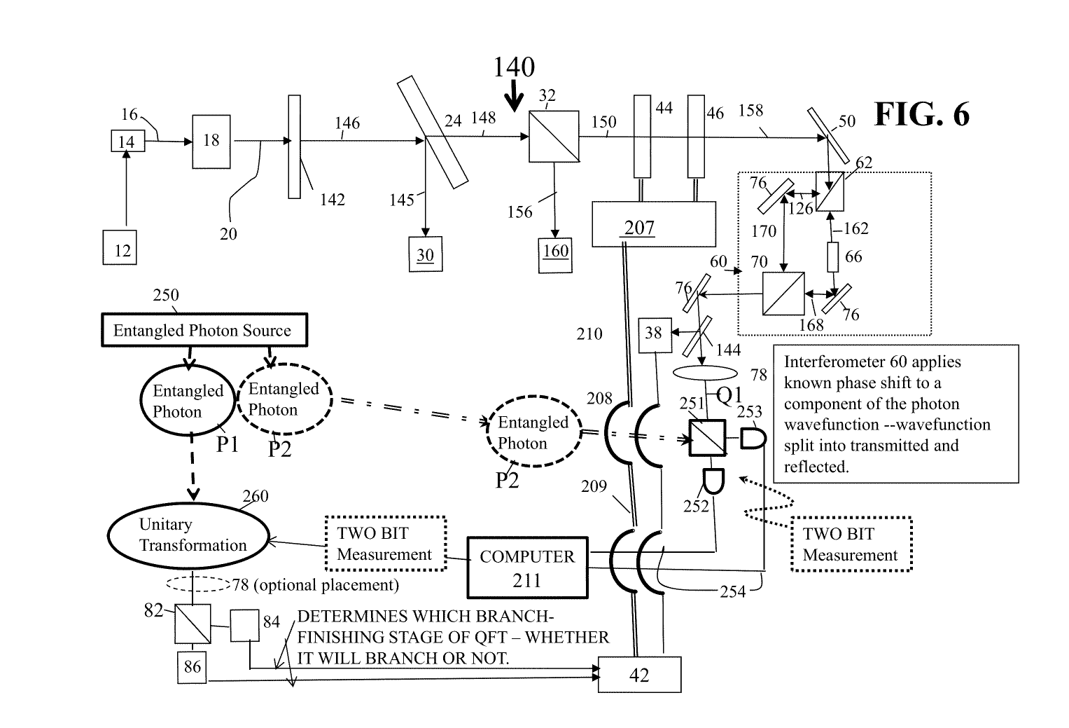

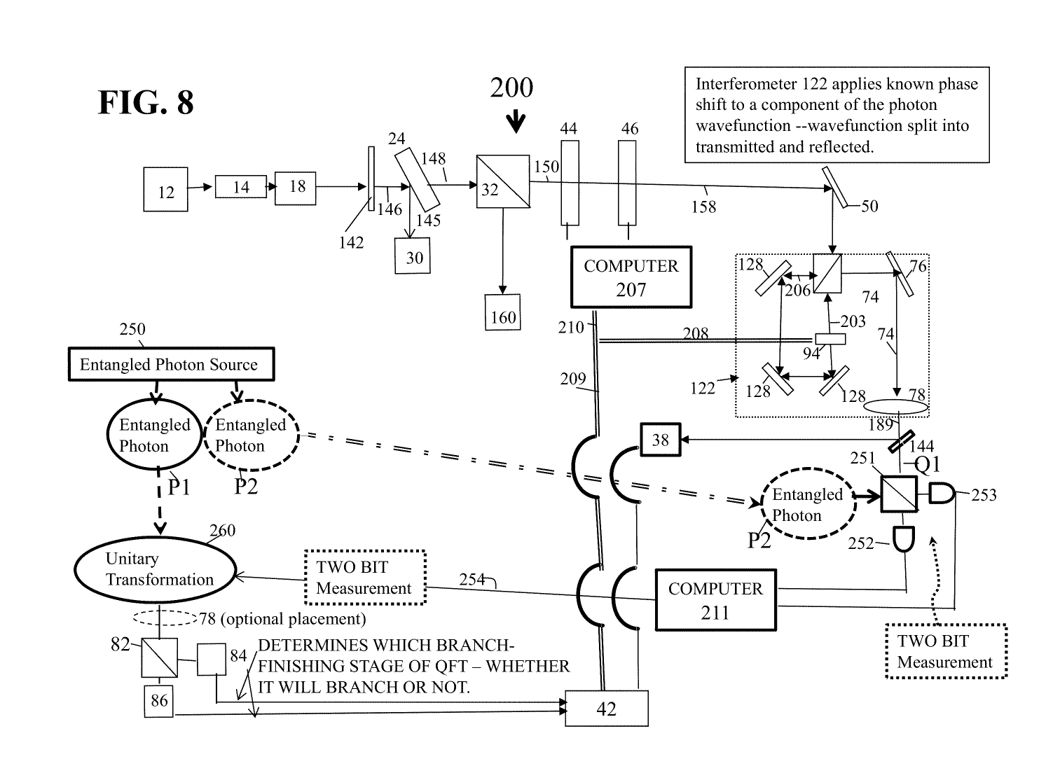

In preferred embodiments shown in FIGS. 3-8, a quantum Fourier transform is performed on the arbitrarily oriented elliptical polarization state using optical components (comprising interferometers 60 (FIGS. 3 & 6), 92 (FIGS. 4 & 7), 122 (FIG. 5 or 8)), as depicted in the respective figures, to yield a quantum computational product. A quantum Hadamard transform may be performed on the quantum computational product to yield one of two possible quantum particle outputs (via half wave plate 78). Through feedback circuitry, the input data set is processed based upon the coincident arrival of the comparator wave function state and one of the two quantum particle outputs. Data compression and transmission in accordance with a preferred embodiment of the present invention may be performed on either a quantum computer or a digital computer.

Due to the properties of the qubits, the systems of FIGS. 3 through 8 employ the quantum Fourier transform (QFT) and a classical or quantum inverse Fourier transform in the measurement process. Data inputted in the form of a wave function, generated using, for example, amplitudes of a given signal, is converted into a quantum state or qubits over which, in a preferred embodiment of the present invention, transforms, such as the quantum Fourier transform (QFT) operate. The conversion of the wave function to a quantum state represented by qubits is described, for example, in Gui Long, Yang Sun; “Efficient scheme for initializing a quantum register with an arbitrary superposed state,” Physical Review A, Volume 64, 014303 (2001) (herein incorporated by reference). The quantum Fourier transform is implemented by a series of optical elements implementing quantum operations followed by a measurement as described for example, in Robert B. Griffiths, et al. “Semiclassical Fourier Transform for Quantum Computation,” Physical Review Letters, Apr. 22, 1996 (herein incorporated by reference). Although a particular embodiment is described, other equivalent formulations, processes, and configurations are encompassed within the scope of the invention.

In terms of data flow, a preferred methodology comprises splitting a wave function representative of an input data set into an arbitrarily oriented elliptical polarization state and a comparator wave function state, the comparator wave function state being transmitted to a detector. In the embodiments of FIGS. 3-8, a quantum Fourier transform is performed on the arbitrarily oriented elliptical polarization state to yield a quantum computational product. A quantum Hadamard transform is performed on the quantum computational product to yield one of two possible quantum particle outputs. Through feedback circuitry, the input data set is processed based upon the coincident arrival of the comparator wave function state and one of the two quantum particle outputs. Data compression and transmission in accordance with a preferred embodiment of the present invention may be performed on either a quantum computer or a digital computer.

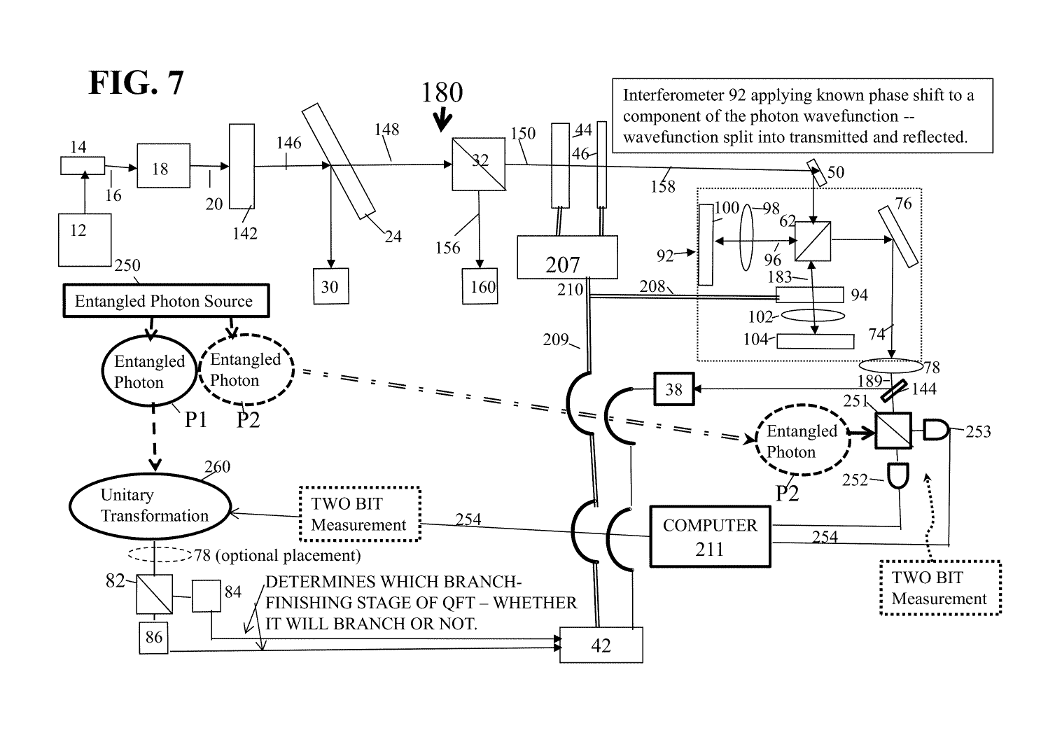

A data communication system operating on quantum computation principles includes a light source having a photon output coding an input data set. A Type-I or Type-II nonlinear crystal converts the photon output into an entangled photon output. An arbitrarily oriented polarization state is assured by passing the entangled photon output through a polarization modulator 44 and a phase modulator 46. A polarization interferometer 122 (FIGS. 5 & 8) (performs a controlled phase shift transform on the arbitrarily oriented polarization state as an interferometer output. The embodiments of FIGS. 3 and 6 substitute an interferometer 60 having the geometry of a polarization Mach-Zehnder interferometer and the embodiments of FIGS. 4 and 7 substitute an interferometer 92 having the geometry of a Michelson interferometer. A half wave plate 78 then performs a quantum Hadamard gate transform to generate one of two possible photon states from the interferometer output thus completing the operations required for a quantum Fourier transform. Coincidence electronics reconstruct the input data set a distance from the light source. The reconstruction is based on the coincident arrival of the one of two possible photon states and at least one of the entangled photon output or the interferometer output. The result is then fed back via computer 207 and associated circuitry whereupon the computer 207 in conjunction with polarization modulator 44 and a phase modulator 46 based upon the “branch” determinations, processes only portions of the succeeding qubits, resulting in reduction in the amount of data which is transmitted.

By way of background, Long, G., et al. “Efficient scheme for initializing a quantum register with an arbitrary superposed state,” Physical Review A, vol. 64, Issue 1, 014303 (2001) (hereinafter Long, et al. (hereby incorporated by reference)) discloses a scheme that can most generally initialize a quantum register with an arbitrary superposition of basis states as a step in quantum computation and quantum information processing. Long, et al. went beyond a simple quantum state such as |i₁, i₂, i₃, . . . iₙ> with iⱼ being either 0 or 1, to construct an arbitrary superposed quantum state. Long, et al. utilized the implementation of O(Nn²) standard 1- and 2-bit gate operations, without introducing additional quantum bits. Long, et al. presents a general scheme that initializes a quantum register without introducing additional qubits wherein the quantum circuit of a 3-qubit system transforms the state 1000> to an arbitrary superposed state with N=2³ basis states. The terminology arbitrary superposed quantum state as used herein correlates to the construction of an arbitrary superposed quantum state as described, inter alia, in Long, et al.

As depicted in FIG. 3, a series of optical elements are provided to act as quantum operators followed by a measurement to implement the quantum Fourier transform. A more detailed description of the use of the Fourier transform is found in Griffiths, R., et al. “Semiclassical Fourier Transform for Quantum Computation,” Physical Review Letters 76, 3328-3231 (1996) (herein incorporated by reference). An optical bench with appropriate electronics is well suited to function as a quantum computer for the compression and transmission of data corresponding to sound. Those of ordinary skill in the art can appreciate that although an optical bench is described as the platform for generating and performing operations on qubits, it is appreciated that three plus qubit quantum computers are known to the art, such as, for example, those computers utilized in conjunction with ion trapping and the nuclear magnetic resonance spectrometer. Although sound is used as an example for the data set amplitudes represented by a quantum wave function, the present invention is not limited to sound.

A wave function in quantum mechanics describes the quantum state of a particle as a function of space and time. The laws of quantum mechanics (such as, for example, the Schrödinger equation) describe how the wave function evolves over time. The symbol for a wave function Ψ is a complex valued function; however |Ψ|² is real, and corresponds to the probability density of finding a particle in a given place at a given time, if the particle's position is measured.

In conjunction with the present invention, the wave function may be coded into qubits of quantum particles. Preferably, the quantum particles are photons, but trapped ions or magnetic spin states can also be utilized to practice the principles of the present invention.

A preferred method of the present invention may utilize qubits in a quantum computer setting or the simulation of qubits in a classical computer. Qubits comprise superpositions of ones and zeros where both simultaneously exist. Photons that define the wave function may be subjected to a quantum Fourier transform operation. In the process, the photons are measured thereby destroying the quantum state, but providing the measured probability in terms of wave function and its complex conjugate

P=ψψ* (1)

In the embodiments of FIGS. 3-8, an inverse Fourier transform (FT) is then applied to the square root of the measured probability to recover a lossy intelligible data compression in the form of quantum particle detection. The inverse Fourier transform may be either a classical or quantum transform. A classical fast Fourier transform is readily performed by optical bench elements or through a classical computer program. The forward and inverse transforms are conducted using a relatively small sample of the wave function Fourier modes which has the property of preserving much of the intelligibility of the data while providing a compression and communication efficiency. Using the quantum computing simulation on a classical computer according to the present invention, a sound data set (for example) is intelligibly reproduced with a lossy compression factor utilizing a classical computation. Computational efficiency with the present invention may be increased by increasing the set of qubits. In practice, the inventive method allows for the transmission of information over a long path using a small number of photons. Data transmission with a small number of photons carrying the data in a quantum particle form is amenable to free optical path transmission through air or vacuum, through optical fibers and via satellite transmission.

Communication between remote locations can be accomplished utilizing a comparatively small number of qubits of quantum particles relative to the data exchanged. Photons are amenable to transit in an environment exposed to climactic weather between the locations. It is appreciated that co-linear transmission of a comparator wave function state and an information carrying state facilitates long-range data transmission.

### State Preparation

A data set is modeled by, or in the form of, a wave function. Using sound transmission as an example, the sound is characterized by intensity amplitudes at uniformly spaced intervals

$$\begin{matrix}{α}_{i} = α ( {t}_{i} ) \\ where & ( 2 ) \\ {t}_{i} = {t}_{0} + {\sum }_{j = 1}^{i} Δ {t}_{j} . & ( 3 )\end{matrix}$$

A superimposed quantum form is applied to the sound data set to facilitate quantum computer manipulation. To accomplish the quantification, data amplitudes are equated to a wave function in the form of a series

$$\begin{matrix}ψ = {\sum }_{i = 0}^{{2}^{N} - 1} {α}_{i} \vert i 〉 \\ where & ( 4 ) \\ \vert i 〉 & ( 5 )\end{matrix}$$

is the quantum state key. The qubits are characterized as the quantum state superpositions

qₖ=Aₖ|0 [symbol] +Bₖ| [symbol] (6)

A quantum probability conservation condition is imposed such that

Aₙ²+Bₙ²=1. (7)

To account for the quantum superposition, the quantum data is organized in terms of a conventional quantum binary tree. A prior art quantum binary tree is depicted as a branching between 0 and 1 outcomes for successive steps in FIG. 2A. Using the qubit representation shown in FIG. 2A, the first step is to determine whether a one or zero exists at the first branch located at the top of the triangle depicted in FIG. 2B. If a zero value is present, Branch A is followed and the right side of the triangle or the “Branch B” becomes unnecessary to future determinations. Elimination of either the “A Branch” or “B Branch” results in data compression inasmuch as the remaining ones or zeros in the A or B Branch need not be considered. FIG. 2C is a depiction of the second level branching following the determination depicted to the left in FIG. 2B. If the value is zero, Branch A1 is followed. If the value is one, Branch A2 is followed. In each case, the other branch is eliminated resulting in data compression. FIG. 2D is a depiction of the third level branching following the determination depicted to the left in FIG. 2C. If the value is zero, Branch A4 is followed. If the value is one, Branch A5 is followed. In each case, the other branch is eliminated resulting in further data compression. The particular values selected for depiction in FIGS. 2C and 2D are merely exemplary. Results of a “one” determination at first level are not shown in FIG. 2C to make the diagram easier to follow. Results of a “one” determination at the second level are not shown in FIG. 2D to make the diagram easier to follow.

The outcomes of the successive steps sum to the values 0 through 2ⁿ−1, where n is the number of qubits. The means of obtaining the 0 or 1 depends on the specific experimental and corresponding simulation implementation. There are several conventional rules that are possible for determining the 0 or 1 value. For example, a 0 state may correspond to a horizontal measurement and the 1 may correspond to a vertical measurement, or the reverse may be true. In general, the series of qubit measurements are prepared such that each value of the state preparation is conditioned to determine the 0 or 1 at each branch. An alternate qubit architecture operative herein is termed “winner takes all.” In the simulation depicted in FIG. 2A (Quantum Binary Tree), n qubit measurements are made. The n value is determinative of the first branch.

The 2ⁿ, where n is the number of qubits, are divided into two parts, lower 0 to ((2ⁿ)/2)−1 and higher indices ((2ⁿ)/2) to 2ⁿ−1. The side with the greatest sum of the indices measured determines the path of the first branch. The second level branch has one half the number of indices of the first branch. Consecutive indices assigned are from the selected half from the first branch. The same process is used for the second branch level as from the first branch, but with half of the indices. This process repeats until all the branching is determined and the selected single index is determined. The quantum binary tree depicted in prior art FIG. 2A for three qubits provides an index space of eight. The quantum binary tree is expandable to n qubits which is equivalent to an index space of 2ⁿ over which transforms, such as the Quantum Fourier Transform (QFT) operate.

The quantum superposition amplitudes at any qubit level in the binary tree may be constructed from, for example, sound amplitudes

$${A}_{k} = {\sum }_{i = 0}^{i = \frac{{2}^{n} k}{2} - 1} {α}_{1} \qquad ( 8 )$$

where the summation is over the number of states

nₖ (9)

at each level of the quantum binary tree. Similarly

$${B}_{k} = {\sum }_{i = \frac{{2}^{n} k}{2}}^{i = {2}^{n} k - 1} {α}_{1} . \qquad ( 10 )$$

The amplitudes α are approximated in the quantum computation by identification with probabilities which can then be sampled. For one realization, it is noted that and

α₀=øᵢ₌₀ⁱ⁼ⁿ^{²}^{k-1}Aᵢ (11)

and

αₖ=øᵢ₌₀ⁱ⁼ⁿ^{²}^{k-1-j}Πⱼ₌₀^{j=i}AᵢBⱼ (12)

where Π is the product of a sequence operator. The classical index k is given in terms of the quantum qubit indices n of the quantum binary tree made of n qubits

$$k = {\sum }_{i = 0}^{i = n - 1} ( {2}^{n - i} ) 〈 \vert {q}_{1} \vert 〉 . \qquad ( 13 )$$

The term [symbol] qᵢ [symbol] (Equation 14) represents the measurement of the i^{th} qubit, registering as a 0 or 1.

### Quantum Data Simulation

Superpositions of qubits are used to store and process data such as sound. The amplitude of the “data” can be stored as the amplitudes of a superposed quantum state

ω=Σαᵢ|k [symbol] ᵢ (15)

where |k [symbol] is the eigenstate of the wavefunction Ψ. The term Ψ can be decomposed as a direct product of qubits

|q [symbol] ₁ [symbol] |q [symbol] ₂ [symbol] . . . [symbol] |q [symbol] ₙ (16)

which compacts storage requirements by a factor of log 2 relative to a classical computation. A data set of size 2ⁿ can be stored and operated on in n quantum bits. Mathematical transforms can also be performed on the quantum stored signal with the associated computational savings.

### Quantum Computational System

Preferred embodiments for the system for quantum data compression and transmission that are preferably performed using photons as quantum particle qubits will now be described. In the preferred embodiments of the present invention depicted in FIGS. 3-8 like numerals described with reference to subsequent figures correspond to previously detailed elements.

Referring now to FIG. 3, a preferred embodiment is depicted generally at 10. A data encoder 12 converts the data set to a set of qubit amplitudes that satisfies the expression of Equation 15 and triggers a light source 14 accordingly. The light source 14 may be a laser, such as Nd:YAG, ion lasers, diode lasers, excimer lasers, dye lasers, and frequency modified lasers. Photons in path 16 emitted from the light source 14 are optionally passed through a spatial filter 18. Filter 18 converts the photons in path 16 in an image space domain to a spatial frequency domain and serves the purpose of removing, for example, stripe noise of low frequency and/or high frequency noise. Examples of noise associated with the system comprise fluctuations typically include line noise powering the light source 14, thermal gradients, detector noise, and inherent quantum noise. The photons 20 having passed through spatial filter 18 are then passed through a Type-II nonlinear optics crystal 22. Examples of Type-II nonlinear optic crystals that may be utilized include potassium dihydrogen phosphate, potassium titanyl phosphate, beta-barium borate, cesium lithium borate and adamantyl amino nitro pyridine. An optional dichroic mirror or bandpass filter that is operative to transmit specified wavelengths and reflect all others 24 is used to selectively reflect out of the beam path 26 those photons 28 that have reflected wavelengths as a result of passing through the crystal 22 into a stop 30. After passage through mirror 24, the remaining entangled photons 26 are split by interaction with a polarization beam splitter 32 into two paths; a known photon state path 34 and a comparator wave function state path 36. The comparator wave function state path 36 is directed onto a single photon counting module 38 by an optional mirror set 40. It is appreciated that a reorganization of beam paths in the system 10 obviates the need for mirror set 40. The detection of the photons from the comparator wave function state path 36 by the single photon counting module 38 is fed to coincidence electronics 42 and is used to reconstruct the data set. The entangled photons in the known photon state path 34 are then passed through a polarization modulator 44 and a phase modulator 46. Exemplary polarization phase modulators illustratively include liquid crystals, Kerr cells, and Pockel cells. Preferably, a series of two liquid crystal devices and a quarter wave plate may be used to achieve arbitrary polarization. Upon the entangled photons known photon state path 34 interacting with the polarization and phase modulators 44 and 46, respectively, the entangled photons are transformed into an arbitrarily oriented elliptical polarization state for passage via path 48 based on the data set signal being transformed and any previously measured photon state, if any is known. Note that both the polarization modulator 44 and phase modulator 46 are controlled by processor or computer 207, which in turn is connected via lines 209, 210 to the coincidence electronics 42. The entangled photons in the arbitrarily oriented elliptical polarization state passing via path 48 are optionally reflected from a mirror 50 and then enter a polarization interferometer depicted generally at 60. The interferometer 60 has the geometry of a polarization Mach-Zehnder interferometer and includes a polarization beam splitter 62 that transmits one portion 64 to a phase modulator 66 resulting in a phase shift in the light component 68 reaching polarization beam splitter 70 relative to the other polarization component 72. Polarization beam splitter 70 recombines beam components 68 and 72 to complete a controlled phase shift transform on the recombined state 74 from the interferometer 60. Three ancillary mirrors each numbered 76 are provided to reflect light in desired directions. The controlled phase shift transformed light component representing a recombined phase state 74 then interacts with a half wave plate 78 oriented at 22.5 degrees in order to implement a quantum Hadamard gate transformation therein and thus complete a quantum Fourier transform. The half wave plate 78 provides a qubit prioritized input 80 to a polarization beam splitter 82. Note that the half wave plate 78 may optionally be positioned following the Unitary Transformation circuitry 260 (as shown by dotted lines).

The process that computes the Quantum Fourier Transform (QFT) of a signal may be described as follows. First, the computer or device that holds the signal divides the signal into a series of sections. Each section contains N samples of the signal. This section of N samples is then used to prepare the first qubit. As shown in FIG. 2A, one qubit is representative of 8 contemporary bits, as illustrated by the base of the quantum binary tree. In accordance with a preferred embodiment, the qubit of the quantum state utilizes a prescribed technique for the Quantum Fourier Transform. This quantum state is then passed though a device that applies a particular phase shift (via phase shifters 44, 46) appropriate to this qubit of the Quantum Fourier Transform. The qubit is then measured and the result of that measurement is recorded as a 0 or 1. This measurement is also used to determine which half of the N samples of the current signal section are used as a subsection to prepare the next qubit, as the other half is not needed to prepare the next qubit for reasons described above in connection with FIG. 2B. This qubit and all the remaining qubits generated for the original signal section are prepared and measured in a similar way with each qubit measurement using only half of the remaining signal subsection to prepare the next qubit. This process ends when the last qubit that is prepared using only 2 samples of the signal section. When all these qubits have been measured for one section, a binary number remains that results in the adding of 1 to the bin addressed by that binary number, for instance the binary number 010 would indicate address 2 and the binary number 110 would indicate address 6. These steps are repeated a number of times on the same signal section to generate a power spectrum representation of the signal section. Signal processing techniques such as a classical inverse Fourier transform or compressive sensing/sampling can be used on this power spectrum to reconstruct the initial signal section in a lossy but still recognizable manner.

In the Quantum Fourier Transform a number of photons, each with prepared qubit states, are sent sequentially through quantum controlled phase transforms followed by quantum Hadamard transforms associated with the half wave plate 78. The state preparation is accomplished by setting the values of the phase and setting the photons to particular elliptical polarization values.

The Hadamard transform is a quantum transform operating on one qubit at a time. The Hadamard transform in connection with the embodiments of FIGS. 3-8 may be performed after the unitary transformation operation 260 or in the alternative, after the interferometers 60 (FIGS. 3 & 6), 92 (FIGS. 4 & 7), 122 (FIG. 5 or 8), as depicted in the respective figures. The Hadamard gate transform is given as

$$( \begin{matrix}1 & 1 \\ 1 & - 1\end{matrix} ) . \qquad ( 17 )$$

The qubits are operated on by the Hadamard transform as

|q′ₙ_{ₖ} [symbol] =H|qₙ_{ₖ} [symbol] (18)

where nₖ is the index of the current qubit state.

Hadamard transforms in the order of the most significant qubit to the least significant qubit. The initial state of each photon qubit is conditioned on the previously measured values of prior photon measurements.

A single photon is operated upon by a Hadamard transform, with the effect of Hadamard transforms on multiple photons representing an entire wave function is represented by the combined Hadamard transform.

### Wave Function Transform

The total wave function made of arbitrary superposed states is operated on by the combined Hadamard transform

|ψ′ [symbol] =Ĥ_{gate}|ψ (19)

where

Ĥ_{gate}=H [symbol] I . . . [symbol] I. (20)

Here the direct product of the identities is repeated until all of the qubits are taken into account.

With reference now to FIG. 3, single photon counting modules 84 and 86 count individual photons with a different given polarization, respectively, and report a counting event to coincidence electronics 42. Only when coincidence is noted between a photon counting event at module 38 and 84, or between module 38 and module 86 is the count considered a valid probability density function measurement. The probability density function is defined by

P=ψψ* (21)

(where ψ represents the wave function and ψ* is the complex conjugate of the wavefunction) and sets the number of times on the average that a photon lands in an index space interval. For n qubits there are 2ⁿ index space intervals (FIG. 2A. provides an example of the index space for 3 qubits).

A determination as to the polarization of each photon is provided by signal measurement at one of the single photon counting modules 84 and 86. The polarization of each photon is measured by the counting modules 84, 86 which represent the end of the photon path through the Hadamard gate and electro-optics. If horizontal (0) is measured, for example by single photon counting module 86, then no phase operations are applied to the remaining qubits. Otherwise, a controlled phase operation Rₘ is applied to remaining operations. Note that the phase polarization 44 and phase modulator 46 are controlled by the computer or processor 207 which is connected to the coincident circuitry 42, which is in turn receives the outputs of the detectors 84, 86. The Rₘ set is defined as

$${R}_{m} = ( \begin{matrix}1 & 0 \\ 0 & {e}^{\frac{i π}{{2}^{Δ n}}}\end{matrix} ) . \qquad ( 22 )$$

The term Δn represents the distance between the nₖ indices of the binary tree levels under consideration,

Δn=nₖ−n_{k′} (23)

Where nₖ represents the maximum number of levels on the binary tree and n_{k′} represents the level of the binary tree currently being operated on. The output of an inventive system is provided to a buffer store. From the buffer store it may be provided to an output device on either a real-time or delayed basis as still images, video images, movies, audio sound representations, and the like.

### Quantum Teleportation of Information

Turning to another facet of the preferred embodiments depicted in FIGS. 3 through 8, as an option, quantum teleportation of information may be utilized. Quantum teleportation refers to the exact transfer of quantum information (a qubit) from one location to another without that qubit being transmitted directly through the space between the sender and the receiver. As an example, this can be accomplished by the sender and the receiver each sharing one half of an entangled quantum system. When the sender wishes to send a qubit (quantum teleportation) the sender will perform a Bell measurement with their half of the shared entangled quantum system and the qubit to be transferred to the receiver. The outcome of the Bell measurement will be sent to the receiver over classical channels and consists of two bits. In each of FIGS. 3 through 8 a unitary transformation operation is performed in element 260. The following analysis applies to each of FIGS. 3 through 8 with respect to Unitary Transformation element 260. When the receiver gets the two bits (from the detectors 252, 253) the receiver then applies to the receiver's remaining portion of the initially shared entangled state one of four unitary operations depending upon what the two bits indicate. Typically these operations can be represented by a matrix and correspond to the Identity matrix and three other matrices. For example,

$$I = \vert \begin{matrix}1 & 0 \\ 0 & 1\end{matrix} \vert , T 1 = \vert \begin{matrix}1 & 0 \\ 0 & - 1\end{matrix} \vert , T 2 = \vert \begin{matrix}0 & 1 \\ 1 & 0\end{matrix} \vert , and T 3 = \vert \begin{matrix}0 & - 1 \\ 1 & 0\end{matrix} \vert .$$

The matrices are called unitary because they do not change the length, \sqrt{a²+b²}, of the vector that the matrix multiplies. After this operation, the receiver will possess the quantum information of the qubit that the sender transmitted. The unitary transformation operation (performed by element 260) may be performed by an element comprising, for example, a half wave plate and a quarter wave plate. For example, if the identity matrix is to be applied, nothing is done with the remaining portion of the initially shared entangled state. If the two bits (from the detectors 252, 253) indicate that the matrix T2 is to be applied then a half wave plate will perform a ninety degree rotation. If T1 is to be applied, then two suitable quarter wave plate operations will be performed. If T3 is to be applied, then two suitable quarter wave plate operations followed by a suitable half wave plate operation will be performed. Upon completion of this unitary transformation operation (260 in FIGS. 3-8, 10A and 10B), due to the quantum aspects of the transfer, the receiver obtains the quantum information contained in qubit Q1 that was inputted into the Bell State Measurement 251.

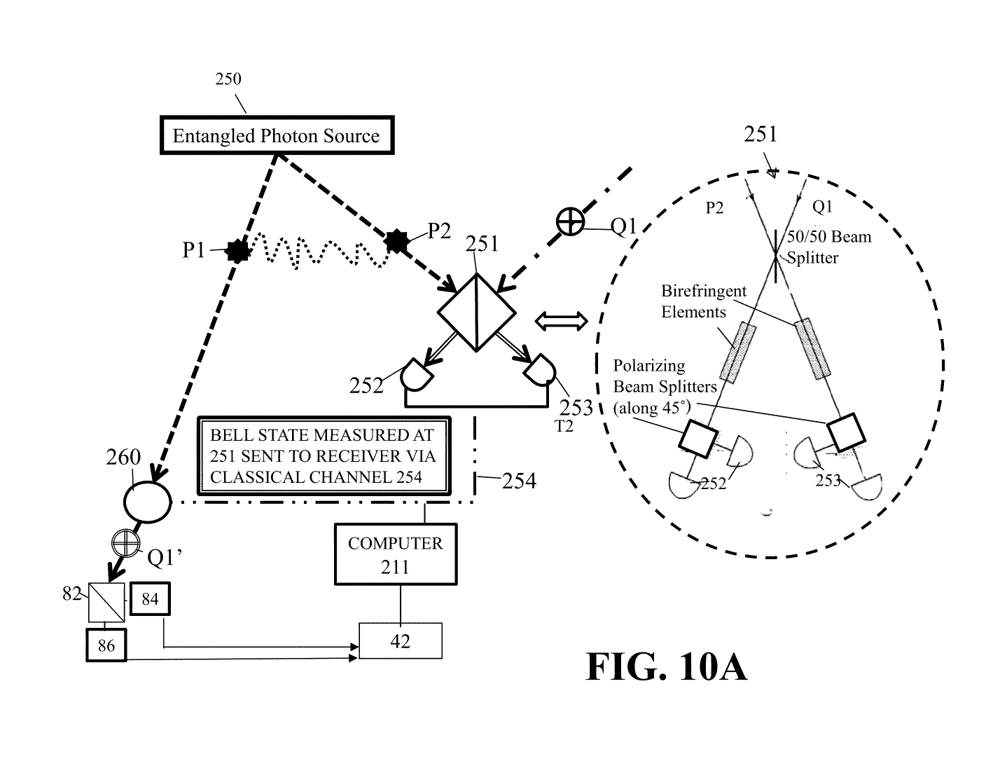

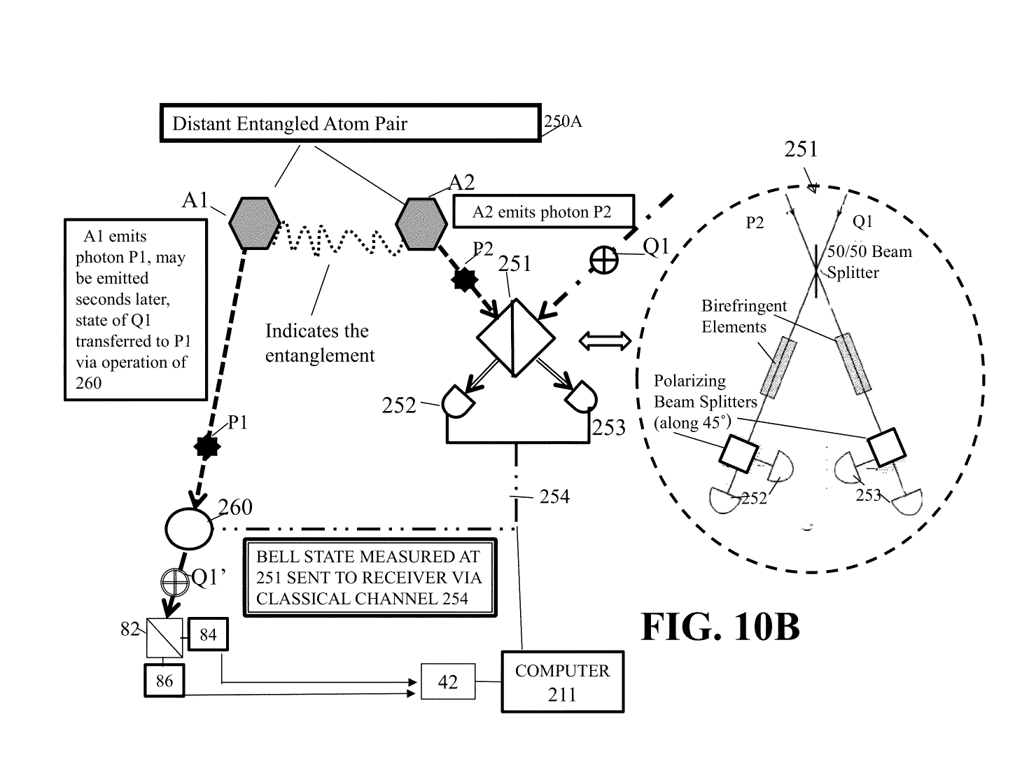

With reference now to FIGS. 3 though 8, shown therein are entangled photon source 250 that provides a source for entangled photons P1 and P2. For ease of understanding, the second entangled photon P2 is repeated as an input into the Bell state measurement element 251 (represented by the square with a diagonal line). The Bell states are a concept in quantum information science representing an EPR pair; i.e. a pair of qubits which jointly are in a Bell state that is, entangled with each other. In the embodiments of FIGS. 3 through 8, for the Bell state measurement element 251 the entangled photon pair are the entangled photon P2 and the informational photon passing via the path 74 in FIGS. 3 through 5 and through the half wave plate 144 in FIGS. 6 through 8. Note that as discussed above, the informational photon may have passed though the half wave plate 78, which implements a quantum Hadamard gate transformation thereon. In the Bell state measurement element 251, the joint measurement takes place between the entangled photon P2 and the informational photon. This interaction is depicted in FIG. 10A, also with photon P2 and qubit Q1. In the case of FIGS. 3 though 8, the qubit Q1 is the resultant of the interferometers 60 (FIGS. 3 & 6), 92 (FIGS. 4 & 7), 122 (FIG. 5 or 8). The determination of the Bell measurement, a joint quantum-mechanical measurement of two qubits that determines which of the four Bell states the two qubits are in is recorded by the photodetectors 252, 253, also referred to as the “two-bit measurement.” In the context of the entangled photons being separated with photon Pb being at the receiving side and the photon P2 being at the sender, information contained in the qubit Q1 may be transmitted from the sender to the receiver with only the two-bit measurement being physically transmitted. That is, the information contained in the qubit Q1, as shown in FIG. 10A, appears on the receiving side (bottom left of FIG. 10A) due to the quantum properties of entanglement. Specifically, entangled photon P1 enters a unitary transformation at element 260, referred to as a unitary transformation operation, wherein the result or output is the information contained on qubit Q1 by detectors 84 and 86. Thus, the information contained in qubit Q1 is passed from the sender to the receiver with only the physical transfer of the two-bit measurement via “classical channels.” Thus, data relating to how to perform the Bell state measurement is transferred while the properties of entanglement between photons P1 and P2 result in the transference of information by teleportation of information; i.e., when the photon P2 encounters the qubit Q1 in the Bell state measurement element 251, the other photon P1 is effected by the encounter so as to in effect impart information from qubit Q1 to the entangled P1, P2 photon state. Photons P1 and P2 may be significant distances from each other and still achieve the effects of entanglement.

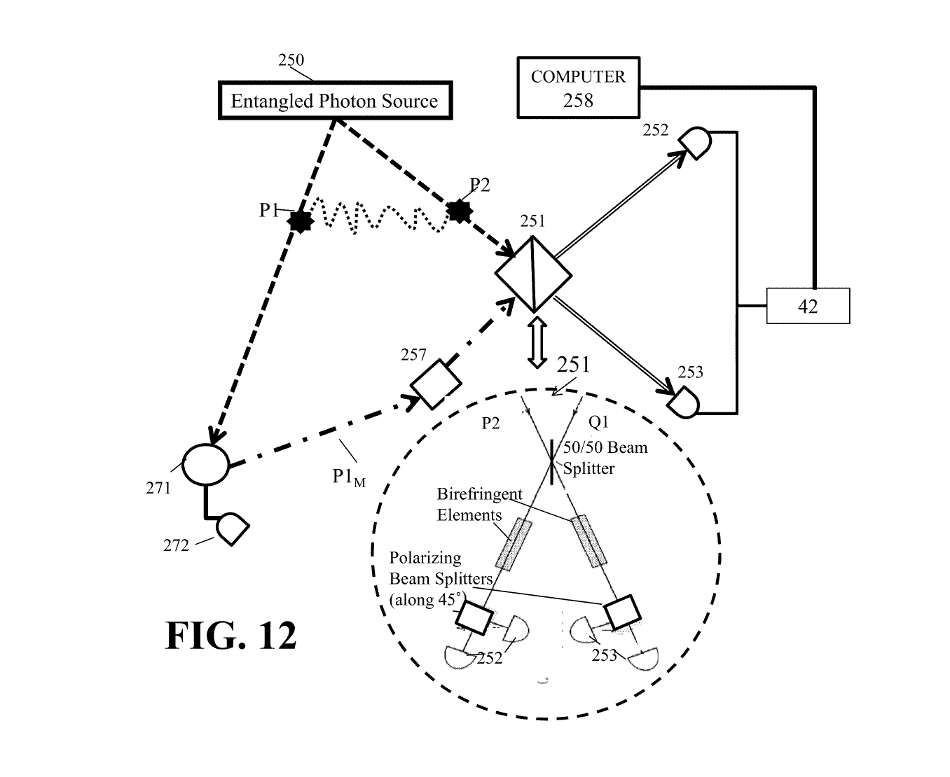

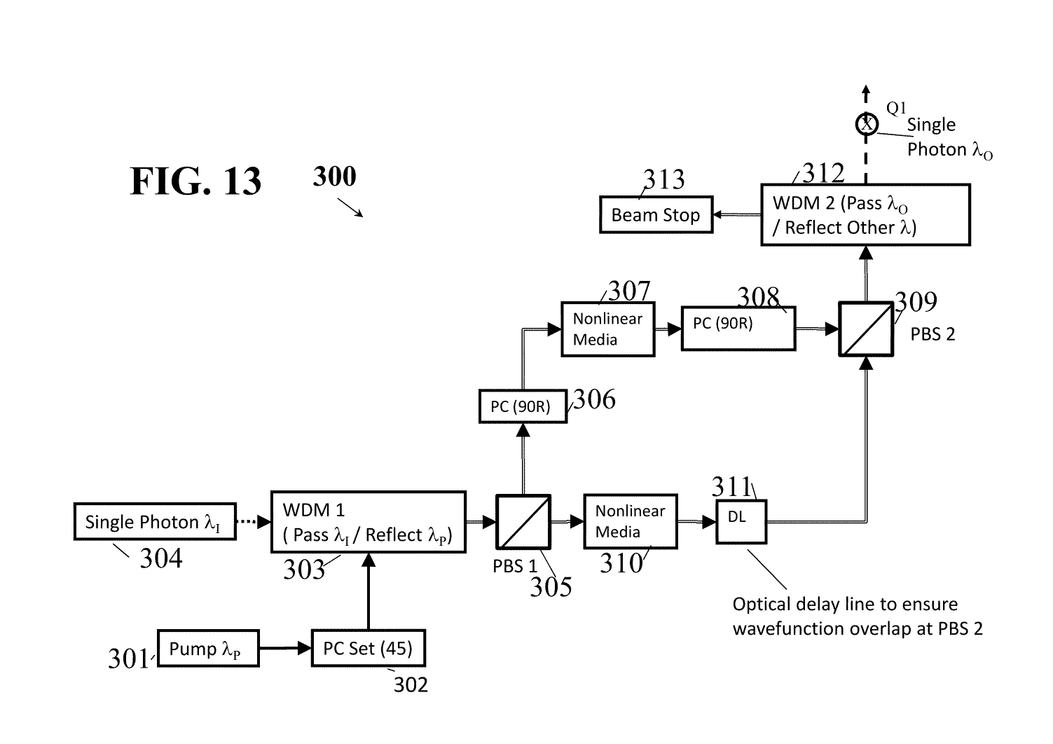

Note that while the entanglement of two photons is shown in FIGS. 3 through 8 and the concept is shown in FIG. 10A, alternative uses of entanglement are represented in FIGS. 10B through 13. In FIGS. 10B and 12, instead of entangled photons P1 and P2, an entangled atom pair A1 and A2 is illustrated. Similar circuitry from FIGS. 10B and 13 may be utilized in conjunction with the implementation of the embodiments of FIGS. 3 through 8 to integrate or substitute the atom pair A1, A2 for the photon pair P1, P2 of FIGS. 2 through 7. FIG. 12 is similar to FIG. 10A, but includes an optical delay 257.

It is noted that with respect to the Bell state measurement, for entanglement using a single qubit variable, difficulties are presented when only three distinct classes out of four Bell states are generally distinguishable. By using multiple qubit variables, for example, polarization, orbital angular momentum, or energy states, tracing or redundancy of variables can be used to in effect achieve complete Bell state measurements.

Referring now to FIG. 4, preferred embodiment system 90 has numerous features in common with that system depicted in FIG. 3 and such attributes share like numerals with those detailed with respect to FIG. 3. In FIG. 4, a data encoder 12 converts the data set to a set of qubit amplitudes that satisfies the expression of Equation 15 and triggers a light source 14 accordingly. The light source 14 may be a laser, such as Nd:YAG, ion lasers, diode lasers, excimer lasers, dye lasers, and frequency modified lasers. Photons in path 16 emitted from the light source 14 are optionally passed through a spatial filter 18. Filter 18 converts the photons in path 16 in an image space domain to a spatial frequency domain and serves the purpose of removing, for example, stripe noise of low frequency and/or high frequency noise as described above in connection with FIG. 3. The photons represented by path 20 having passed through spatial filter 18 are then passed through a Type-II nonlinear optics crystal 22, as described in connection with FIG. 3. An optional dichroic mirror or bandpass filter that is operative to transmit specified wavelengths and reflect all others 24 is used to selectively reflect out of the beam path 26 those photons 28 that have reflected wavelengths as a result of passing through the crystal 22 into a stop 30. After passage through mirror 24, the remaining entangled photons 26 are split by interaction with a polarization beam splitter 32 into two paths; a known photon state path 34 and a comparator wave function state path 36. The comparator wave function state path 36 is directed onto a single photon counting module 38 by an optional mirror set 40. It is appreciated that a reorganization of beam paths in the system 10 obviates the need for mirror set 40. The detection of the photons from the comparator wave function state path 36 by the single photon counting module 38 is fed to coincidence electronics 42 and is used to reconstruct the data set. The entangled photons in the known photon state path 34 are then passed through a polarization modulator 44 and a phase modulator 46. Exemplary polarization phase modulators illustratively include liquid crystals, Kerr cells, and Pockel cells. Preferably, a series of two liquid crystal devices and a quarter wave plate may be used to achieve arbitrary polarization. The polarization modulator 44 and a phase modulator 46 are each controlled by a computer or processor 207 which may be connected via lines 209, 210 to coincidence detecting circuitry 42. Note that the coincidence circuitry has an input from the photon counting module 38. Upon the entangled photons known photon state path 34 interacting with the polarization and phase modulators 44 and 46, respectively, the entangled photons are transformed into an arbitrarily oriented elliptical polarization state for passage via path 48 based on the data set signal being transformed and any previously measured photon state, if any, being known. The photons in the path 48 are referenced in connection with FIGS. 10A, 10B, and 13 as corresponding to the qubit Q1. The entangled photons in the arbitrarily oriented elliptical polarization state passing via path 48 are optionally reflected from a mirror 50 and then enter a polarization interferometer depicted generally within the dotted lines labeled 92.

In contrast to system 10 depicted in FIG. 3, the system 90 includes an interferometer shown generally at 92 that has the geometry of a polarization Michelson interferometer. The interferometer 92 receives orthogonally polarized entangled photon pairs from the arbitrarily oriented elliptical polarization state path 48 incident on a polarization beam splitter 62 that splits the arbitrarily oriented elliptical polarization state 48 with one component of the polarization 93 phase shifted at phase modulator 94 relative to the other polarization component 96. The polarization component 96 interacts with a quarter wave plate 98 two times rotating polarization by 90 degrees. Phase component 96 is then reflected from mirror 100 back to polarization beam splitter 62 where the phase component 96 is recombined with phase shifted polarization component 93 that has passed through polarization modulator 94, a quarter wave plate 102 two times rotating the polarization by 90 degrees and returning to polarization beam splitter through reflection from translating mirror 104. It is appreciated that the phase modulator 94 is readily removed and the phase difference applied to phase shifted polarization component 93 is imparted by the translating mirror 104. Phase modulator 94 is connected to the computer/processor and coincidence circuitry 42 via line/path 208, 209, 210. Regardless of the specific components of interferometer 92, the recombined state 74 is reflected off mirror 76 and further manipulated as detailed with respect to FIG. 3 such that a valid probability density function measurement is only counted upon coincidence between photon detection at modules 38 and 84, or between modules 38 and 86.

The controlled phase shift transformed entangled photon wavefunction components representing a recombined phase state in path 74 (of the qubit Q1) then interacts with a half wave plate oriented at 22.5 degrees 78 in order to implement a quantum Hadamard gate transformation therein and thus complete a quantum Fourier transform.

Continuing to the left side of FIG. 4, entangled photon source 250 provides entangled photons P1 and P2. In the drawing, for explanatory purposes, the second entangled photon P2 is repeated as an input into the Bell state measurement element 251 (represented by the square with a diagonal line). Within the Bell state measurement element 251, entangled photon P2 and the informational qubit Q1 passing via the path 74 interact via quantum interference. Note that as discussed above, the informational photon may have passed though the half wave plate 78, which implements a quantum Hadamard gate transformation thereon. In the Bell state measurement element 251, the measurement takes place between the entangled photon P2 and the informational photon. This interaction is depicted in FIG. 10A which depicts photon P2 and qubit Q1 undergoing a joint Bell state measurement. In the case of FIGS. 3 though 8, the qubit Q1 is the resultant of the interferometers 60 (FIGS. 3 & 6), 92 (FIGS. 4 & 7), 122 (FIG. 5 or 8). The determination of the Bell measurement, a joint quantum-mechanical measurement of two qubits, determines which of the four Bell states the two qubit system (Q1 and P2) exist. This is recorded by the photodetectors 252, 253, and the results are referred to herein as the “two-bit measurement.”

In the general context of the entangled photons P1 and P2 being separated with photon P1 being at the receiving side and the photon P2 being at the sender, information contained in the qubit Q1 may be transmitted from the sender to the receiver with only the two-bit measurement (recorded by detectors 252, 253) being physically transmitted. That is, the information contained in the qubit Q1, as shown in FIG. 10A, appears on the receiving side (bottom left of FIG. 10A) due to the quantum properties of entanglement. Specifically, entangled photon P1 enters a unitary transformation at element 260, labeled unitary transformation operation, wherein the result or output is the information contained on qubit Q1 by detectors 84 and 86 after passage through half mirror 82.

As explained in the foregoing (regarding the unitary transformation operation) when the sender wishes to send a qubit (quantum teleportation) the sender will perform a Bell measurement with sender's half of the shared entangled quantum system and the qubit to be transferred to the receiver (at elements 251, 252, 253). The outcome of the Bell measurement will be sent to the receiver over classical channels and consists of two bits. When the receiver gets the two bits (transferred via computer 211 to the unitary transformation element 260) the receiver applies to their remaining portion of the initially shared entangled state one of four unitary operations depending upon what the two bits indicate. Typically these operations can be represented by a matrix and correspond to the Identity matrix and three other matrices. For example,

$$I = \vert \begin{matrix}1 & 0 \\ 0 & 1\end{matrix} \vert , T 1 = \vert \begin{matrix}1 & 0 \\ 0 & - 1\end{matrix} \vert , T 2 = \vert \begin{matrix}0 & 1 \\ 1 & 0\end{matrix} \vert , and T 3 = \vert \begin{matrix}0 & - 1 \\ 1 & 0\end{matrix} \vert .$$

The matrices are called unitary because they do not change the length, \sqrt{a²+b²}, of the vector that the matrix multiplies. After this operation, the receiver will possess the quantum information of the qubit that the sender transmitted. The unitary operation may (260) be performed by an element comprising, for example, a half wave plate and a quarter wave plate. For example, if the identity matrix is to be applied, nothing is done with the remaining portion of the initially shared entangled state. If the two bits indicate that the matrix T2 is to be applied the half wave plate will perform a ninety degree rotation. If T1 is to be applied, then two suitable quarter wave plate operations will be performed. If T3 is to be applied, then two suitable quarter wave plate operations followed by a suitable half wave plate operation will be performed. The outcome of the unitary transformation operation is detected by detectors 84, 86 via beamsplitter 82.

Thus, the information contained in qubit Q1 is passed from the sender to the receiver with only the physical transfer of the two-bit measurement via “classical channels.” Thus, data relating to how to perform the Bell state measurement is transferred while the properties of entanglement between photons P1 and P2 result in the transference of information by teleportation of information; i.e., when the photon P2 “encounters” the qubit Q1 in the Bell state measurement element 251, the other photon P1 is effected by the “encounter” so as to in effect impart information from qubit Q1 to the entangled photons P1 and P2 simultaneously. Photons P1 and P2 may be significant distances from each other and still achieve the effects of entanglement, i.e., P1 is impacted by the conditions affecting P2.

The half wave plate 78 provides a qubit prioritized input 80 to a polarization beam splitter 82. Note that the half wave plate 78 may optionally be positioned following the Unitary Transformation circuitry 260 (as shown by dotted lines).

Referring now to FIG. 5, a system is depicted generally at 120, the system 120 has numerous features in common with that system depicted in FIG. 3 and such attributes share like numerals with those detailed with respect to FIG. 3.

Specifically, as shown in FIG. 5, a data encoder 12 converts the data set to a set of qubit amplitudes that satisfies the expression of Equation 15 (i.e., the amplitude of the “data” is stored as the amplitudes of a superposed quantum state ψ=Σαᵢ|k [symbol] ᵢ and triggers a light source 14 accordingly.

The light source 14 may be a laser, such as Nd:YAG, ion lasers, diode lasers, excimer lasers, dye lasers, and frequency modified lasers. Photons in path 16 emitted from the light source 14 are optionally passed through a spatial filter 18. Filter 18 converts the photons in path 16 in an image space domain to a spatial frequency domain and serves the purpose of removing, for example, stripe noise of low frequency and/or high frequency noise as described above in connection with FIG. 3. The photons represented by path 20 having passed through spatial filter 18 are then passed through a Type-II nonlinear optics crystal 22. An optional dichroic mirror or bandpass filter 24 that is operative to transmit specified wavelengths and reflect all others is used to selectively reflect out of the beam path 26 those photons 28 that have reflected wavelengths as a result of passing through the crystal 22 into a stop 30. Whatever photon goes through will be wavelength shifted such that the sum of energies is equal to the “parent” photon. After passage through half-mirror 24, the remaining entangled photons 26 are split by interaction with a polarization beam splitter 32 into two paths; a known photon state path 34 and a comparator wave function state path 36. The comparator wave function state path 36 is directed onto a single photon counting module 38 by an optional mirror set 40. It is appreciated that a reorganization of beam paths in the system 10 obviates the need for mirror set 40. The detection of the photons from the comparator wave function state path 36 by the single photon counting module 38 is fed to coincidence electronics 42 and is used to reconstruct the data set at the receiver end. The entangled photons in the known photon state path 34 are then passed through a polarization modulator 44 and a phase modulator 46. Exemplary polarization phase modulators illustratively include liquid crystals, Kerr cells, and Pockel cells. Preferably, a series of two liquid crystal devices and a quarter wave plate may be used to achieve arbitrary polarization. Upon the entangled photons known photon state path 34 interacting with the polarization and phase modulators 44 and 46, respectively, the photons Q1 are transformed into an arbitrarily oriented elliptical polarization state for passage via path 48 based on the data set signal being transformed and any previously measured photon state, if any is known. The photons Q1 in the arbitrarily oriented elliptical polarization state passing via path 48 are optionally reflected from a mirror 50 and then enter a polarization interferometer depicted generally at 122.

Unlike the system 10 depicted in FIG. 3, and system 90 depicted in FIG. 4, the system 120 includes an interferometer shown generally at 122 that has the geometry of a polarization Sagnac interferometer. The arbitrarily oriented elliptical polarization state 48 is split at polarization beam splitter 62 to phase shift a polarization component 123 through interaction with a phase modulator 94. A second component 126 is recombined with the phase shifted component 123 through coincidental reflection with the mirrors collectively labeled 128. The recombined state 74 is reflected by mirror 76 onto a half wave plate 78 to implement a quantum Hadamard gate transformation.

Continuing to the left side of FIG. 5, entangled photon source 250 provides entangled photons P1 and P2. In the drawing, for explanatory purposes, the second entangled photon P2 is repeated as an input into the Bell state measurement element 251 (represented by the square with a diagonal line). Within the Bell state measurement element 251, entangled photon P2 and the informational qubit Q1 interact via quantum interference. Note that as discussed above, the informational photon may have passed though the half wave plate 78, which implements a quantum Hadamard gate transformation thereon. In the Bell state measurement element 251, the measurement takes place between the entangled photon P2 and the informational photon. This interaction is depicted in FIG. 10, which depicts photon P2 and qubit Q1 undergoing a joint Bell state measurement. The determination of the Bell measurement, a joint quantum-mechanical measurement of two qubits, determines which of the four Bell states the two qubit system (Q1 and P2) exist. This is recorded by the photodetectors 252, 253, and the results are referred to herein as the “two-bit measurement.” The transfer of these two bits via lines 254 may be accomplished by first passing the two bits through an optional computer 211 for input into the unitary transformation element 260.

It is noted again that in the general context of the entangled photons P1 and P2 being separated with photon P1 being at the receiving side and the photon P2 being at the sender, information contained in the qubit Q1 may be transmitted from the sender to the receiver with only the two-bit measurement (recorded by detectors 252, 253) being physically transmitted. The half wave plate 78 provides a qubit prioritized input 80 to a polarization beam splitter 82. Note that the half wave plate 78 may optionally be positioned following the Unitary Transformation circuitry 260 (as shown by dotted lines).

As explained in the foregoing (regarding the unitary transformation operation) when the sender wishes to send a qubit (quantum teleportation) the sender will perform a Bell measurement with sender's half of the shared entangled quantum system and the qubit to be transferred to the receiver (at elements 251, 252, 253). The outcome of the Bell measurement will be sent to the receiver over classical channels and consists of two bits. When the receiver gets the two bits (transferred via computer 211 to the unitary transformation element 260) the receiver applies to their remaining portion of the initially shared entangled state one of four unitary operations depending upon what the two bits indicate. Typically these operations can be represented by a matrix and correspond to the Identity matrix and three other matrices. For example,

$$I = \vert \begin{matrix}1 & 0 \\ 0 & 1\end{matrix} \vert , T 1 = \vert \begin{matrix}1 & 0 \\ 0 & - 1\end{matrix} \vert , T 2 = \vert \begin{matrix}0 & 1 \\ 1 & 0\end{matrix} \vert , and T 3 = \vert \begin{matrix}0 & - 1 \\ 1 & 0\end{matrix} \vert .$$

The matrices are called unitary because they do not change the length, \sqrt{a²+b²}, of the vector that the matrix multiplies. After this operation, the receiver will possess the quantum information of the qubit that the sender transmitted. The unitary operation may (260) be performed by an element comprising, for example, a half wave plate and a quarter wave plate. For example, if the identity matrix is to be applied, nothing is down with the remaining portion of the initially shared entangled state. If the two bits indicate that the matrix T2 is to be applied the half wave plate will perform a ninety degree rotation. If T1 is to be applied, then two suitable quarter wave plate operations will be performed. If T3 is to be applied, then two suitable quarter wave plate operations followed by a suitable half wave plate operation will be performed. The outcome of the unitary transformation operation is detected by detectors 84, 86 via beamsplitter 82.

Continuing, in the left side of FIG. 5 single photon counting modules 84 and 86 count individual photons with a given polarization and report a counting event to coincidence electronics 42. Only when coincidence is noted between a photon counting event at module 38 and 84, or between module 38 and module 86 is the count considered a valid probability density function measurement.

Referring now to FIG. 6, an alternate preferred embodiment system is depicted generally at 140 that is a Type-I nonlinear optics crystal analog. A data encoder 12 coverts the data set to a set of qubit amplitudes that satisfies the expression of Equation 15 and triggers a light source 14 accordingly. Photons in path 16 emitted from the light source 14 are optionally passed through a spatial filter 18. Filter 18 converts the photons in path 16 in an image space domain to a spatial frequency domain and serves the purpose of removing, for example, stripe noise of low frequency and/or high frequency noise. Photons in path 16 emitted from the light source 14 are optionally passed through a spatial filter 18. The photons 20 having passed through spatial filter 18 are then passed through a Type-I nonlinear crystal 142 generates entangled photon pairs with the same known polarization from photons 20. Type I nonlinear optical crystals operative herein illustratively include beta-barium borate, potassium niobate, lithium triborate and cesium lithium borate. Preferably, the crystal 142 is tuned for non-degenerative down conversion with regard to dichroic mirror 144. Dichroic mirror 144 is tuned to reflect one of the entangled pair and pass the other. The entangled photon pair Q1, Q2 with same known polarization 146 is separated by an optional dichroic mirror or bandpass filter that is operative to transmit specified wavelengths and reflect all others 24 which is used to selectively reflect out of the path 26 those photons 28 that have reflected wavelengths as a result of passing through the crystal 22 into a stop 30. The nearly monochromatic known polarization beam 148 comprising photons or qubits Q1, Q2 is incident on polarization beam splitter 32 and that component with a known photon state 150 is directed through a polarization modulator 44, a phase modulator 46 to yield an arbitrarily oriented polarization state 158 that is optionally reflected off mirror 50 and into interferometer 60 that has the geometry of a polarization Mach-Zehnder interferometer. Second photon state 156 is directed onto beam stop 160. The arbitrarily oriented elliptical polarization state 158 retains characteristics of the data set signal to be subsequently transformed in any previously measured photon state, if such is known. The interferometer 60 depicted has the geometry of a polarization Mach-Zehnder interferometer and includes a polarization beam splitter 62 that transmits one portion 162 to a phase modulator 66 resulting in a phase shift in the light component 168 reaching polarization beam splitter 70 relative to the other polarization component 170. Polarization beam splitter 70 recombines beam components 168 and 170 to complete a quantum Fourier transform on the recombined state 172 from the interferometer 60. Ancillary mirrors collectively number 76 are provided to reflect light in desired directions. The recombined state 172 is such that one of the photons of an entangled photon pair is reflected by dichroic mirror 144 to single photon counting module 38 while the other photon of the entangled photon pair will be transmitted onto the half wave plate 78.

Continuing to the left side of FIG. 6, entangled photon source 250 provides entangled photons P1 and P2. In the drawing, for explanatory purposes, the second entangled photon P2 is repeated as an input into the Bell state measurement element 251 (represented by the square with a diagonal line). Within the Bell state measurement element 251, entangled photon P2 and the informational qubit Q1 (which passes through the interferometer 122 and which passes via the path 74) interact via quantum interference. Note that as discussed above, the informational photon may have passed though the half wave plate 78, which implements a quantum Hadamard gate transformation thereon. In the Bell state measurement element 251, the entanglement takes place between the entangled photon P2 and the informational photon. This interaction is depicted in FIG. 10A, which depicts photon P2 and qubit Q1 undergoing a joint Bell state measurement. The determination of the Bell measurement, a joint quantum-mechanical measurement of two qubits, determines which of the four Bell states the two qubit system (Q1 and P2) exists. This is recorded by the photodetectors 252, 253, and the results are referred to herein as the “two-bit measurement.”

It is noted again that in the general context of the entangled photons P1 and P2 being separated with photon P1 being at the receiving side and the photon P2 being at the sender, information contained in the qubit Q1 may be transmitted from the sender to the receiver with only the two-bit measurement (recorded by detectors 252, 253) being physically transmitted. The half wave plate 78 provides a qubit prioritized input 80 to a polarization beam splitter 82. Note that the half wave plate 78 may optionally be positioned following the Unitary Transformation circuitry 260 (as shown by dotted lines).

As explained in the foregoing (regarding the unitary transformation operation) when the sender wishes to send a qubit (quantum teleportation) the sender will perform a Bell measurement with sender's half of the shared entangled quantum system and the qubit to be transferred to the receiver (at elements 251, 252, 253). The outcome of the Bell measurement will be sent to the receiver over classical channels and consists of two bits. When the receiver gets the two bits (transferred via computer 211 to the unitary transformation element 260) the receiver applies to their remaining portion of the initially shared entangled state one of four unitary operations depending upon what the two bits indicate. Typically these operations can be represented by a matrix and correspond to the Identity matrix and three other matrices. For example,

$$I = \vert \begin{matrix}1 & 0 \\ 0 & 1\end{matrix} \vert , T 1 = \vert \begin{matrix}1 & 0 \\ 0 & - 1\end{matrix} \vert , T 2 = \vert \begin{matrix}0 & 1 \\ 1 & 0\end{matrix} \vert , and T 3 = \vert \begin{matrix}0 & - 1 \\ 1 & 0\end{matrix} \vert .$$

The matrices are called unitary because they do not change the length, \sqrt{a²+b²}, of the vector that the matrix multiplies. After this operation, the receiver will possess the quantum information of the qubit that the sender transmitted. The unitary operation may (260) be performed by an element comprising, for example, a half wave plate and a quarter wave plate. For example, if the identity matrix is to be applied, nothing is down with the remaining portion of the initially shared entangled state. If the two bits indicate that the matrix T2 is to be applied the half wave plate will perform a ninety degree rotation. If T1 is to be applied, then two suitable quarter wave plate operations will be performed. If T3 is to be applied, then two suitable quarter wave plate operations followed by a suitable half wave plate operation will be performed. The outcome of the unitary transformation operation is detected by detectors 84, 86 via beamsplitter 82.

Continuing, in the left side of FIG. 6 single photon counting modules 84 and 86 count individual photons with a given polarization and report a counting event to coincidence electronics 42. Only when coincidence is noted between a photon counting event at module 38 and 84, or between module 38 and module 86 is the count considered a valid probability density function measurement. Note that in all embodiments of FIGS. 3-8, one result of detectors 84, 86 is the determination of which branch (or whether or not a branch will be undertaken, the finishing stage of the QFT) of the branches depicted in FIGS. 2A-2D with respect to the Quantum Binary Tree. Moreover, the result is represented by Q1′ in FIG. 10A. The representation Q1′ refers to the transferred photon information state and can be many bits per photon transferred.

Referring now to FIG. 7, a Type-I nonlinear optical crystal analog system 180 is depicted. A data encoder 12 converts the data set to a set of qubit amplitudes that satisfies the expression of Equation 15 and triggers a light source 14 accordingly. Photons in path 16 emitted from the light source 14 are optionally passed through a spatial filter 18. The photons 20 having passed through spatial filter 18 are then passed through a Type-I nonlinear crystal 14 that generates entangled photon pairs Q1, Q2 with the same known polarization via path 20. Preferably, the crystal 142 is tuned for non-degenerative down conversion with regard to dichroic mirror 144 that is operative to separate the non-degenerate down converted wavelengths. The entangled photon pairs Q1, Q2 with same known polarization in path 146 is separated from reflected frequency shifted components in path 145 by optional dichroic mirror or bandpass filter 24 that are terminated at beam stop 30. The nearly monochromatic known polarization beam in path 148 is incident on polarization beam splitter 32 and that component with a known photon state in path 150 is directed through a polarization modulator 44, a phase modulator 46 to yield an arbitrarily oriented elliptical polarization state entangled photons in path 158 that are reflected off mirror 50 and into an interferometer shown generally at 92 that has the geometry of a polarization Michelson interferometer. The arbitrarily oriented elliptical polarization state in path 158 retains characteristics of the data set signal to be subsequently transformed in any previously measured photon state, if such is known. The interferometer 92 is identical to the interferometer 92 in FIG. 4. The interferometer 92 receives the photon pairs Q1, Q2 in the arbitrarily oriented elliptical polarization state on path 158 incident on a polarization beam splitter 62 that splits the arbitrarily oriented elliptical polarization state photon wavefunctions Q1 and Q2 in path 158 with one component of the polarization wavefunction for Q1 and Q2 in path 183 phase shifted at phase modulator 94 relative to the other polarization wavefunction component for photons Q1 and Q2 in path 186. The polarization components of photons in path 186 interact with a quarter wave plate 98 two times rotating polarization by 90 degrees. Phase polarization wavefunction components in path 186 are then reflected from mirror 100 back to polarization beam splitter 62 where the wavefunction components in path 96 are recombined with phase shifted polarization components in path 183 that has passed through polarization modulator 94, a quarter wave plate 102 two times rotating the polarization by 90 degrees and returning to polarization beam splitter through reflection off of translating mirror 104. The combined state 74 is transmitted through a half wave plate 78 oriented so as to perform a quantum Hadamard transform to yield recombined transformed output 189. Note that the half wave plate 78 may optionally be positioned following the Unitary Transformation circuitry 260 (as shown by dotted lines). The recombined transformed output 189 is such that one of the photon components (e.g., Q2) thereof is reflected by dichroic mirror 144 to single photon counting module 38 while the other photon component (e.g., Q1) is directed to Bell measurement element 251. Continuing to the left side of FIG. 7, entangled photon source 250 provides entangled photons P1 and P2. In the drawing, for explanatory purposes, the second entangled photon P2 is repeated as an input into the Bell state measurement element 251 (represented by the square with a diagonal line). Within the Bell state measurement element 251, entangled photon P2 and the informational qubit Q1 (which passes through the interferometer 122 and which passes via the path 74) interact via quantum interference. Note that as discussed above, the informational photon may have passed though the half wave plate 78, which implements a quantum Hadamard gate transformation thereon. In the Bell state measurement element 251, the measurement takes place between the entangled photon P2 and the informational photon. This interaction is depicted in FIG. 10A, which depicts photon P2 and qubit Q1 undergoing a joint Bell state measurement. The determination of the Bell measurement, a joint quantum-mechanical measurement of two qubits, determines which of the four Bell states the two qubit system (Q1 and P2) exists. This is recorded by the photodetectors 252, 253, and the results are referred to herein as the “two-bit measurement.”

It is noted again that in the general context of the entangled photons P1 and P2 being separated with photon P1 being at the receiving side and the photon P2 being at the sender, information contained in the qubit Q1 may be transmitted from the sender to the receiver with only the two-bit measurement (recorded by detectors 252, 253) being physically transmitted.

As explained in the foregoing (regarding the unitary transformation operation), when the sender wishes to send a qubit (quantum teleportation) the sender will perform a Bell measurement with sender's half of the shared entangled quantum system and the qubit to be transferred to the receiver (at elements 251, 252, 253). The outcome of the Bell measurement will be sent to the receiver over classical channels and consists of two bits. When the receiver gets the two bits (transferred via computer 211 to the unitary transformation element 260) the receiver applies to their remaining portion of the initially shared entangled state one of four unitary operations depending upon what the two bits indicate. Typically these operations can be represented by a matrix and correspond to the Identity matrix and three other matrices. For example,

$$I = \vert \begin{matrix}1 & 0 \\ 0 & 1\end{matrix} \vert , T 1 = \vert \begin{matrix}1 & 0 \\ 0 & - 1\end{matrix} \vert , T 2 = \vert \begin{matrix}0 & 1 \\ 1 & 0\end{matrix} \vert , and T 3 = \vert \begin{matrix}0 & - 1 \\ 1 & 0\end{matrix} \vert .$$

The matrices are called unitary because they do not change the length, \sqrt{a²+b²}, of the vector that the matrix multiplies. After this operation, the receiver will possess the quantum information of the qubit that the sender transmitted. The unitary operation may (260) be performed by an element comprising, for example, a half wave plate and a quarter wave plate. For example, if the identity matrix is to be applied, nothing is done with the remaining portion of the initially shared entangled state. If the two bits indicate that the matrix T2 is to be applied the half wave plate will perform a ninety degree rotation. If T1 is to be applied, then two suitable quarter wave plate operations will be performed. If T3 is to be applied, then two suitable quarter wave plate operations followed by a suitable half wave plate operation will be performed. The outcome of the unitary transformation operation is detected by detectors 84, 86 via beamsplitter 82. Note that in all embodiments of FIGS. 3-8, one result of detectors 84, 86 is the determination of which branch (or whether or not a branch will be undertaken, the finishing stage of the QFT) of the branches depicted in FIGS. 2A-2D with respect to the Quantum Binary Tree. Moreover, the result is represented by Q1′ in FIG. 10A. The representation Q1′ refers to the transferred photon information state and can be many bits per photon transferred.

Continuing, in the left side of FIG. 7 single photon counting modules 84 and 86 count individual photons with a given polarization and report a counting event to coincidence electronics 42. Only when coincidence is noted between a photon counting event at module 38 and 84, or between module 38 and module 86 is the count considered a valid probability density function measurement.

Referring now to FIG. 8, a Type-I nonlinear optical crystal analog system 200 is depicted, which in general is similar to the system 120 of FIG. 5 (for example, interferometers 122 are present in both systems 120 and 200) and where like numerals used with reference to FIG. 5 correspond to the description of those previously described with respect to the proceeding figures. In FIG. 8, a Type-I nonlinear crystal 142 generates entangled photon pairs with the same known polarization from photons passing in path 20. Preferably, the crystal 142 is tuned for non-degenerative down conversion with regard to dichroic mirror 144. The known polarization beam of entangled photons in path 148 is incident on polarization beam splitter 32 that operates to transmit one polarization component and reflect other polarization components and that component with a known photon polarization state in path 150 is directed to a polarization modulator 44. As in all of the embodiments in FIGS. 5-8, the polarization modulator 44 and phase modulator 46 are controlled by computer 207, which determines which half of the data to process (as explained with reference to FIG. 2B) based upon the last measurement fed back from coincident detector 42, which is connected to the computer 207 by lines 209 and 210. The component with a known photon state is directed through a polarization modulator 44 and phase modulator 46 to yield an arbitrarily oriented elliptical polarization state in path 158 that is reflected off mirror 50 and into an interferometer shown generally at 122 that has the geometry of a polarization Sagnac interferometer. The arbitrarily oriented elliptical polarization state in path 158 retains characteristics of the data set signal to be subsequently transformed in any previously measured photon state, if such is known. The interferometer 122 comprises like elements referenced by the same numerals as the interferometer 122 of FIG. 5 and receives the arbitrarily oriented elliptical polarization state in path 158 incident on a polarization beam splitter 62 that splits the arbitrarily oriented elliptical polarization state in path 158 to phase shift a polarization component in path 203 through interaction with a phase modulator 94. Phase Modulator 94 is also connected to computer 207 by lines 208 and 210. The computer 207 controls the phase modulator 94 depending upon the stage of the Fourier transform.

In connection with the embodiments depicted in FIGS. 4, 5, 7 and 8, optionally, a second computer 211 may be used to control phase modulator 94 if the phase modulator is at a remote location. The second component (of the entangled photon pair Q1, Q2) in path 206 is recombined with the phase shifted component 203 (of the entangled photon pair Q1, Q2) through coincidental reflection with the mirrors collectively labeled 128. The combined state 187 is transmitted through a half wave plate 78 oriented so as to perform a quantum Hadamard transform to yield recombined transformed output 189. Note that the half wave plate 78 may optionally be positioned following the Unitary Transformation circuitry 260 (as shown by dotted lines). The recombined transformed output 189 is such that one of the photon components thereof is reflected by dichroic mirror 144 to single photon counting module 38 while the other photon component is processed as follows.

Continuing to the left side of FIG. 8, entangled photon source 250 provides entangled photons P1 and P2. In the drawing, for explanatory purposes, the second entangled photon P2 is repeated as an input into the Bell state measurement element 251 (represented by the square with a diagonal line). Within the Bell state measurement element 251, entangled photon P2 and the informational qubit Q1 (which passes through the interferometer 122 and which passes via the path 74) interact via quantum interference. Note that as discussed above, the informational photon may have passed though the half wave plate 78, which implements a quantum Hadamard gate transformation thereon. In the Bell state measurement element 251, the measurement takes place between the entangled photon P2 and the informational photon. This interaction is depicted in FIG. 10A, which depicts photon P2 and qubit Q1 undergoing a joint Bell state measurement. The determination of the Bell measurement, a joint quantum-mechanical measurement of two qubits, determines which of the four Bell states the two qubit system (Q1 and P2) exists. This is recorded by the photodetectors 252, 253, and the results are referred to herein as the “two-bit measurement.”

It is noted again that in the general context of the entangled photons P1 and P2 being separated with photon P1 being at the receiving side and the photon P2 being at the sender, information contained in the qubit Q1 may be transmitted from the sender to the receiver with only the two-bit measurement (recorded by detectors 252, 253) being physically transmitted. The half wave plate 78 provides a qubit prioritized input 80 to a polarization beam splitter 82 and yields a single photon registered on one of the single photon counting modules 84 or 86. Note that the half wave plate 78 may optionally be positioned following the Unitary Transformation circuitry 260 (as shown by dotted lines).

As explained in the foregoing (regarding the unitary transformation operation) when the sender wishes to send a qubit (quantum teleportation) the sender will perform a Bell measurement with sender's half of the shared entangled quantum system and the qubit to be transferred to the receiver (at elements 251, 252, 253). The outcome of the Bell measurement will be sent to the receiver over classical channels and consists of two bits. When the receiver gets the two bits (transferred via computer 211 to the unitary transformation element 260) the receiver applies to their remaining portion of the initially shared entangled state one of four unitary operations depending upon what the two bits indicate. Typically these operations can be represented by a matrix and correspond to the Identity matrix and three other matrices. For example,

$$I = \vert \begin{matrix}1 & 0 \\ 0 & 1\end{matrix} \vert , T 1 = \vert \begin{matrix}1 & 0 \\ 0 & - 1\end{matrix} \vert , T 2 = \vert \begin{matrix}0 & 1 \\ 1 & 0\end{matrix} \vert , and T 3 = \vert \begin{matrix}0 & - 1 \\ 1 & 0\end{matrix} \vert .$$

The matrices are called unitary because they do not change the length, \sqrt{a²+b²}, of the vector that the matrix multiplies. After this operation, the receiver will possess the quantum information of the qubit that the sender transmitted. The unitary operation may (260) be performed by an element comprising, for example, a half wave plate and a quarter wave plate. For example, if the identity matrix is to be applied, nothing is done with the remaining portion of the initially shared entangled state. If the two bits indicate that the matrix T2 is to be applied the half wave plate will perform a ninety degree rotation. If T1 is to be applied, then two suitable quarter wave plate operations will be performed. If T3 is to be applied, then two suitable quarter wave plate operations followed by a suitable half wave plate operation will be performed. The outcome of the unitary transformation operation is detected by detectors 84, 86 via beamsplitter 82. Note that in all embodiments of FIGS. 3-8, one result of detectors 84, 86 is the determination of which branch (or whether or not a branch will be undertaken, the finishing stage of the Quantum Fourier Transform (QFT)) of the branches depicted in FIGS. 2A-2D with respect to the Quantum Binary Tree. Moreover, the result is represented by Q1′ in FIG. 10A. The representation Q1′ refers to the transferred photon information state and can be many bits per photon transferred.

Continuing, in the left side of FIG. 8, single photon counting modules 84 and 86 count individual photons with a given polarization and report a counting event to coincidence electronics 42. Only when coincidence is noted between a photon counting event at module 38 and 84, or between module 38 and module 86 is the count considered a valid probability density function measurement.

The coincidence electronics 42 feed the result back to the computer 207 via lines 209 and 210 so that the computer 207 determines which portion of the data to process next and how to prepare the data bases on the last measurement detected by the coincident electronics. The feature is depicted in FIG. 2B where dotted lines are used to show data paths which are no longer in use and the BINS labeled R are no longer used while the BINS labeled L remain to be processed. By making a determination not to use the 4 BINS labeled R as depicted in FIG. 2B, data compression is achieved.

It is noted the foregoing depicts the functions of respective elements that are controlled or implemented by a computer. Such operations may be performed, for example by or in conjunction with the computer labeled as Computer 207 in FIGS. 3-8, which depicts a classic computer, and the capabilities of computer 207 or associated computers may include the loading with an input signal. The computer 207 (or associated computers) then performs a quantum Fourier transform and either a classical inverse Fourier transform or a quantum inverse Fourier transform. The output of system 207 (or associated computers) may be provided to a buffer store (not shown). From the buffer store it may be provided to an output device on either a real time or delayed basis as still images, video images, movies, audio sound representations, and the like. Computer or processor 207 may be loaded with the input signal that determines the wave function amplitudes that satisfy Equation 15, controls modulators 44 and 46, and controls the phase shift elements (e.g. 66 in FIG. 3). Processor 207 is also operatively connected to coincidence electronics 42. The coincidence electronics serve to determine when a valid Bell State measurement has occurred by a coincidence between a detection event at, for example, detector 38 in FIGS. 3-8 and the Bell State measurement indicated by detectors 252 and 253. Processor 207 would then classically communicate, e.g. via the Internet etc, two bits that represent the outcome of the Bell State measurement to processor 211 optionally with a time stamp provided by 42 indicating when the coincidence took place. Computer 211 may be operationally connected to Unitary transformer 260, coincidence electronics 42 and one half of an entangled pair of photons P1, and detectors 86 and 84. On receiving two bits from Processor 207, computer 211 then sets the Unitary transformer 260 to the appropriate matrix values as described above to transform photon P1 into the quantum photon state at path 74 to complete the quantum teleportation of information operation. Computer 211 records the result of the measurement at 84, 86 and communicates to Processor 207 that result so that the next qubit can be teleported along the correct branch of the quantum binary tree (FIG. 2A). Computer 211 can then perform either a classical inverse Fourier transform or a quantum inverse Fourier transform to recover the signal communicated by processor 207. The output of system 211 may be provided to a buffer store (not shown). From the buffer store it may be provided to an output device on either a real time or delayed basis as still images, video images, movies, audio sound representations, and the like.

### Example

### Sound Spectrum Computation

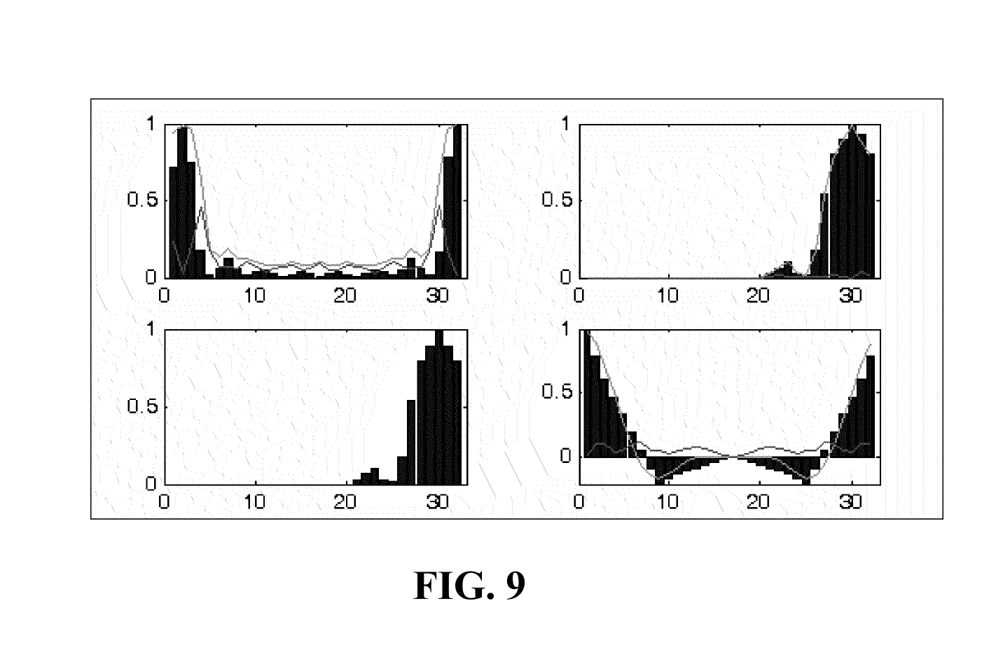

In order to evaluate the ability of the inventive quantum algorithm to compress and transmit a signal representative of the data set with a comparatively small number of photons, 32 sound samples defining a normalized arbitrary spectrum are provided in the top left panel of FIG. 9. The histogram defines a quantized spectrum while the solid lines superimposed thereover represent classical Fourier (gray line) transform and QFT (black line) fits to the data. The 32 sound sample elements of the top left spectrum are amenable to storage and operation on 2ⁿ or 4 qubits. The top right panel of FIG. 9 represents a single statistical evaluation of the arbitrary spectrum depicted in the top left panel. The line superimpositions on the histogram in the top right represents a classical and quantum magnitude superposition. The lower left panel is duplicative of the conventional four photon single evaluation of the arbitrary spectrum (upper left panel) and represents the input signal into the processor 207 depicted in FIG. 3. The lower right panel depicts the reconstructed arbitrary spectrum (upper left panel) based on quantum Fourier transform as described herein, followed by an inverse Fourier transform. The solid overlapping lines represent reconstructed probability and classical magnitudes.

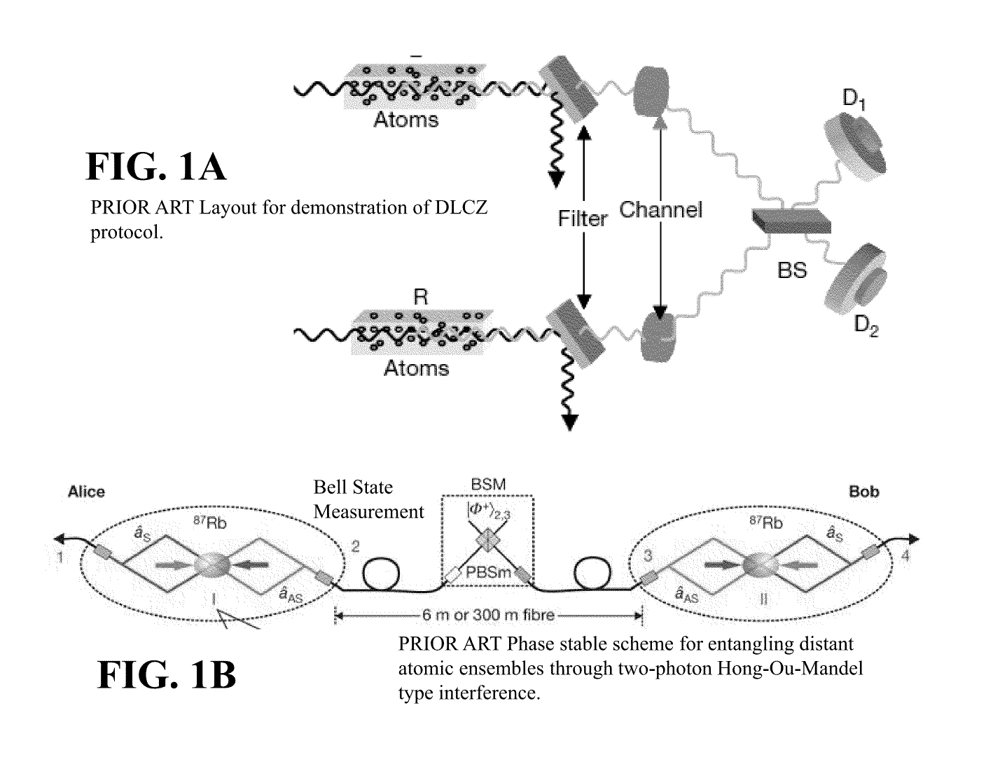

FIG. 10A is a schematic depiction of the concept of the preferred embodiment system of FIGS. 3 through 8 in which a qubit Q1 of converted data is transferred to the receiver as a photon state. Bold dashed arrowed lines indicate the travel paths of individual portions of an entangled photon pair generated by the entangled photon source 250. Filled eight-sided stars P1 and P2 indicate each part of an entangled photon pair. The dotted line between the stars represents the entanglement of the two photons. The crossed circle indicates the qubit Q1 of data to be converted. The bold arrowed dash-dot line in the upper right of FIG. 10A denotes the direction and travel path for the qubit (or photon information to be transferred) of data to be converted. The square with a diagonal line, element 251) represents the presence of a device that performs a Bell state measurement. Such devices may be for example optical elements such as beam splitters and waveplates coupled with nonlinear interactions (as described in Yoon-Ho Kim, Sergei P. Kulik, and Yanhua Shih, “Quantum Teleportation of a Polarization State with a Complete Bell State Measurement,” Physical Review Letters, Vol. 86, No. 7, pp. 1370-1373, (2001) (herein incorporated by reference), or Bell state detection is done sequentially using Raman transitions for atomic systems, as described in Lloyd, S., et al. “Long Distance, Unconditional Teleportation of Atomic States via Complete Bell State Measurements,” Phys. Rev. Lett. Volume 87, Number 16, page 167903-1 (2001), herein incorporated by reference. Note that Ronald E. Meyers, et al., “A Quantum Network with Atoms and Photons (QNET-AP),” US Army Research Laboratory, Adelphi, Md. 20783, Proc. SPIE 8518, Quantum Communications and Quantum Imaging X, 85180G (Oct. 17, 2012); (herein incorporated by reference) proposes a configuration similar to FIG. 1B but using photonic qubit wavelength conversion between atomic emissions and photons at telecommunication wavelengths in fiber in order to optimize photon qubit transmission distance before absorption in optical fiber.

An example of a Bell state measurement device is shown to the right in FIG. 10A, wherein the Bell state measurement element or device 251 comprises a beam splitter and includes four number resolving detectors. A photon number resolving detector is able to tell whether it measured one photon or two within its measurement. Birefringent elements on each outlet side of the beam splitter delay polarization components with respect to the other of the same photon wavefunction. As shown to the right in FIG. 10A, after the birefringent elements, two polarizing beam splitters are aligned to 45 degrees that measure the four Bell states. Note that there are two birefringent elements are at each arm and two detectors at each arm going through 45 degree coincidence (for example, as to the Bell state, double clicking for φ⁺). Note that the qubit and the second entangled photon are interfering in Bell state measurement element and that the Bell state measurement is a joint measurement corresponding to the photons interaction. Each photon has a polarization and phase; their wavefunctions are going to exit the beam splitter in certain superpositions. The result is the measurement of the components of the wavefunctions that interacted at 251. Q1 will interact with P2 and because of the interaction and entanglement between P2 and P1, information on Q1 is transferred to P1. Thus, information is transferred from the sender to the receiver when the entanglement between P2 and Q1 is transferred to P1 via the unitary transformation element 260 due to the prior entanglement between P1 and P2. At this junction, the information contained in Q1 is outputted from the unitary transfer device 260 as Q1′. A classical communication channel 254 is present, which provides the Bell state measurements received by detectors 252, 253 at the beams splitter 251 where P2 interferes with Q1.

Referring again to FIG. 10A, the arrow double lines represent the travel paths of the photon wavefunctions prior to measurement at a detector. The dash-dot-dot-dash line indicates a “classical” communication channel 254 that extends between the sender and the receiver where two bits of information representing the outcome of the Bell State measurement conducted in element 251 are transmitted to the receiver. In Bell state measurement element 251, a joint measurement is performed between one part of an entangled pair (represented as P2 in FIG. 10A) and the photon to be communicated (represented as Q1). The two bits in channel 254 tell the receiver (and in particular element 260) how to measure the remaining entangled photon. The element 260 in FIG. 10A, 10B represents a device that performs a unitary transformation specified by the two bits of classically transmitted information from the sender (resulting from the outcome of detectors 252, 253) on the remaining portion of the initial entangled photon pair. In element 260, a unitary transformation operation is performed to complete communication. These unitary transformations are often represented by a Pauli matrix. The solid arrowed line indicates the travel path of the transferred qubit, represented by the double-lined crossed circle, towards a detector, as explained above in conjunction with FIGS. 3 through 8. In FIGS. 10A, 10B, the representation Q1′ refers to the transferred photon information state and can be many bits per photon transferred. Elements 82, 84 and 86 operationally connected to Computer 211 serve to complete the measurement of the transferred information. The results of the measurement would be transmitted to Processor 207 (not shown) to be used to prepare the next qubit (Q1) of information to teleported to 211.

FIG. 10B is configured substantially the same as the embodiment of FIG. 10A except that the sources of entangled photons P1 and P2 are the atomic memories A1 and A2 respectively. Filled eight sided stars indicate the photon P1, P2 generated by the entangled quantum memories, the dotted line between the quantum memories representing the two quantum memories A1, A2 are entangled. Bold dashed arrowed lines indicate the travel paths of individual photons P1, P2 generated by the quantum memories A1, A2 that are indicated by gray filled hexagons. The crossed circle Q1 represents the qubit Q1 of quantum information or data to be communicated. The description and operation of the remaining elements of FIG. 10A is the same and is not repeated for the sake of brevity, although the description is incorporated by reference herein as though fully repeated.

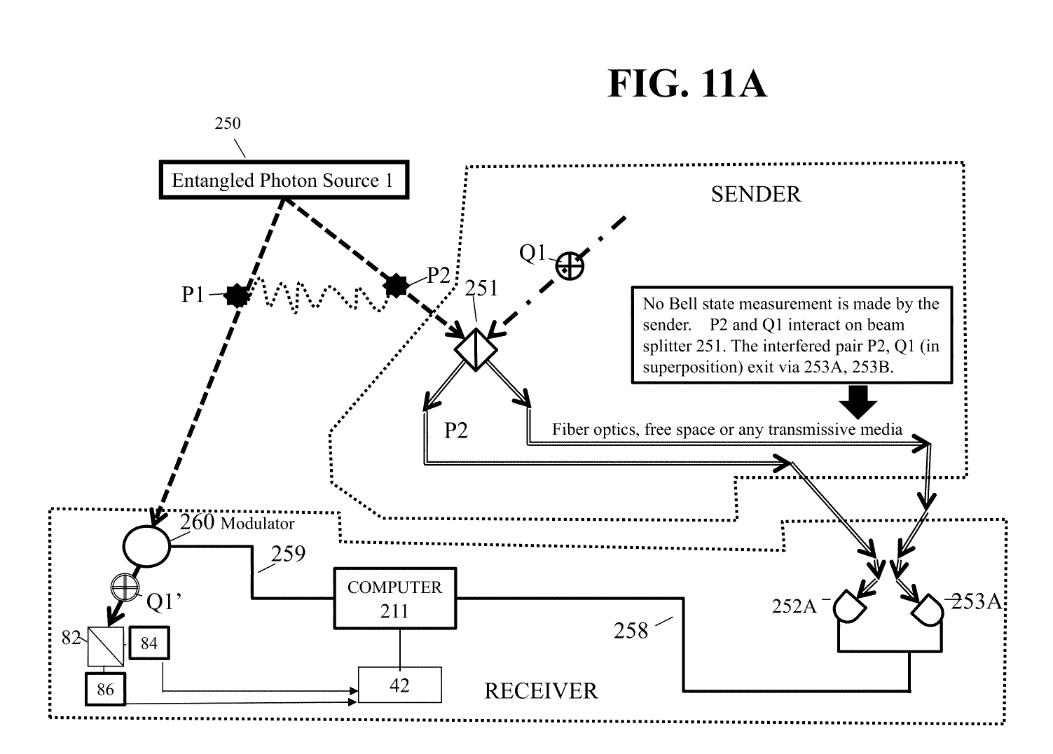

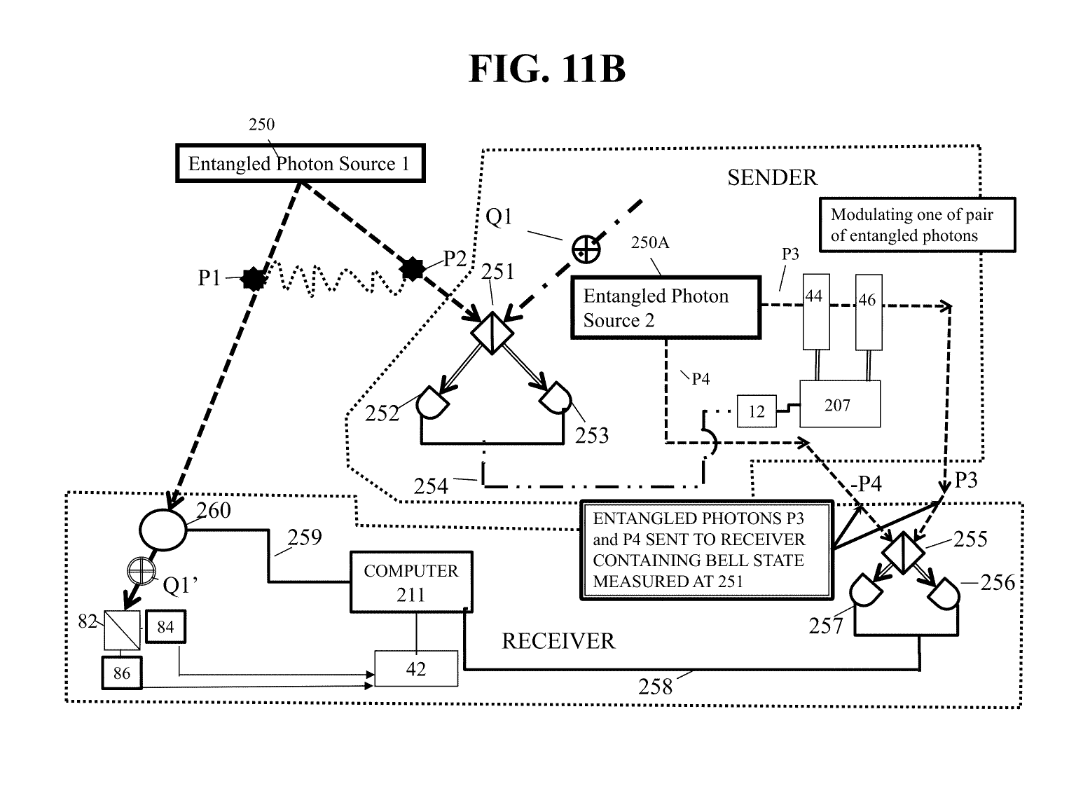

FIGS. 11 A and 11B disclose alternate preferred embodiments similar in nature to FIG. 10A. In the preferred embodiment of FIGS. 11A and 11B, the description and operation of Bell state measurement element 251, unitary transformation element 260, polarization beam splitter 82, detectors 84 and 86, computer 211, are substantially the same as in the embodiments of FIGS. 10A and 10B and are described above.

As is the case of FIG. 10A, the following occurs, the Bell state measurement device or element 251 may be, for example, a beam splitter and includes four number resolving detectors. A photon number resolving detector is able to tell whether it measured one photon or two within its measurement. Birefringent elements on each outlet side of the beam splitter delay polarization components with respect to the other of the same photon wavefunction. As shown to the right in FIG. 10A, after the birefringent elements, two polarizing beam splitters are aligned to 45 degrees that measure the four Bell states. Note that there are two birefringent elements are at each arm and two detectors at each arm going through 45 degree coincidence (for example, as to the Bell state, double clicking for Ψ⁻). Note that the qubit and the second entangled photon are interfering in Bell state measurement element or device and that the Bell state measurement is a joint measurement corresponding to the interaction of the photons. Each photon has a polarization and phase; their wavefunctions are going to exit the beam splitter in certain superpositions. The result is the measurement of the components of the wavefunctions that interacted at 251. Q1 will interact with P2 and because of the interaction and entanglement between P2 and P1, information on Q1 is transferred to P1.

Referring now to FIG. 11A, the classical channel 254 no longer extends between the sender and receiver. Instead the photons split by Bell State measurement element 251 (e.g., beam splitter) are transmitted to the sender and measured by the detectors 252A and 252B on the receiver side. The double lines represent the travel paths of the photon wave functions prior to measurement at detector 252A and 253A. The determination of the Bell measurement, a joint quantum-mechanical measurement of two qubits that determines which of the four Bell states the two qubits are in is recorded by the photodetectors 252A, 252B, also referred to as the “two-bit measurement.” In the context of the FIG. 10A, for example, entangled photons being separated with photon P1 being at the receiving side and the photon P2 being at the sender, information contained in the qubit Q1 may be transmitted from the sender to the receiver with only the two-bit measurement being physically transmitted by classical channels. However, in FIG. 11A, the classical channel is eliminated. The measurement results from the Bell state measurement at 252A and 252B is transferred to computer 211 along path 258. Computer 211 then specifies the setting of unitary transformation element 260 in accordance with the value of the second Bell state measurement.

The unitary transfer element 260 in FIG. 11A is described fully with respect to FIG. 10A and the description is hereby incorporated by reference, As in FIG. 10A, the representation Q1′ refers to the transferred photon information state and can be many bits per photon transferred. Elements 82, 84 and 86 operationally connected to Computer 211 serve to complete the measurement of the transferred information. The results of the measurement would be transmitted to Processor 207 to be used to prepare the next qubit (Q1) of information to teleported to 211.

Referring now to FIG. 11B, the classical channel 254 no longer extends between the sender and receiver. Instead the channel 254 extends to computer 207 via encoder 12, which provides the outcome of the Bell state measurement to processor 207. Unlike FIG. 10A, the classical communication channel between the sender and receiver is replaced by, inter alia, the sending of entangled photons through space or fiber optics as represent by lines containing P3 and P4 passing from the sender to the receiver. Prior to transmission to the receiver, P3 and P4 are modulated. Processor 207 then sets phase and polarization modulators 44 and 46 to set the Bell state of entangled photons P3, P4 to the measured Bell state of Q1 and P2, wherein the outcomes of the detected states measured by 252 and 253 are used to control polarization modulator 44 and phrase modulator 46. In addition, unlike FIG. 10A, a second entangled photon source 250A operates to generate photons P3 and P4. P3 and P4 are related to photons P1 and P2 as the photons are either time-stamped or synchronized. Photon P3 is passed through a polarization modulator 44 and a phase modulator 46. Exemplary polarization phase modulators illustratively include liquid crystals, Kerr cells, and Pockel cells. Preferably, a series of two liquid crystal devices and a quarter wave plate may be used to achieve arbitrary polarization. Upon the entangled photon P3 interacting with the polarization and phase modulators 44 and 46, respectively, the entangled photon P4 is transformed into an arbitrarily oriented elliptical polarization state based on data set signal being transformed and any previously measured photon state, if any is known.

The modulated entangled photon pair P3-P4 is then transmitted to the receiver for measurement on a second Bell state measurement element 255. Detectors 256 and 257 record the Bell state measurement. The measurement from the second Bell state measurement is transferred to computer 211 along path 258. Computer 211 then specifies the setting of unitary transformation element 260 in accordance with the value of the second Bell state measurement. Unitary transformation element 260 in FIG. 11B represents a device that performs a unitary transformation specified by the computer 211 based on the modulated Bell state transmitted from the sender (resulting from the outcome of detectors 252, 253) on the remaining portion of the initial entangled photon pair. The Unitary transformation operation is performed identical to that of FIG. 10A above and the description is incorporated by reference herein. The representation Q1′ refers to the transferred photon information state and can be many bits per photon transferred. Elements 82, 84 and 86 operationally connected to Computer 211 serve to complete the measurement of the transferred information. The results of the measurement are transmitted to Processor 207 to be used to prepare the next qubit (Q1) of information to teleported to 211.

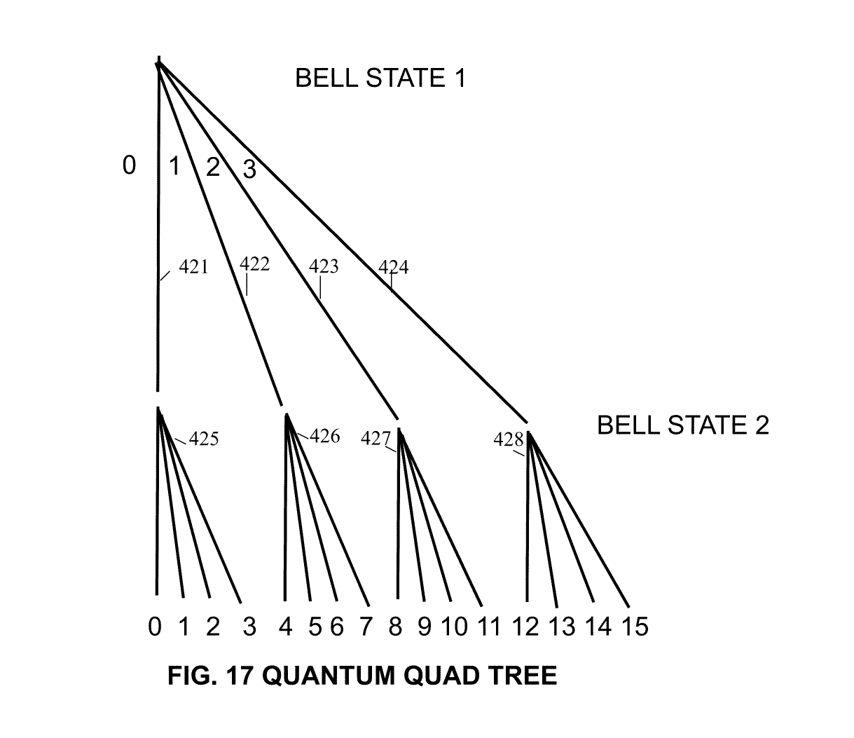

FIG. 12 is a schematic depiction of a preferred embodiment system used for exfiltration from a sensor of remotely generated information. Filled eight sided stars indicate each part of an entangled photon pair P1, P2. Bold dashed arrowed lines indicate the travel paths of individual portion of the entangled photon pair P1, P2 generated by the entangled photon source 250. The dotted swiggly line between the photons P1, P2 is meant to indicate that the two photons are entangled. The bold arrowed dash dot dash line denotes the direction and travel path for the qubit of converted data. The Bell state measurement element 251 (represented throughout the specification by a square with a diagonal line) performs a Bell State measurement. Similarly, 82 is a Bell State measurement device throughout the specification. At Bell State measurement device 251 in FIG. 12, a joint measurement takes place between a time offset part of an entangled photon pair P1, P2 and modulated (earlier in time) photon. The delay occurs due to the path length difference that P1 travels from 250 to 271 and then to 251 optical delay 257 ensures overlap between the entangled photon P1_{M} from the distant qubit modulator 271 and the entangled photon generated by the source 250 at a later time. The arrowed double lines represent the travel paths of the photon wavefunctions prior to measurement at detectors 252, 253. The distant qubit modulator 271 may be, for example, be operatively connected to a distant sensor 272 that measures information from the local area, the qubit modulator 271 modulates the quantum state of an entangled photon from the entangled photon source to represent the information acquired from the vicinity of the sensor 272. The optical delay 257 is a device to ensure overlap of the modulated entangled photon wavefunction returning from the remote sensor 271 with the wavefunction of a portion of an entangled photon pair generated by the entangled photon source 250 at a subsequent time. The outcome of the Bell measurement performed by 251 contains information from the remote sensor 271. As an exfiltration example, assume that the distant sensor at 272 is a device that counts the number of hostile troops traversing a particular area, such a crossing a bridge. In this instance say 12 hostile troops have been measured by 272 to have crossed that bridge over some time interval. The information from sensor 272 needs to be exfiltrated. The exfiltration process happens when a quantum sender and receiver consisting of an entangled photon source 250, Bell state measurement system 251, detectors 252, 253, optical delay element 257, coincidence electronics 42, and computer 258. At time T the quantum sender and receiver would transmit one half of an entangled photon state P1 towards the qubit modulator 271 and the other half of the entangled state P2 is directed towards the Bell state measurement element 251. The photons P1 and P2 are entangled in a known Bell state. At time T+1dt the photon P2 has interacted with the Bell state measurement system or element and been destroyed. Photon P1 would then interact with and be modulated by the qubit modulator 271 at time T+2dt. At time T+3dt the quantum sender transmits another pair of entangled photons with P1 directed towards 271 and P2 directed towards 251. At time T+4dt, the P1 photon created at time T which has been modulated by 271 undergoes a joint Bell state measurement with photon P2 that was created at time T+3dt. Due to the modulation applied by 271 the Bell state that would be measured corresponds to branch 3 of “Bell State 1” on FIG. 17. The next Bell state measurement occurs at time T+8dt and would correspond to branch 0 of “Bell State 2” on FIG. 17. This would complete the transmission of a “12” to the quantum sender and receiver and be a successful exfiltration of that information from the modulator 271 and sensor 272 as only a few photons are needed and if any of those photons were intercepted there is no information unique to the photons P1, all the information is instead encoded into the Bell states of the P1 and P2 when measured by 251. This is enabled by the transmission of a known Bell state to the modulator 271 and based on the known transmitted Bell state is able to modulate that known state towards a particular outcome when measured.

FIG. 13 is a schematic depiction of an alternate system 300 utilizing a Mach-Zehnder configuration, wherein a single qubit of quantum information encoded into a photon is frequency/wavelength converted prior to transmission, detection, or manipulation to a more favorable frequency/wavelength. Beginning with a laser pump source 301, the laser beam is pumped into a polarization controller 302 that sets the pump polarization at 45 degrees. Next a wave division multiplexer or dichroic mirror 303 transmits the generation of a single photon from single photon generator 304. Arrowed dotted lines indicate the travel path for the photon carrying the encoded quantum information. Arrowed solid lines indicate the path for the high flux laser pump photons. Elements 306, 308 labeled PC-SET or PC (90R) indicate polarization altering devices such as polarizers and wave plates. The wave division multiplexers (WDM) 303 and 312 represent optical devices to combine or separate the wavelengths/frequencies of the pump photons with the quantum information photons onto a common or different optical path. For example, the wave division multiplexer or dichroic mirror 303 transmits λ₁ and reflects λ_{P} or all other λ.

The arrowed double lines indicate the travel paths for the combined pump photons and qubit photons. Polarizing beam splitter 305 transmits and reflects the orthogonal polarization components of the wavefunction of the qubit photon and pump photons. Polarizing Beamsplitter (PBS) 305 and 309 always transmit one of the orthogonal components and reflects the other. Polarization controller 306 operates to rotate pump polarization and single photon wavefunction polarization by 90 degrees. The nonlinear media boxes 307 and 310 are the locations where the quantum frequency conversion takes place employing either sum-frequency-generation or difference-frequency-generation. An optical delay line 311 operates to ensure wavefunction overlap at the polarizing beamsplitter 309 (PBS 2). The Box 313 labeled beam-stop is a device to capture excess pump photons and noise photons produced in the SFG or DFG device. The arrowed dashed line indicates the travel path of the frequency/wavelength converted qubit. This converted qubit Q1 may then be coupled into transmission optics or into optical devices for manipulation or detection. The net result of the system 300 operation is to in essence create a “quantum information waveguide” for the single photon produced at generator 304, the orthogonal components of which are split by beam splitter 305, frequency “converted” by nonlinear media 307, 310, recombined at beamsplitter 309, and filtered at elements 312, 313.

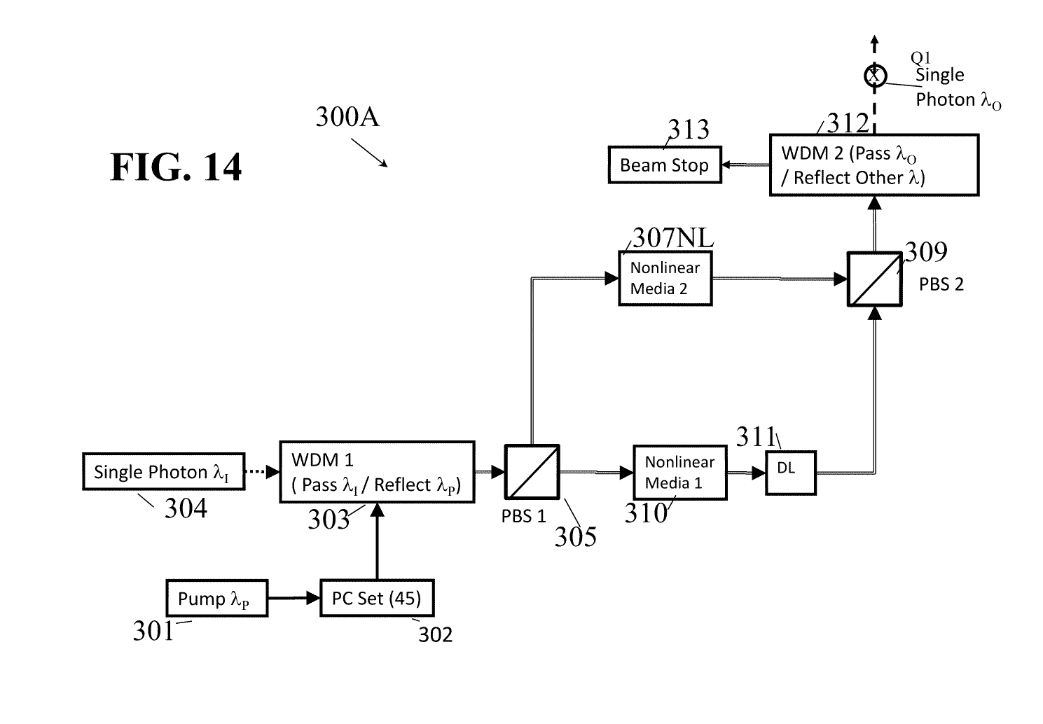

FIG. 14 is a schematic depiction of an embodiment similar to that of FIG. 13 with the exception of the omission of the polarization controller 306 and the inclusion of the nonlinear crystal 2 that is cut 90 degrees from the nonlinear crystal 1. Note that the delay line 311 is included to fine tune the overlap of the wavefunction components on PBS 2. The nonlinear media in FIG. 14 is oriented to function with the polarization of the photons along each path.

Referring to the details of FIG. 14, a schematic depiction of an alternate preferred embodiment system 300A utilizing a Mach-Zehnder configuration, wherein a single qubit of quantum information encoded into a photon is frequency/wavelength converted prior to transmission, detection, or manipulation to a more favorable frequency/wavelength. Beginning with a laser pump source 301 with wavelength λ_{P}, the laser beam is pumped into a polarization controller 302 that sets the pump polarization at 45 degrees. Next a wave division multiplexer or dichroic mirror 303 transmits the generation of a single photon from single photon generator 304. Wave division multiplexer or dichroic mirror Wave division multiplexer or dichroic mirror that transmits λ₁, and reflects Wave division multiplexer or dichroic mirror that transmits λ₁ and reflects λ_{P}, or all other λ. Arrowed dotted lines indicate the travel path for the photon carrying the encoded quantum information. Arrowed solid lines indicate the path for the high flux laser pump photons. The wave division multiplexers (WDM) 303 and 312 represent optical devices to combine or separate the wavelengths/frequencies of the pump photons with the quantum information photons onto a common or different optical path. For example, the wave division multiplexer or dichroic mirror 303 transmits λ₁ and reflects λ_{P} or all other λ.

The arrowed double lines indicate the travel paths for the combined pump photons and qubit photons. Next, polarizing beam splitter 305 transmits and reflects the orthogonal polarization components of the wavefunction of the qubit photon and pump photons. Polarizing Beamsplitter (PBS) 305 and 309 always transmit one of the orthogonal components and reflects the other. Polarization controller 306 operates to rotate pump polarization and single photon wavefunction polarization by 90 degrees. The nonlinear media boxes 307NL and 310NC are the locations where the quantum frequency conversion takes place employing either sum-frequency-generation or difference-frequency-generation. Specifically, at 307 NL, the nonlinear media is oriented 90 degrees from nonlinear nonlinear media 310NC. An optical delay line 311 operates to ensure wavefunction overlap at the polarizing beamsplitter 309 (PBS 2). The beam stop 313 is a device to capture excess pump photons and noise photons produced in the SFG or DFG device. Wave division multiplexer or dichroic mirror 312 transmits λ₀ and reflects all other λ. The arrowed dashed line indicates the travel path of the frequency/wavelength converted qubit Q1. This converted qubit Q1 may then be coupled into transmission optics or into optical devices for manipulation or detection. The net result of the system 300A operation is to in essence create a “quantum information waveguide” for the single photon produced at 304, the orthogonal components of which are split by beam splitter 305, frequency “converted” by nonlinear media 307NL, 310NC, recombined at beamsplitter 309, and filtered at elements 312, 313.

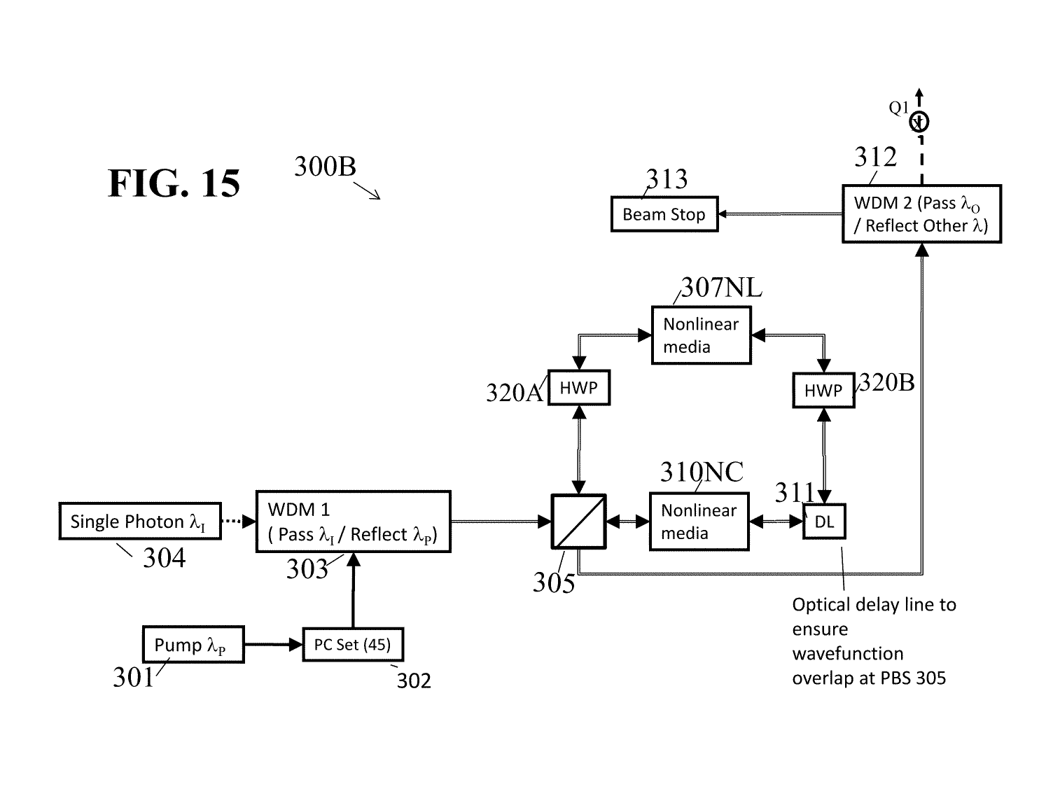

Referring to the details of FIG. 15, a schematic depiction of an embodiment 300B utilizing a Sagnac configuration, wherein a single qubit of quantum information encoded into a photon is frequency/wavelength converted prior to transmission, detection, or manipulation to a more favorable frequency/wavelength. An advantage of the Sagnac configuration is that the wavefunctions of all the photons travel through the same optical devices in both polarizations which help to mitigate polarization dependent birefringence effects between the orthogonal polarization components. Beginning with a laser pump source 301 with wavelength λ₁, the laser beam is pumped into a polarization controller 302 that sets the pump polarization at 45 degrees. Next a wave division multiplexer or dichroic mirror 303 transmits the generation of a single photon from single photon generator 304. The wave division multiplexer or dichroic mirror Wave division multiplexer or dichroic mirror that transmits λ₁, and reflects λ_{P}, or all other λ. Arrowed dotted lines indicate the travel path for the photon carrying the encoded quantum information. Arrowed solid lines indicate the path for the high flux laser pump photons. The wave division multiplexers (WDM) 303 and 312 represent optical devices to combine or separate the wavelengths/frequencies of the pump photons with the quantum information photons onto a common or different optical path. For example, the wave division multiplexer or dichroic mirror 303 transmits λ₁ and reflects λ_{P} or all other λ.

The arrowed double lines indicate the travel paths for the combined pump photons and qubit photons. Next, polarizing beam splitter 305 transmits and reflects the orthogonal polarization components of the wavefunction of the qubit photon and pump photons. Polarizing Beamsplitter (PBS) 305 always transmits one of the orthogonal components and reflects the other. The nonlinear media boxes 307NL and 310NC are the locations where the quantum frequency conversion takes place employing either sum-frequency-generation or difference-frequency-generation. Specifically, at 307 NL, the nonlinear media is oriented parallel to the nonlinear media 310 NC. An optical delay line 311 operates to ensure recombining wavefunction overlap at the polarizing beamsplitter 305. Halfwave plates (HWP) 320A and 320B operate to rotate polarization by pump polarization and single photon wavefunction polarization by 90 degrees to ensure proper phase matching for interaction and non-interaction with the nonlinear media 307NL and 310NC for both clock wise and counter clock wise propagating photons. The beam stop 313 is a device to capture excess pump photons and noise photons produced in the SFG or DFG device. Wave division multiplexer or dichroic mirror 312 transmits λ₀ and reflects all other λ. The arrowed dashed line indicates the travel path of the frequency/wavelength converted qubit Q1. This converted qubit Q1 may then be coupled into transmission optics or into optical devices for manipulation or detection. The net result of the system 300B operation is to in essence create a “quantum information waveguide” for the single photon produced at 304, the orthogonal components of which are split by beam splitter 305, frequency “converted” by nonlinear media 307NL, 310NC, recombined at beamsplitter 305, and filtered at elements 312, 313.

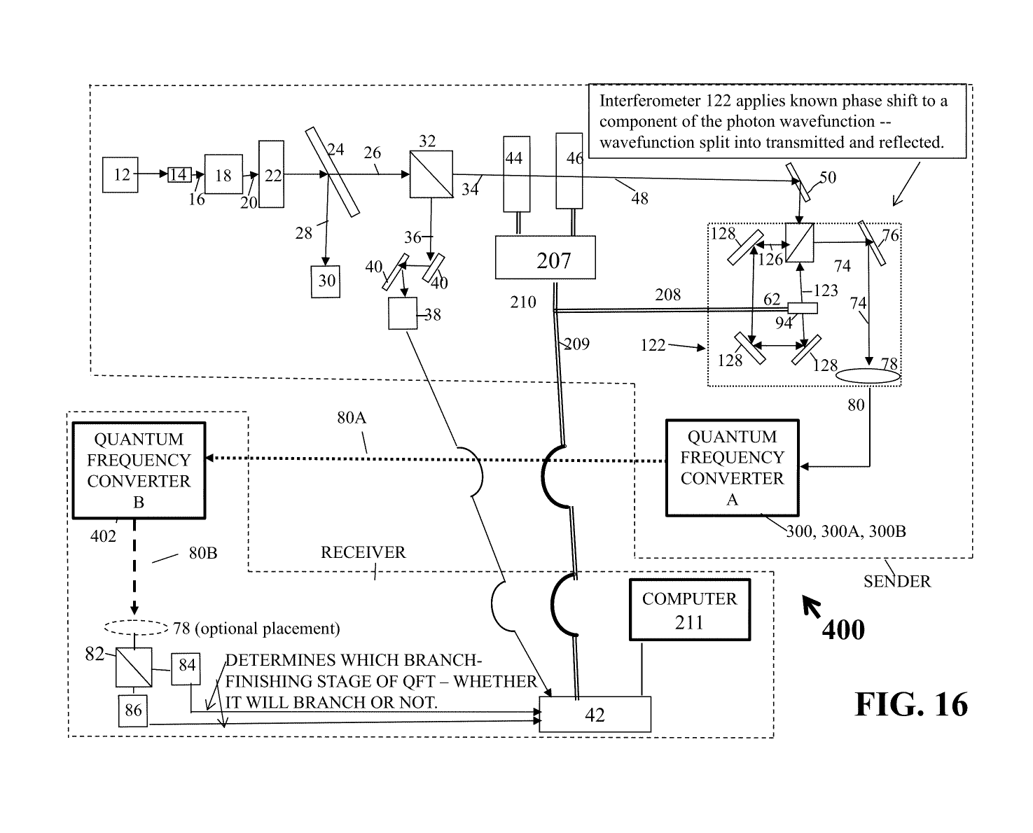

FIG. 16 is an alternate preferred embodiment of the inventive system depicted generally at 400. The system 400 has numerous features in common with that system depicted in FIG. 3 and such attributes share like numerals with those detailed with respect to FIG. 3. Specifically, as shown in FIG. 16, a data encoder 12 converts the data set to a set of qubit amplitudes that satisfies the expression of Equation 15, i.e., the amplitude of the “data” is stored as the amplitudes of a superposed quantum state and triggers a light source 14 accordingly. The light source 14 may be a laser, such as Nd:YAG, ion lasers, diode lasers, excimer lasers, dye lasers, and frequency modified lasers. Photons in path 16 emitted from the light source 14 are optionally passed through a spatial filter 18. Filter 18 converts the photons in path 16 in an image space domain to a spatial frequency domain and serves the purpose of removing, for example, stripe noise of low frequency and/or high frequency noise as described above in connection with FIG. 3. The photons in path 20 having passed through spatial filter 18 are then passed through a Type-II nonlinear optics crystal 22. An optional dichroic mirror or bandpass filter 24 that is operative to transmit specified wavelengths and reflect all others is used to selectively reflect out of the beam path 26 those photons 28 that have reflected wavelengths as a result of passing through the crystal 22 into a stop 30. Whatever photon goes through will be wavelength shifted such that the sum of energies is equal to the “parent” photon. After passage through half-mirror 24, the remaining entangled photons in path 26 are split by interaction with a polarization beam splitter 32 into two paths; a known photon state path 34 and a comparator wave function state path 36. The comparator wave function state path 36 is directed onto a single photon counting module 38 by an optional mirror set 40. It is appreciated that a reorganization of beam paths in the system 10 obviates the need for mirror set 40. The detection of the photons from the comparator wave function state path 36 by the single photon counting module 38 is fed to coincidence electronics 42 and is used to reconstruct the data set at the receiver end. The entangled photons in the known photon state path 34 are then passed through a polarization modulator 44 and a phase modulator 46. Exemplary polarization phase modulators illustratively include liquid crystals, Kerr cells, and Pockel cells. Preferably, a series of two liquid crystal devices and a quarter wave plate may be used to achieve arbitrary polarization. Upon the entangled photons known photon state path 34 interacting with the polarization and phase modulators 44 and 46, respectively, the entangled photons Q1, Q2 are transformed into an arbitrarily oriented elliptical polarization state for passage via path 48 based on the data set signal being transformed and any previously measured photon state, if any is known. The entangled photons Q1, Q2 in the arbitrarily oriented elliptical polarization state passing via path 48 are optionally reflected from a mirror 50 and then enter a polarization interferometer depicted generally at 122.

The system 400 of FIG. 16 includes an interferometer shown generally at 122 that has the geometry of a polarization Sagnac interferometer. The arbitrarily oriented elliptical polarization state in path 48 is split at polarization beam splitter 62 to phase shift a polarization component 123 through interaction with a phase modulator 94. A second component 126 is recombined with the phase shifted component 123 through coincidental reflection with three mirrors labeled 128. The recombined state 74 is reflected by mirror 76 onto a half wave plate 78 to implement a quantum Hadamard gate transformation.

The qubit Q1 travels along path 80 to Quantum Frequency Converter A (see 300, 300A, 300B of FIGS. 13-15), which is implemented to convert the frequency of the qubit Q1 to a frequency suitable for propagation to the receiver along path 80A. That is, the frequency is changed as shown in FIGS. 13-15. The frequency is converted by frequency converter A using of devices 300, 300A, or 300B which are described in FIGS. 13-15. When the qubit Q1 interacts with, for example 300B of FIG. 15, the photon Q1 with frequency λ_{I} will combine with a laser with an appropriate frequency for the desired wavelength conversion, λ_{P}, inside of wave-division multiplexer 303 (shown in FIG. 15). The laser pump 301 provides a high intensity source of photons at frequency λ_{P}. This high intensity laser illumination then interact with the optical element 302 which sets the polarization of the high intensity photons to 45 degrees. The combined Q1 and high intensity photons then interact with polarizing beam splitter 305. Beam splitter 305 is operative to split the polarization wavefunction components of Q1 into clock-wise (CW) and counter clock-wise (CCW) propagating paths, each path with a unique polarization; the high intensity pump beam is also split into the clock-wise and counter clock-wise paths, each path having equal intensity of pump beam light. For the Q1 components and pump beam traveling the clock-wise propagation path first interact with a half wave plate 320A which operates to rotate the polarization of the photons to the correct phase matching condition for non-linear media 307NL. The non-linear media 307NL operates to convert the frequency of the wavefunction components of Q1 traveling the clock-wise propagation path. After exiting 307NL the clock-wise propagating wavefunction components of Q1 and pump beam interact with half waveplate 320B which operates to rotate the polarization of the clock-wise propagating wavefunction components of Q1 and the clock-wise propagating pump beam to a phase matching condition for non-interaction with nonlinear media 310NC. Note that frequency conversion requires that the correct phase matching conditions be met for the nonlinear media. The clock-wise path propagating components may optionally interact with delay line 311 to ensure wavefunction overlap on polarizing beam splitter 305 to recombine the clock-wise and counter clock-wise propagating components. The Q1 components and pump beam traveling the counter clockwise path first interact with the optional delay line 311 to ensure wavefunction overlap on polarizing beam splitter 305 to recombine the clock-wise path and counter clock-wise path propagating components. For the Q1 components and pump beam traveling the counter clock-wise path, then interact with nonlinear media 310NC. The nonlinear media 310NC operates to convert the frequency of the wavefunction components of Q1 traveling the counter clock-wise propagation path. The frequency converted components of Q1 and pump beam then interact with half wave plate 320B which operates to rotate the polarization of light on the counter clock-wise path to a non-interacting phase matching condition with nonlinear media 307NL. After passing through 307NL the counter clockwise path wavefunction components and pump beam then interact with half wave plate 320A to rotate the counter clockwise path propagating polarizations to enable wavefunction recombination on beam splitter 305. The recombined frequency converted Q1 and pump beam then interact with wave division multiplier 312 which operates to transmit the frequency of the converted Q1 (λ_{O}) and reflect all other frequencies to beam stop 313. After propagating to the receiver the qubit Q1 interacts with 402, Quantum Frequency Converter B which operates to convert the frequency of the qubit Q1 from the propagation frequency, such as 1550 nm in optical fiber, to a frequency more suitable for operation such as measurement by detectors 84 and 86, e.g. 700 nm for some silicon avalanche photodiode detectors. It is to be appreciated that the interactions of the frequency converted Q1 from path 80 with the components of 402 are substantially equivalent to those recited above with optionally a different pump laser frequency and phase matching criteria for the non-linear media 307NL and 310NC.

Following the frequency conversions of elements 401 and 402, returning now to FIG. 16, in the left side of FIG. 16 single photon counting modules 84 and 86 count individual photons with a given polarization and report a counting event to coincidence electronics 42. Only when coincidence is noted between a photon counting event at module 38 and 84, or between module 38 and module 86 is the count considered a valid probability density function measurement. The result of the coincidence measurements by 38 and 84 or 38 and 86 are transmitted over classical channels to processor 207 for the preparation and transmission of the next qubit.

FIG. 17 is a prior art quantum quad tree depicted as a branching between 0, 1, 2 and 3 outcomes via branches 421, 422, 423, 424 for successive steps in FIG. 17. Using the Bell state measurement representation shown in FIG. 17, the first step is to determine whether a zero, one, two or three exists at the first branch (421, 422, 423, 424) located at the top of the triangle depicted in FIG. 17 (Bell State 1). If a zero value is measured then 421 is followed, if a one is measured, then 422, if a two is measured then 423, and if a three is measured then 424 is followed.

The outcomes of the successive steps sum to the values 0 through 4ⁿ−1, where n is the number of Bell state qubits. The means of obtaining the 0, 1, 2, or 3 depends on the specific experimental and corresponding simulation implementation. There are several conventional rules that are possible for determining the 0, 1, 2 or 3 value. For example, a 0 state may correspond to a Bell state measurement of Ψ⁺, the 1 may correspond to a measurement of Ψ⁻, the 2 to a measurement of Ψ⁺, and the 3 to a measurement of Ψ⁻, or other alternative assignments may be true. In general, the series of Bell state measurements are prepared such that each value of the state preparation is conditioned to determine the 0, 1, 2, or 3 at each branch.

In the simulation depicted in FIG. 17 (Quantum Quad Tree), n Bell state measurements are made. The n value is determinative of the first branch. The 4ⁿ lower branches (425-428), where n is the number of Bell states, are divided into four parts (425-428). The side with the greatest sum of the indices measured determines the path of the first branch. The second level branch has one fourth the number of indices of the first branch. Consecutive indices assigned are from the selected half from the first branch. The same process is used for the second branch level as from the first branch, but with half of the indices. This process repeats until all the branching is determined and the selected single index is determined. The quantum quad tree depicted in prior art FIG. 17 for two Bell state measurements provides an index space of sixteen. The quantum quad tree is expandable to n Bell states which is equivalent to an index space of 4ⁿ.

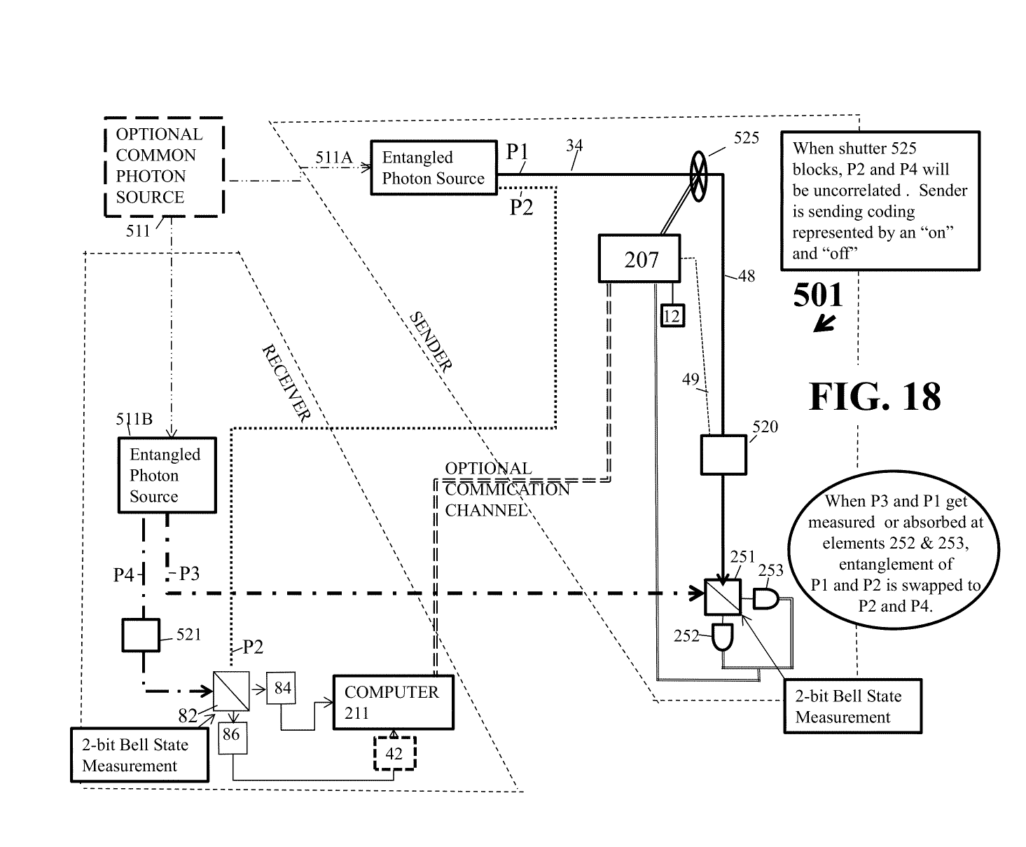

FIG. 18 is a schematic block diagram illustration of an alternate preferred embodiment 501 for transference of data from a sender to a receiver using either a common entangled photon source 511 or, in the alternative, two entangled photon sources 511A and 511B. Computers and processors 211 and 207 operate to control sending, receiving, recording and display of the information. The entanglement sources 511 (or 511A and 511B) may be co-located with either the sender or receiver or may be distant from both. When utilizing two sources 511A and 511B, each source provides an entangled photon pair represented by P1, P2 and P3, P4 in FIG. 18. The entangled pairs (P1, P2) and (P3, P4) must be synchronized or time-stamped so that the interaction between P1 and P3 is correlated with the interaction between P2 and P4. Specifically, the entangled photons P1 and P2 from the entangled photon source 511A, are synchronized or time-stamped with the entangle photons P3 and P4 from the entangled photon source 511B. Likewise, in the case of a common photon source 511, the entangled photons P1 and P2 and the entangled photons P3 and P4 are synchronized or time-stamped. Thus, with both the common source (511) and separate elements (511A, 511B) elements, the synchronicity or time stamping exists between the entangled photons in each pair as well as between the pairs of photons.

Photons P1 pass through paths 34 and 48 to beam splitter 251. Photons P3 enter beam splitter 251 as shown in FIG. 18. Photonic element 251, which may be a beam splitter, splits the inputted photons into two paths which terminate by elements 252, 253, which may be either absorbers or detectors. When absorbers are utilized for elements 252, 253, no connection circuitry to processor/computer 207 will exist, inasmuch as only in the case of detectors will electrical signals be generated and sent to the computer 207. When entangled photons P1 and P3 are measured and/or absorbed by detectors or absorbers 252, 253 the Bell state is transferred to the remaining photon pair, entangled photons P2 and P4, and entangling them by the process of entanglement swapping. When P2 and P4 are entangled and measured by 82, 84, 86 a correlated value will be measured. The entanglement will be one of 4 Bell states and the Bell state measured on right (sender's subassembly) will be same as Bell state measured on left (receiver's subassembly). The measured Bell states at both the sender and receiver may further be used to negotiate a shared quantum key.

Delay element 520 operates to ensure coincidence in the interaction on beam splitter 251 between photons P1 and P3 and delay element 521 operates to ensure coinciding interaction on beam splitter 81 between photons P2 and P4. The delay element is controlled by computer 207 through line 49 The receiver performs a Bell state measurement at 82 and the results of that measurement are recorded by processor/computer 211. Computer 211 may have a coincidence detector 42 associated therewith. Optionally, a communications channel may interconnect computers 207 and 211 as represented by the parallel dashed lines.

Optionally, computer/processor 207 controls an optional shutter device 525 that is operational to prevent photons P1 from interacting with element 251 and prevent a swap of entanglement from photons P1-P3 to photons P2-P4. Alternatively device 525 may be controlled by an operator to prevent photons P1 from interacting with element 251 and prevent a swap of entanglement from photons P1-P3 to photons P2-P4. In a second alternative computer/processor 207 may control entangled photon source 511 or 511A to emit or not emit entangled photon pairs to enable or disable swapping of entanglement from photons P1-P3 to photons P2-P4. The sender operates to perform a Bell measurement between photons P1 and P3 or to block photon P 1. When a Bell measurement is performed with photons P2 and P4 their quantum states will either possess a non-zero valued correlation or a zero valued correlation. A zero correlation value may be referred to as uncorrelated. The transfer of information may utilize encoding methods such as Morse code or ASCII. When the shutter 525 is “open,” P2 and P4 will strike Bell measurement device (polarization beam splitter) 82 and a correlated measurement will be recorded. From the aspect of detectors 84 and 86 when the photons P2 and P4 are correlated, both photons will be detected by either of detectors 84 or 86. If the shutter 525 is “closed” so as to block P1, then P2 will still enter Bell state measurement element 82 but no correlation will occur; i.e., the photons P2 and P4 will not have a preponderance of measurements in which the one of the detectors 84 or 86 measures both photons P2 and P4. The transfer of information for preferred embodiment 501 may include encodings such as Morse code or ASCII. The information being transferred may be, for example, binary representations of Bell state measurements, images, sound, or other types of quantum, digital and/or analog data to be communicated.

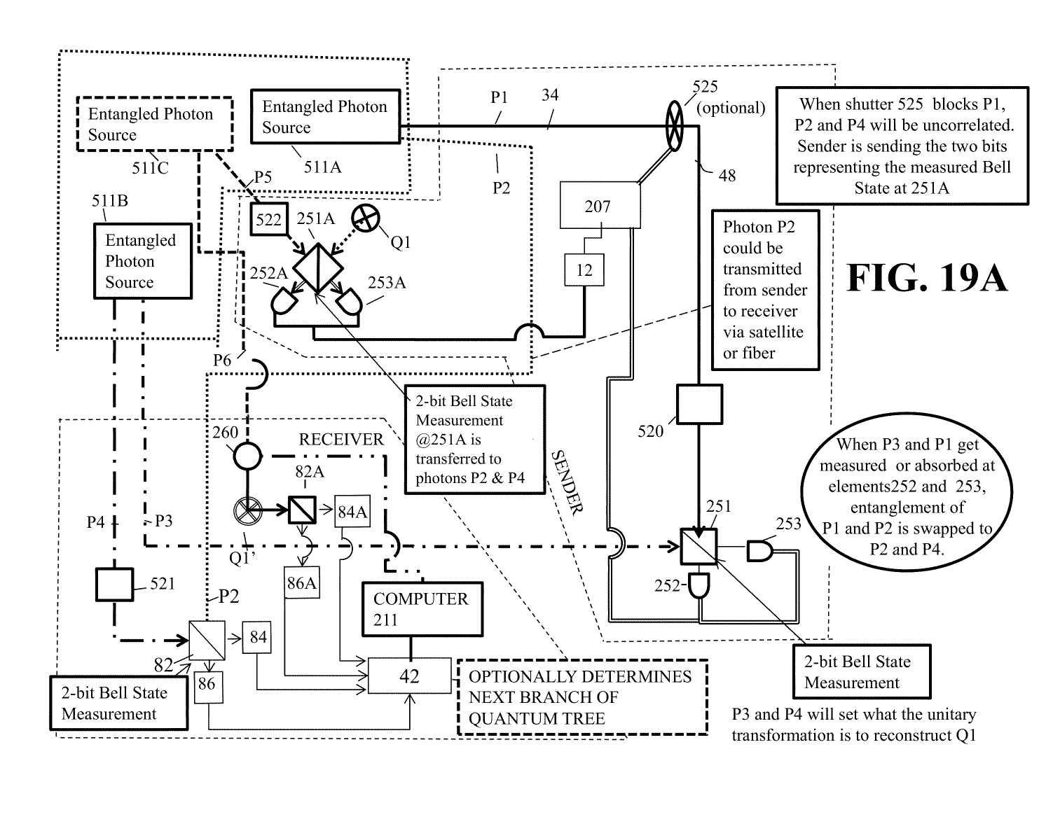

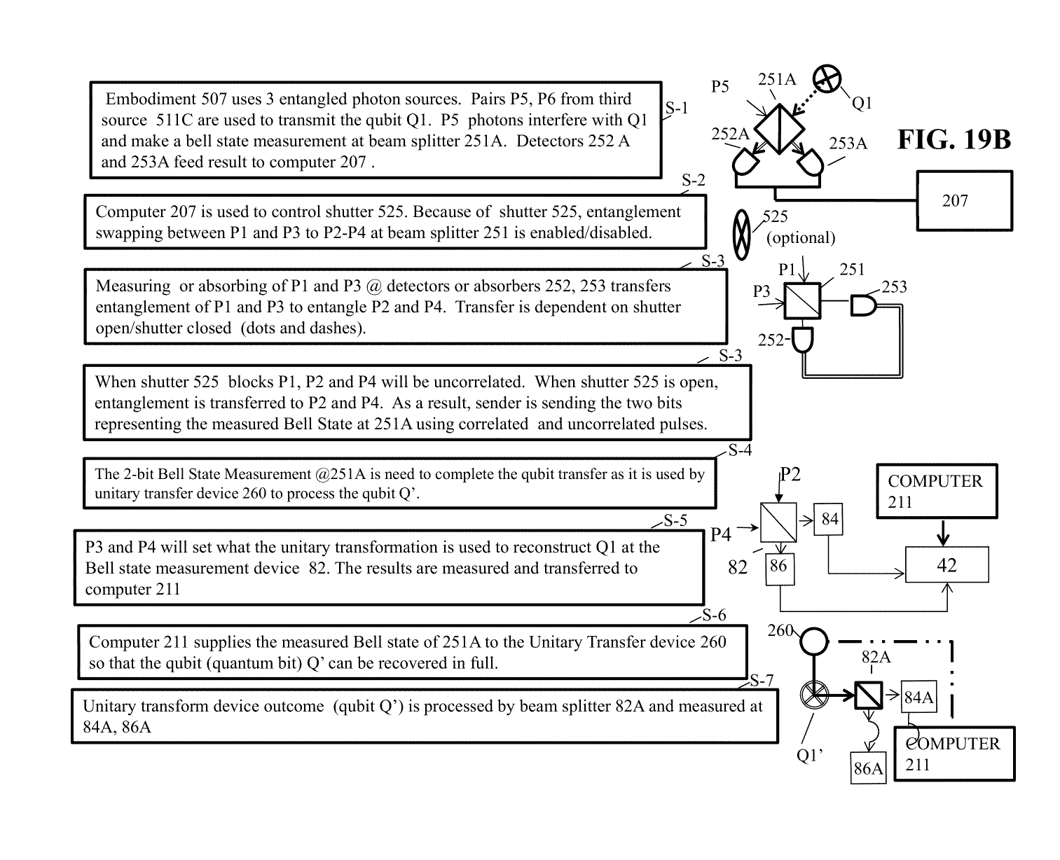

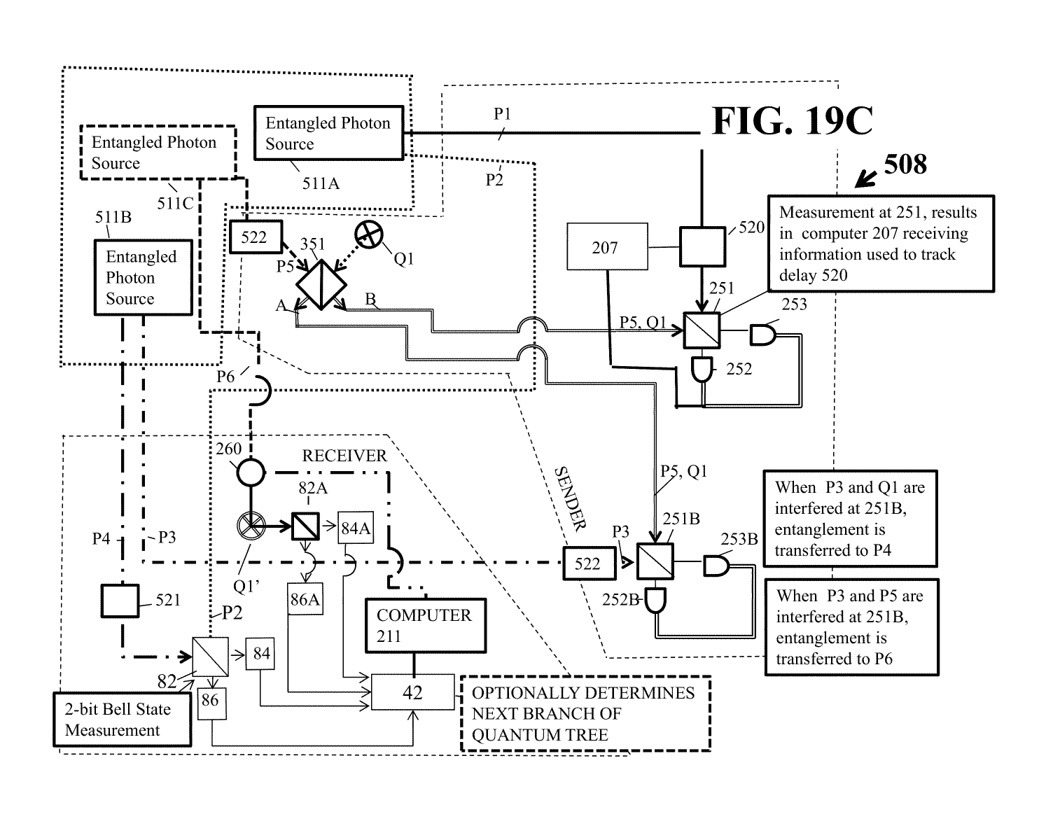

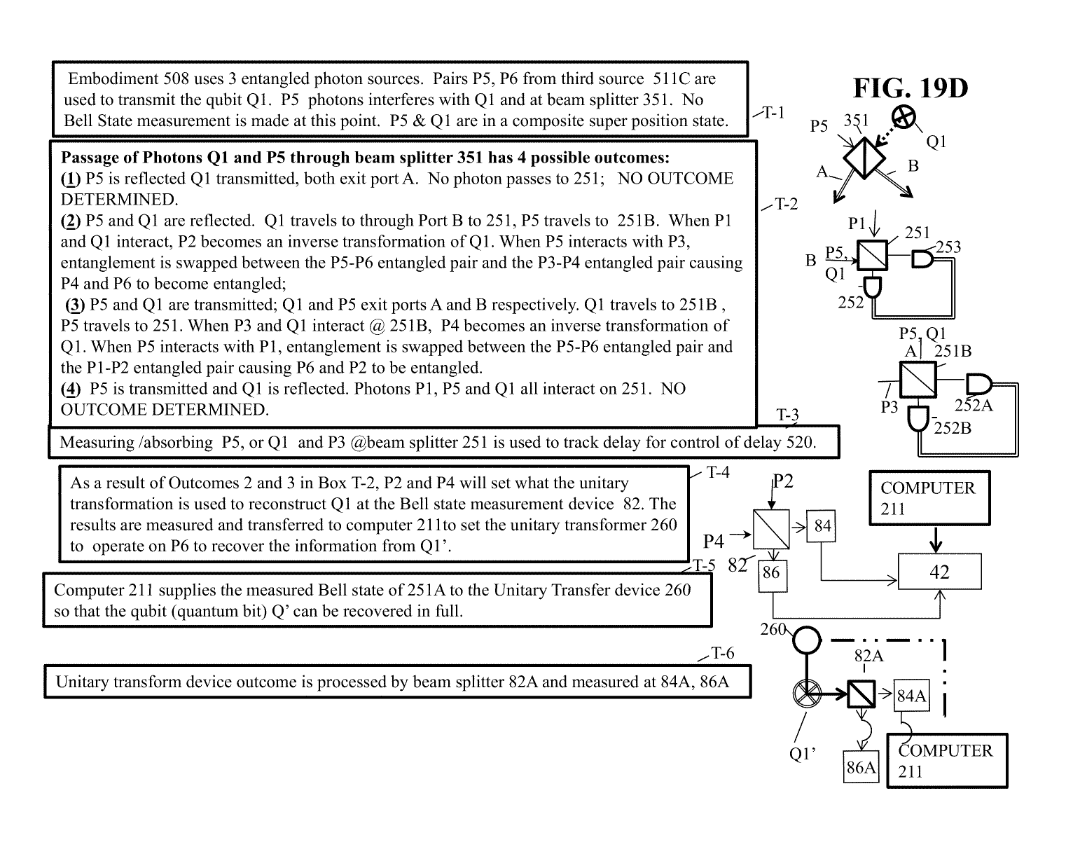

FIG. 19A schematically illustrates an alternate preferred embodiment which is a variation of the embodiment shown in FIG. 18. Computers and processors 211 and 207 operate to control sending, receiving, recording and display of the information. The components 511A, 525, 207, 12, 251, 252, and 253 operate as described with respect to FIG. 18 and the description thereof is incorporated by reference. The embodiment of FIG. 19 further includes a quantum teleportation channel to transfer information from the sender to a receiver as described in FIGS. 10A and 18. The crossed circle labeled Q1 indicates the qubit Q1 of data to be converted. As in FIG. 10A, the square with a diagonal line, (element 251A) represents the presence of a device that performs a Bell state measurement.

An example of a Bell state measurement device or element is shown to the right in FIG. 10A, wherein the Bell state measurement element 251 comprises a beam splitter and includes four number resolving detectors. A photon number resolving detector is able to tell whether it measured one photon or two within its measurement. Birefringent elements on each outlet side of the beam splitter delay polarization components with respect to the other of the same photon wavefunction. As shown to the right in FIG. 10A, after the birefringent elements, two polarizing beam splitters are aligned to 45 degrees that measure the four Bell states. Note that there are two birefringent elements are at each arm and two detectors at each arm going through 45 degree coincidence (for example, as to the Bell state, double clicking for n). Note that the qubit and P5 are interfering in Bell state device 251A and that the Bell state measurement is a joint measurement corresponding to the interaction of the photons interaction. Each photon has a polarization and phase; their wavefunctions are going to exit the beam splitter in certain superpositions. The result is the measurement of the components of the wavefunctions that interacted at 251. Q1 will interact with P2 and because of the interaction and entanglement between P2 and P1, some information on Q1 is transferred to P1.

The embodiment shown in FIG. 19A uses a third source of entangled photons 511C, which generally replaces the optional communications channel between the sender (computer 207) and receiver (computer 211). Due to the entanglement between P5 and P6, photons P5 and P6 essentially provide a quantum channel information link between the sender and receiver subassemblies to get the information to the receiver and to obviate the need for a communications channel shown in FIG. 18. All photons emitted from sources 511A, 511B and 511C are synchronized or time stamped. Photons coming out of entangled photon sources 511A, 511B and 511C are at the same or corresponding wavelengths. The photons from 511A, 511B, 511C are operated at the same clock. So long as the wavelength does not provide distinguishable information on the entangled property, photons of differing wavelengths may be utilized. Although the photons work in the same clock, delay lines are used to compensate for the path lengths needed to travel to the various components. With respect to the travel of photon P6 to the receiver, a global clock may be utilized in conjunction with a GPS system so that the travel distance and arrival time can be computed.

In the embodiment of FIG. 19A the results of the Bell state measurement element 251A, 252A, 253A of the information photon Q1 with one of an entangled pair of photons P5 are transferred to the photons P2 and P4 due to the properties of entanglement. As an option, the embodiment may use shutter 525 to transfer the value of the Bell state measurement value from detectors 252A, 252B via computer 207 using an encoding such as Morse code or ASCII. In the case of Morse code, a series of dashes and dots are transmitted correlated to a code of letters. In the case of ASCII, a sequence of 8 bits corresponds to a letter or number. The dots or dashes would correspond to a binary zero or one. The receiver uses the two-bits that are representative of the Bell state measured from the interaction of Q1 and P5 at detectors 252A and 253A to set the unitary transformation device 260, via the entanglement between photons P5 and P6, for photon P6 to reconstruct the state of photon Q1 to be measured by detectors 84A and 86A. Note that photons P1-P6 individually contain no information content were these photons to be intercepted and measured.

As an example, consider a case where three entangled photon sources are located at the sender. The sender is going to teleport a sequence of information photons (qubits) to the receiver using only quantum information channels and Bell state encoding for the two bit information transfer to the receiver. The sender will prepare the information photon Q1 in the desired state and interact that photon with an entangled photon P5 from entangled photon source 511C on beam splitter 251A, the remaining photon P6 from that entangled pair is directed towards the receiver and element 260. A Bell state measurement will be performed between photons P5 and Q1 and the results of that measurement directed to encoder 12. Specifically, Photons P1 pass through paths 34 and 48 to beam splitter 251. Photons P3 enter beam splitter 251 as shown in FIG. 19A. Photonic element 251, which may be a beam splitter, splits the inputted photons into two paths which terminate by elements 252, 253, which may be either absorbers or detectors. When absorbers are utilized for elements 252, 253, no connection circuitry to processor/computer 207 will exist, inasmuch as only in the case of detectors will electrical signals be generated and sent to the computer 207. When entangled photons P1 and P3 are measured and/or absorbed by detectors or absorbers 252, 253, the Bell state is transferred to the remaining photon pair, entangled photons P2 and P4, and entangling them by the process of entanglement swapping.

The results of the measurement of P2-P4 by the receiver on beam splitter 82 and detectors 84, 86 will be recorded by computer 211 and used to set the unitary transformation circuitry 260 to the unitary transformation prescribed by the encoded Bell state. Photon P6 then passes through element 260 with the prescribed unitary transformation to recover the information contained in photon Q1. The values of that information photon, Q1′, are measured on detectors 84A and 86A after passing through polarizing beam splitter 82A. The results of the measurements from 84A and 86A are recorded by computer 211. The sender may then repeat the steps until a sequence of encoded data has been teleported to the receiver using only quantum channels for increased stealth and security.

The entanglement sources may be co-located with either the sender or receiver or may be distant from both. Each entangled photon source provides an entangled photon pair. Entangled photon pairs from each entangled photon source must be synchronized or time stamped to ensure interactions between photons from entangled pairs generated by the different entangled sources.

Further as to the optional shutter device 525, computer/processor 207 controls an shutter device 525 that prevents photons P1 from interacting with element 251 and prevent a swap of entanglement from photons P1-P3 to photons P2-P4. Alternatively device 525 may be controlled by an operator to prevent photons P1 from interacting with element 251 and prevent a swap of entanglement from photons P1-P3 to photons P2-P4. In a second alternative computer/processor 207 may control entangled photon source 511 or 511A to emit or not emit entangled photon pairs to enable or disable swapping of entanglement from photons P1-P3 to photons P2-P4. The sender operates to perform a Bell measurement between photons P1 and P3 or to block photon P1. When a Bell measurement is performed with photons P2 and P4 they will either be correlated or uncorrelated, depending on the position of shutter 525. When a Bell measurement is performed with photons P2 and P4 their quantum states will either possess a non-zero valued correlation or a zero valued correlation. A zero correlation value may be referred to as uncorrelated. When the shutter 525 is “open,” P2 and P4 will interact with Bell measurement device 82 and a correlated measurement will be recorded. From the aspect of detectors 84 and 86 when the photons P2 and P4 are correlated, both photons will be detected by either of detectors 84 or 86. If the shutter 525 is “closed” so as to block P1, then P3 will still enter Bell state measurement device or element 82 but no correlation will occur, i.e., the photons P2 and P4 will not have a preponderance of measurements in which the one of the detectors 84 or 86 measures both photons P2 and P4. The transfer of information for preferred embodiment 501 may include encodings such as Morse code or ASCII.

FIG. 19B is a general description of key stages of the operation of FIG. 19A. As explained at S-1, embodiment 507 uses 3 entangled photon sources. Pairs P5, P6 from third source 511C are used to transmit the qubit Q1. P5 photons interfere with Q1 and make a bell state measurement at Bell state measurement device or element 251A. Detectors 252 A and 253A feed result to computer 207. At S-2, Computer 207 is used to control shutter 525. Because of shutter 525, doing entanglement swap between P1 and P3 at photonic element 251, which may be a beam splitter is enabled/disabled. The measuring or absorbing of P1 and P3 after beam splitter 251 by detectors or absorbers 252, 253 transfers entanglement of P1 and P3 to entanglement of P2 and P4 When shutter 525 blocks P1, P2 and P4 will be uncorrelated. When shutter 525 is open, entanglement is transferred to P2 and P4. As a result, sender is sending the two bits representing the measured Bell State at Bell state measurement device or element 251A using correlated and uncorrelated pulses. As pointed out in Box S-4, the 2-bit Bell State Measurement at 251A is need to complete the qubit transfer as it is used by unitary transfer device 260 to process the qubit Q′ As pointed out in Box S-5, P2 and P4 will set what the unitary transformation is used to reconstruct Q1 at the Bell state measurement device 82. The results are measured and transferred to computer 211. As pointed out in Box S-6, computer 211 supplies the measured Bell state of 251A to the Unitary Transfer device 260 so that the qubit (quantum bit) Q′ can be recovered in full. Unitary transform device outcome (qubit Q′) is processed by beam splitter 82A and measured at 84A, 86A. Computer 211 is used to determine the message sent (see Box S-7).

FIG. 19C is a schematic illustration of an alternate preferred embodiment 508 for transfer of information from a sender to a receiver using at least three entangled photon sources in which Bell state measurements are utilized. Computers and processors 211 and 207 operate to control sending, receiving, recording and display of the information and 207 operate to control sending and receiving of the information. The components on the receiver side are identical to the components of FIG. 19A. Thus, the description of these elements with respect to FIG. 19A applies to FIG. 19C. The embodiment of FIG. 19C includes a quantum teleportation channel to transfer information from the sender to a receiver. In this embodiment the information photon Q1 and one of an entangled pair of photons, P5, are interacted on beam splitter 351. As illustrated in FIG. 19D, Box When Q1 and P5 interact on beam splitter 351 there are four possible outcomes: (1) P5 is reflected Q1 transmitted, both exit port A. No photon passes to Bell state measurement device or element 251. No outcome is determinable.

(2) P5 and Q1 are reflected. Q1 travels to through Port B to photonic element 251, which may be a beam splitter. P5 travels to 251B. When P1 and Q1 interact, P2 becomes an inverse transformation of Q1. When P5 interacts with P3, entanglement is swapped to P4.

(3) P5 interacts with Q1 at Beam splitter 351. Q1 and P5 exit ports A and B respectively. Photon Q1 travels to Bell state measurement device or element 251B without P5. Photon P5 travels to Bell state measurement device or element 251B. Photon P5 entanglement is swapped (via P3) to P4. Photon Q1 travels to Bell state measurement device or element 251 and information from Photon Q is imparted to Photon P2 via entanglement of Photons P1 & P2.

(4) Photon P5 is transmitted and Q1 is reflected. Photons P1, P5 and Q1 all interact on Bell state measurement device or element 251. No outcome is determinable.

Until the photons are measured each of these outcomes are equally likely. With respect to single photon interaction a 50/50 beam splitter has the property that it is equally likely for the single photon to be measured at either output port of the beam splitter 351. The interfered Q1-P5 photon states, e.g. polarization, are directed towards Bell state measurement device or elements 251 and 251B respectively. There are two ways to generate valid Bell state measurements at both Bell state measurement device or elements 251 and 251B. These are the cases where both the information photon Q and photon P5 are transmitted through beam splitter 351 (outcome 2) or where both photons Q1 and P5 are reflected on interacting with beam splitter 351 (outcome 3). In the case where the information photon is reflected though beam splitter 351 a Bell state measurement between the information photon Q1 and entangled photon P1 will take place at components Bell state measurement device or element 251, and absorbers or detectors 252, and 253. This effectively teleports the information photon onto photon P2.

Specifically, Photons P1 pass through delay 520 to beam splitter 251. Photons P3 enter beam splitter 251 as shown in FIG. 19C. Photonic element 251, which may be a beam splitter splits the inputted photons into two paths which terminate by elements 252, 253, which may be either absorbers or detectors. When absorbers are utilized for elements 252, 253, no connection circuitry to processor/computer 207 will exist, inasmuch as only in the case of detectors will electrical signals be generated and sent to the computer 207. When entangled photons P1 and P3 are measured and/or absorbed by detectors or absorbers 252, 253, the Bell state is transferred to the remaining photon pair, entangled photons P2 and P4, and entangling them by the process of entanglement swapping.

Photon P5 for this instance will interact with photon P3 on beam splitter 251B. Specifically, Photons P3 pass through element 522 to the beam splitter 251B. Photons P3 enter beam splitter 251 as shown in FIG. 19C. Photonic element 251B, which may be a beam splitter splits the inputted photons into two paths which terminate by elements 252B, 253B, which may be either absorbers or detectors. When absorbers are utilized for elements 252B, 253B, no connection circuitry to processor/computer 207 will exist, inasmuch as only in the case of detectors will electrical signals be generated and sent to the computer 207. Entangled photons P5, Q1 and P3 are measured and/or absorbed by detectors or absorbers 252B, 253B.

This Bell state measurement will perform and entanglement swap and entangle photons P4 and P6. When a Bell measurement is performed between photons P2 and P4 the outcome of that measurement applied through the unitary operation on photon P6 will recover the state of the information photon Q1 as Q1′. In the case where the information photon Q1 is transmitted through beam splitter 351 (outcome 3) a Bell state measurement between Q1 and entangled photon P3 will take place at Bell state measurement device or photonic element 251B (including elements 252B and 253B) effectively teleporting the state of Q1 onto entangled photon P4. Photon P5 will interact with photon P1 on Bell state measurement device or element 251, (including detectors 252, and 253) generating a Bell measurement and performing an entanglement swap to entangle photons P2 and P6. When a Bell measurement is performed between photons P2 and P4 the outcome of that measurement applied through the unitary operation on photon P6 will recover the state of the information photon Q1 as Q1′.

It must also be noted that interaction on a beam splitter between two photons does not necessarily entangle photons. In the case of entanglement swapping each photon interacting on a beamsplitter and measured and/or absorbed is generated as one photon of an entangled pair of photons. Similarly, the interaction of information photon Q1 with, for example, entangled photon P5 on beam splitter 351 does not entangle the photon Q1 with photon P6.

As in the embodiment illustrated in FIG. 19A, the entangled photons P2 and P4 are directed to interact on Bell state measurement device or element 82 (including detectors 84, and 86) for a Bell state measurement. The results of that measurement are recorded by processor/computer 211. The receiver uses the two-bits that are representative of the Bell state to set the unitary transformation device 260 to modulate photon P6 to reconstruct the state of photon Q1 (Q1′) to be measured by detectors 84A and 86A. Note that in this embodiment no classical communications channel, i.e. radio or the Internet, is used to complete the quantum teleportation providing more stealth and security as no photon or other typical means of transferring information is passing from the sender to the receiver. Furthermore, the photons P1-P6 individually contain no information content were these photons to be intercepted and measured. The value of the teleported formation photon, Q1′, is measured on detectors 84A and 86A after passing through polarizing Bell state measurement device or element 82A. The results of the measurements from detectors 84A and 86A are recorded by computer 211. The results of the measurement would be transmitted to processor/computer 207 to be used to prepare the next qubit (Q1) of information to teleported to 211. The sender may then repeat the steps until a sequence of encoded data has been teleported to the receiver using only quantum channels for increased stealth and security.

The entangled photon sources 511A, 511B, and 511C may be co-located with either the sender or receiver or may be distant from both. Each entangled photon source provides an entangled photon pair. Entangled photon pairs from each entangled photon source must be synchronized or time stamped to ensure interactions between photons from entangled pairs generated by the different entangled sources. Delay elements 520 and 521 are components that operate to ensure photon interaction on Bell state measurement devices or elements 251 and 81 respectively. Delay element 520 is controlled by computer 207, as computer 207 is used to track delay. The information detected by detectors 252 and 253 is processed by computer 207.

FIG. 19D is a general description of key stages of the operation of FIG. 19C. As explained at T-1, embodiment 508 uses 3 entangled photon sources. Pairs P5, P6 from third source 511C are used to transmit the qubit Q1. P5 photons interfere with Q1 and make a bell state measurement at beam splitter 351. Detectors 252 and 253 feed result to computer 207. In the alternative, absorbers may be substituted for detectors 252B and 253B and connections to the computer 207 may then be eliminated. The interfering of P5, Q1 and P1 at beam splitter 251 may be used to track the delay for a delay element. At Box T-3, Q1 and P5 photon (dual paths outputted from 351) result in interfering Q1 and P5 at Bell state devices 251 and 251B with photons P1 and P3 respectively. At Box T-4, Measurement of P5, Q1 and P3 at 251B provides a 3 particle measurement. Similar measurement between P1, P5 and Q1 at 251. The net result is that P2 is going to have some of information regarding P5 and Q1 associated with it. When the Bell state measurement is made with P3 and P5, Q1 at Bell state device 251B, P4 will have some of the information associated with it. The 2-bit Bell State Measurement Bell state measurement device 251A is used to complete the qubit transfer as it is used by unitary transfer device 260 to process the qubit Q′ As pointed out in Box T-5, P2 and P4 will set what the unitary transformation is used to reconstruct Q1 at the Bell state measurement device 82. The results are measured and transferred to computer 211. As pointed out in Box T-6, computer 211 supplies the measured Bell state of 251A to the Unitary Transfer device 260 so that the qubit (quantum bit) Q′ can be recovered in full. Unitary transform device outcome (qubit Q′) is processed by beam splitter 82A and measured at 84A, 86A. Computer 211 is used to determine the message sent (see Box T-7).

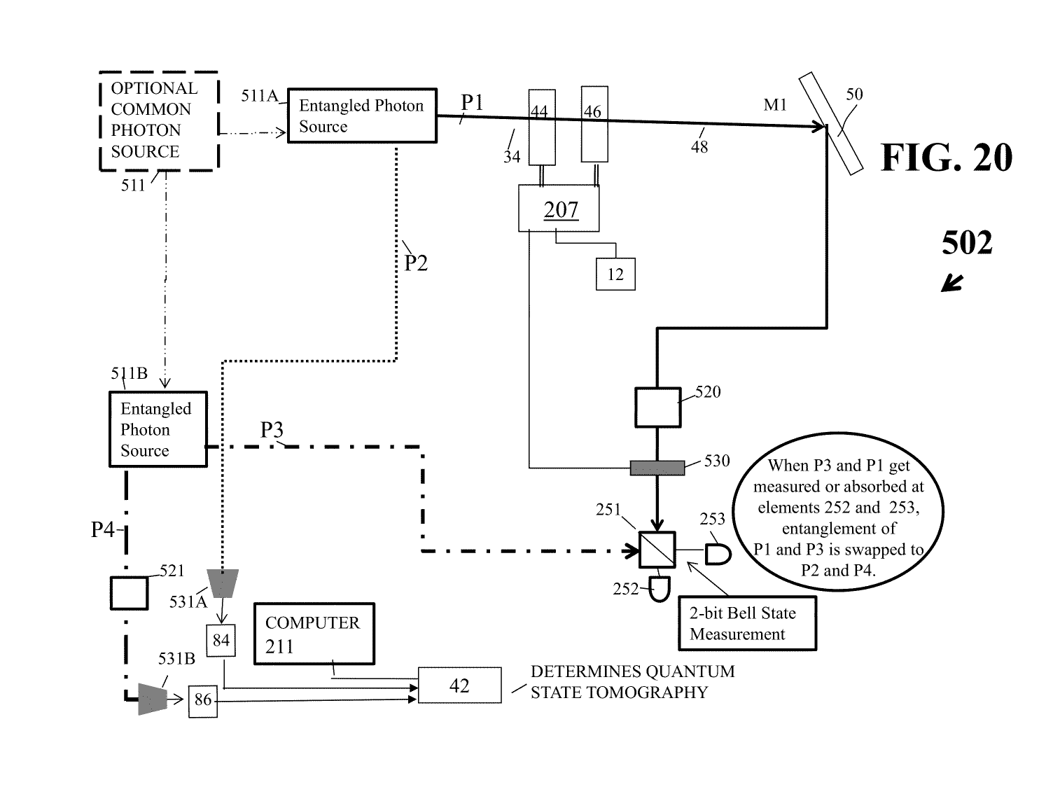

FIG. 20 is a schematic block diagram illustration of an alternate preferred embodiment 502 for transfer of information from a sender to a receiver using either a common entangled photon source 511 or, in the alternative, two entangled photon sources 511A and 511B. As a further option for preferred embodiment 502, data transfer may be accomplished via quantum quad-tree decomposition of a message or signal using coincidence electronics 42 used to reconstruct a data set, such as determining the next branch of a quantum tree. The entanglement sources 511 (or 511A and 511B) may be co-located with either the sender or receiver or may be distant from both. When utilizing two sources 511A and 511B, each source provides an entangled photon pair represented by P1, P2 and P3, P4 in FIG. 20. The entangled pairs (P1, P2) and (P3, P4) must be synchronized or time-stamped so that the interaction between P1 and P3 is correlated with the interaction between P2 and P4. Referring now to FIG. 20, the entangled photons P1 and P2 from the entangled photon source 511A, are synchronized or time-stamped with the entangle photons P3 and P4 from the entangled photon source 511B. Likewise, in the case of a common photon source 511, the entangled photons P1 and P2 and the entangled photons P3 and P4 are synchronized or time-stamped. Thus, in both the separate and common source embodiments, the synchronicity or time stamping exists between the entangled photons in each pair as well as between the pairs of photons. Entangled photon P1 is transmitted via photon state path 34 to polarization modulator 44 and phase modulator 46 operating on entangled photon P1 to encode a Bell state under the control of processor 207. Computers and processors 211 and 207 operate to control sending, receiving, recording and display of the information and 207 operate to control sending and receiving of the information. Processor 207 further controls polarizing element 530 to set the polarization of input photon P1 to a specified value. Note that polarization analyzers 531A and 531B are operative to set photons P3 and P4 to specified polarizations for measurement by detectors 84 and 86 for quantum state tomography. Delay line element 520 operates to insure coincident photon measurements on detectors or absorbers 252 and 253. Specifically, Photons P1 pass through paths 34 and 48 to beam splitter 251. Photons P3 enter beam splitter 251 as shown in FIG. 20. Photonic element 251, which may be a beam splitter, splits the inputted photons into two paths which terminate by elements 252, 253, which may be either absorbers or detectors. When entangled photons P1 and P3 are measured and/or absorbed by detectors or absorbers 252, 253, the Bell state is transferred to the remaining photon pair, entangled photons P2 and P4, and entangling them by the process of entanglement swapping.

Polarization analyzers 531A and 531B may be comprised of polarizers, half wave plates, and quarter wave plates that are operative to set photons P3 and P4 to specified polarizations for measurement by detectors 84 and 86 for quantum state tomography. Quantum state tomography provides an assessment of the multiple states of each photon (such horizontal or vertical polarization, and/or circular polarizations). Delay line element 521 operates to insure coincident photon measurements on detectors 84 and 86. Computer 211 computes a quantum state tomography that will be representative of the polarization value specified by polarizer 530.

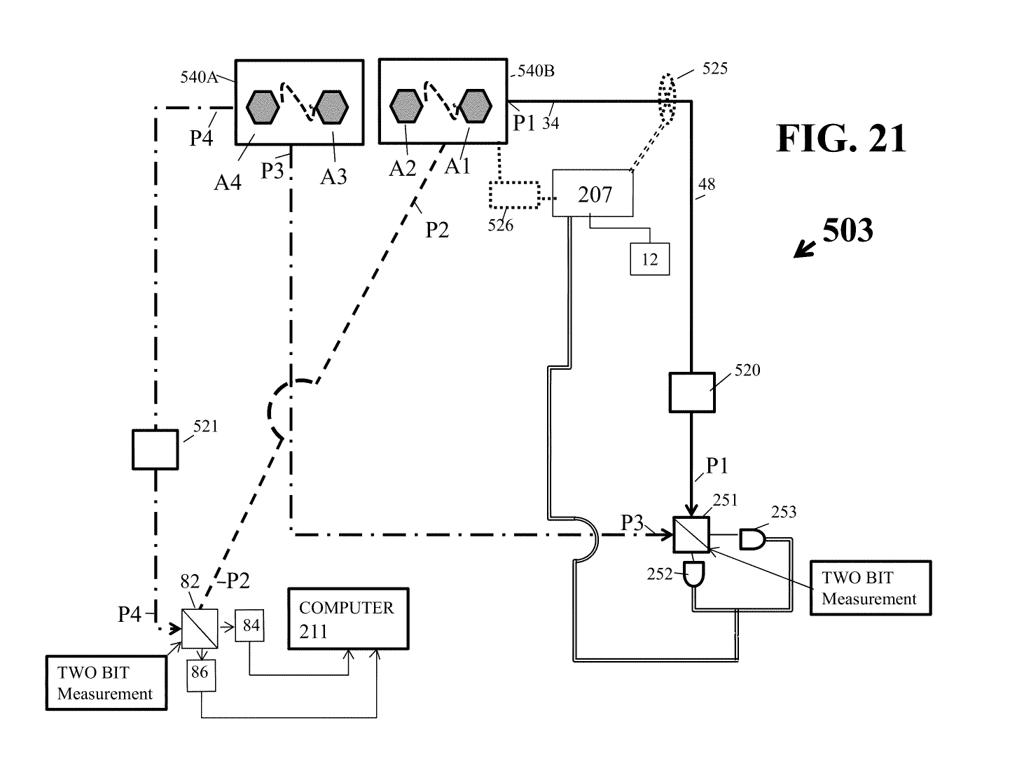

FIG. 21 is a schematic illustration of an alternate preferred embodiment 503 which comprises two entangled quantum memories 540A and 540B. Entangled memory 540A provides entangled photons P3 and P4. Entangled memory 540A provides entangled photons P1 and P2. The entangled quantum memories 540A, 540B may be co-located with either the sender or receiver or may be distant from both. The sender processor 207 controls polarization modulator 44 and phase modulator 46 operating on entangled photon P1 to encode a Bell state. An optional shutter 525 operates to prevent the passage of photon P1 at predetermined times as controlled by processor 207. Entangled photon P1 passes via paths 34, 48 to delay element 520. Elements 520 and 521 are components that operate to ensure timely photon interaction on Bell state measurement device or elements 251 and 81 respectively. Specifically, Photons P1 pass through paths 34 and 48 to (through delay element 520) to beam splitter 251. Photons P3 enter beam splitter 251 as shown in FIG. 21. Photonic element 251, which may be a beam splitter, splits the inputted photons into two paths which terminate by elements 252, 253, which may be either absorbers or detectors. When absorbers are utilized for elements 252, 253, no connection circuitry to processor/computer 207 will exist, inasmuch as only in the case of detectors will electrical signals be generated and sent to the computer 207. When entangled photons P1 and P3 are measured and/or absorbed by detectors or absorbers 252, 253, the Bell state is transferred to the remaining photon pair, entangled photons P2 and P4, and entangling them by the process of entanglement swapping.

The receiver performs a Bell state measurement at Bell state measurement device or element 82 and the results of that measurement are recorded by processor/computer 211 and the results of measurement are provided to processor 207 to prepare the next branch of the quantum quad-tree for information transfer. Computers and processors 211 and 207 operate to control sending, receiving, recording and display of the information and 207 operates to control sending and receiving of the information.

As an option, computer/processor 207 controls an optional shutter 525 that is operational to prevent photons P1 from interacting with Bell state measurement device or element 251 and prevent a swap of entanglement from photons P1-P3 to photons P2-P4. The sender operates to perform a Bell measurement between photons P1 and P3 or to block photon P 1. When a Bell measurement is performed with photons P2 and P4 their quantum states will either possess a non-zero valued correlation or a zero valued correlation, depending upon whether the shutter 525 is in an open, for a non-zero correlation, or closed position for a zero correlation. A zero correlation value may be referred to as uncorrelated. Using the variable pulsing like effect of shutter 525, the transfer of information may include encodings such as Morse code or ASCII.

As a further option for the embodiment of FIG. 21, an optional controller 526 is substituted for the shutter 525 that regulates the passage of entangled photons P1 which prevents interaction with element 251 and prevents a swap of entanglement from photons P1-P3 to photons P2-P4. Through the operation of controller 526, the sender operates to perform a Bell measurement between photons P1 and P3 or to block photon P1. When a Bell measurement is performed with photons P2 and P4 their quantum states will either possess a non-zero valued correlation when the shutter is open or a zero valued correlation when the shutter is closed. A zero correlation value may be referred to as uncorrelated. Using the variable pulsing like effect of controller 526, the transfer of information may include encodings such as Morse code or ASCII.

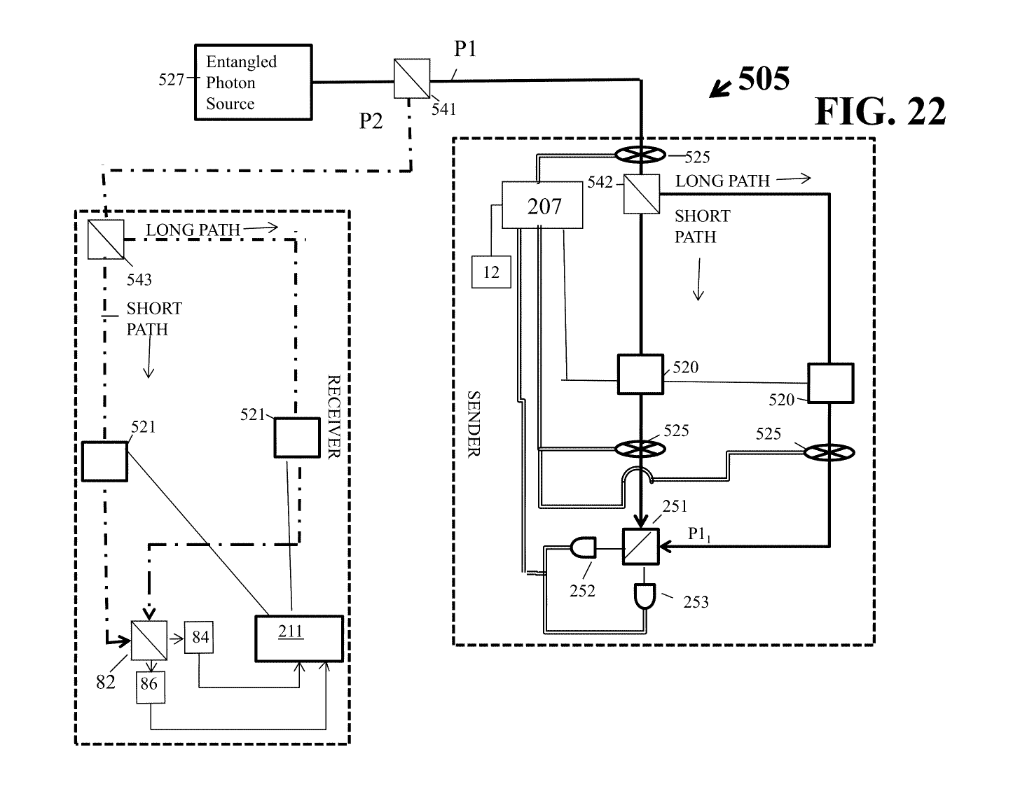

FIG. 22 is a schematic block diagram illustration of an alternate preferred embodiment 505 for transfer of information from a sender to a receiver using a single entangled photon source 527. The entanglement source 527 may be located with either the sender or receiver or may be distant from both. The entangled photon source 527 provides a sequence of entangled photon pairs P1 and P2 which are directed (such as by a beam splitter, dichroic mirror, wave-division multiplexer, etc that is suitable for the entanglement generated by the entanglement source (521) so that one photon (designated as P1) of the pairs is sent to the first (or sender) subassembly and the second photon (designated as P2) of the pairs of entangled photons is sent to the second (or receiver) subassembly. Entangled photon pairs are emitted from entangled photon source 527 at times T₁, T₁, T₂, T₃ . . . T_{N} separated by approximately a ΔT. Such an entangled photon source may be termed a pulsed source. Such a pulsed source may also include such adaptations as to compensate for errors in time separations to render the time separations sufficiently accurate. Thus, photon P1_{T1} is the photon P1 entering the sender subassembly at time T₁ and photon P1_{T2} is the photon P1 entering the sender subassembly at time T₂. At the sender subassembly, the independent photons P1_{T1}, P1_{T2}, P1_{T3} P1_{TN} enter the beam splitter 542 at times T₁, T₂, T₃ . . . T_{N} (separated by a ΔT). The sender and receiver subassembly may be referred to as an unequal path lengths interferometer due to the path length difference between the long and short paths.

At the receiver (or second) subassembly, photon P2_{T1} is the photon P2 entering the sender subassembly at time T₁ and photon P2_{T2} is the photon P1 entering the sender subassembly at time T₂. Independent photons P2_{TN} enter the beam splitter 543 at times T₁, T₂, T₃ . . . T_{N} (separated by a ΔT).

There is an equal probability that the photons will enter the short or long paths as shown in FIG. 22. Each long path is constructed such that the distance traveled by the photon entering the path requires a time ΔT for the photon to reach the beam splitter 251 on the first or sender side and 82 on the second or receiver. Given that there is an equal probability that the next photon P1 arriving at beam splitters 542, 543 will take the short path, the long and short paths are constructed such that photons P1_{T1} and P1_{T2} will interact at the Bell state measurement device or element 251 at the same time. Similarly, photons P2_{T1} and P2_{T2} will interact at the Bell state measurement device or element 82 at the same time. In effect, beam splitter 542 splits the paths of the photon into entangled photons P1_{T1} and P1_{T2}, etc. In a similar manner, beam splitter 543 splits the paths of the photon P2_{T1} and P2_{T2}, etc.

Optionally, shutters 525 may be included as shown in the sender side of FIG. 22. Delay elements 520 and 521 (which may be for example optical delay lines, quantum memories, slow light medium, etc.) are components that operate to ensure photon interaction on beam splitters 251 and 82 respectively. Note the lines from computer 207 to delay elements 520. Delay elements 520 are used to optimize the overlap on beam-splitter 521 between the long and short path photon wavefunctions. Computer 207 can determine optimal overlap from coincidence measurements by detectors 252 and 253. Similar control lines from 211 to delay elements 521 are also be included to optimize photon wavefunction overlap on beamsplitter 82 as determined by the coincidence measurements between detectors 84 and 86.

Beamsplitters 542 and 543 operate to direct photon components of photons P1 (P1_{T1}, P1_{T2}, P1_{T3} . . . P1_{TN}) and P2 ((P2_{T1}, P2_{T2}, P2_{T3} . . . . P2_{TN}) along their respective paths as shown in FIG. 22. When entangled photons P1_{T1} and P1_{T2} are measured by detectors 252, 253 the entanglement is transferred to the remaining photon pair, photons P2_{T1} and P2_{T2}, entangling them by the process of entanglement swapping. Similarly, the photons P1_{TN} and P1_{TN+1} are measured by the Bell state measurement device or element 251 (in conjunction with detectors or absorbers 252, 253) the entanglement is transferred to the remaining photon pair, photons P2_{TN} and P2_{TN+1}, entangling them by the process of entanglement swapping. The receiver performs a joint measurement at Bell state measurement device or element 82 and the results of that measurement are recorded by processor/computer 211. Computers and processors 211 and 207 operate to control sending, receiving, recording and display of the information and 207 operate to control sending and receiving of the information.

Optionally, computer/processor 207 controls at least one optional shutter 525, that operates to prevent the photons P1 on the long, short, or both paths from interacting with element 251 and prevent a swap of entanglement from photons P1_{TN} and P1_{TN+1} to P2_{TN} and P2_{TN+1}, The sender operates to perform a joint measurement between photons P1_{TN} and P1_{TN+1} or to block photon P1 paths. When a joint measurement is performed with photons P2_{TN} and P2_{TN+1}, they will either be correlated or uncorrelated. The transfer of information may include encodings such as Morse code or ASCII. The type of information that may be transferred also includes the outcomes of a Bell state measurement between one photon of an entangled photon pair and an information photon (qubit) as would be used for quantum teleportation. Thus this embodiment can be used to transfer the outcome of a Bell state measurement by a quantum channel. It is to be appreciated that the speed of information transfer from the sender subsystem to the receiver subsystem is limited by the speed of quantum information.

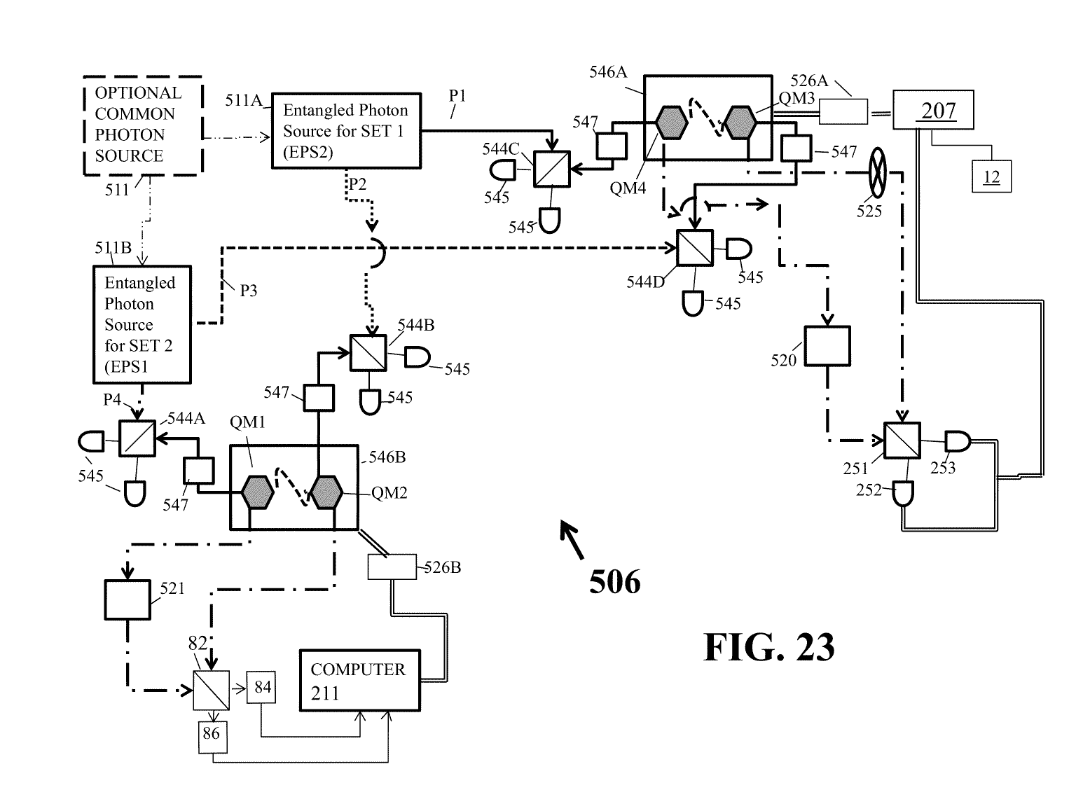

FIG. 23 is a schematic illustration of an alternate preferred embodiment 506 for transfer of information from a sender to a receiver using quantum memories. The quantum memories operate to store information, quantum information and/or the quantum state of photons interacting with the quantum memory for later use and/or operations. There are two primary stages for this embodiment. The first stage is establishing entanglement between distant quantum memories (QM1-QM3 and QM2-QM4). The second stage involves performing an entanglement swap utilizing quantum memories QM3 and QM4 to entangled or not-entangle distant quantum memories QM1 and QM2. The establishment of the initial distant entanglement between quantum memories QM-QM3 and QM2-QM4 would take the following steps. The first step is to reset the quantum memories. A reset of the quantum memories entails processor 207 and computer 211 directing controlling 526A and 526B to direct a specified sequence of pulses to quantum memories QM1, QM2, QM3 and QM4 respectively. The second step is to use entangled photon sources to establish distant entanglement of pairs of elements of the sender and receiver quantum memories. Preferred embodiment 506 may utilize either a common entangled photon source 511 or, in the alternative, two entangled photon sources 511A and 511B. The entanglement sources 511 (or 511A and 511B) may be co-located with either the sender or receiver or may be distant from both. When utilizing two sources 511A and 511B, each source provides an entangled photon pair represented by P1, P2 and P3, P4 in FIG. 23 The entangled pairs (P1, P2) and (P3, P4) must be synchronized or time-stamped so that the interaction between P1 and P3 is correlated with the interaction between P2 and P4. Likewise, in the case of a common photon source 511, the entangled photons P1 and P2 and the entangled photons P3 and P4 are synchronized or time-stamped. Thus, both in the separated and common source embodiments, the synchronicity or time stamping exists between the entangled photons in each pair as well as between the pairs of photons. The third step comprises processor 207 directing controller 526A to perform a write operation pulse sequence on memory QM4 causing a photon to be directed towards beam splitter 544C to interact with photon P1 from entangled photon source 511 or 511A. After interaction on the beam splitter the photons would be measured and/or absorbed on components 545. Similarly Computer 211 would direct controller 526B to perform a write operation pulse sequence on memory QM2 that would cause a photon to be directed towards beam splitter 544B to interact with photon P2 from entangled photon source 511A or 511. After interaction on the beam splitter the photons would be measured and/or absorbed on components 545. After the pair of measurements/absorptions P1-QM4, P2-QM2 the entanglement between P1-P2 would be transferred to QM2 and QM4 with the two distant quantum memories now entangled. Similar operations would be performed for quantum memories QM1 and QM3 using photons P3 and P4.

During the fourth step, the sender processor directs controller 526A to direct a pulse sequence on memory QM3 or QM4 to perform a read operation on one or both memories in accordance with the encoding prescribed by encoder 12. The photons from memories QM3 and QM4 are directed towards Bell state measurement device or element 251. Specifically, Photons P1 pass through shutter 525 to beam splitter 251. Photons P3 enter beam splitter 251 as shown in FIG. 23. Beam splitter 251 splits the inputted photons into two paths which terminate by elements 252, 253, which may be either absorbers or detectors. When absorbers are utilized for elements 252, 253, no connection circuitry to processor/computer 207 will exist, inasmuch as only in the case of detectors will electrical signals be generated and sent to the computer 207. The entangled photons P1 and P3 are measured and/or absorbed by detectors or absorbers 252, 253.

During the interaction with absorbers or detectors 252 and 253 one or both photons from memories QM3 and QM4 are measured and or absorbed on detectors 252 and 253. The absorption or measurement entangling quantum memories QM1 and QM2 in the case where a photon was emitted by memories QM3 and QM4 or not entangling quantum memories QM 1 and QM2 if the photon emission was suppressed.

During the fifth step, the receiver computer 211 directs controller 526B to direct a pulse sequence on quantum memories to perform a read operation on quantum memories QM1 and QM2. Photons from the read operations being directed towards detectors 84 and 86 through optionally present Bell state measurement device or element 82.

During the sixth step, the measurements of detectors 84 and 86 (considered to be part of the Bell state measurement device or element) are recorded by computer 211. In the instance where the entanglement was swapped between QM3 and QM4 the recorded measurements will be correlated, in the instance where the entanglement swapping was suppressed the recorded measurements will be uncorrelated. Steps 1 to 6 are repeated until the sequence of encoded data has been transmitted.

Preferred embodiment 506 may utilize either a common entangled photon source 511 or, in the alternative, two entangled photon sources 511A and 511B. As a further option for preferred embodiment 506, data transfer may be accomplished via quantum quad-tree decomposition of a message or signal using computer 211 to reconstruct a data set, such as determining the next branch of a quantum tree, as explained in the foregoing (see FIGS. 2A and 17, for example). The entanglement sources 511 (or 511A and 511B) may be co-located with either the sender or receiver or may be distant from both. When utilizing two sources 511A and 511B, each source provides an entangled photon pair represented by P1, P2 and P3, P4 in FIG. 23. The entangled pairs (P1, P2) and (P3, P4) must be synchronized or time-stamped so that the interaction between P1 and P3 is correlated with the interaction between P2 and P4. Likewise, in the case of a common photon source 511, the entangled photons P1 and P2 and the entangled photons P3 and P4 are synchronized or time-stamped. Thus, both in the separated and common source embodiments, the synchronicity or time stamping exists between the entangled photons in each pair as well as between the pairs of photons. Computers and processors 211 and 207 operate to control sending, receiving, recording and display of the information and 207 operate to control sending and receiving of the information.

Alternate preferred embodiment 506 (FIG. 23) further comprises two pairs of quantum memory elements 546A and 546B. Quantum memory element 546A comprises two quantum memories QM3 and QM4 and quantum memory element 546B comprises the two quantum memories QM1 and QM2. The quantum memories operate to store quantum information or the quantum state of photons interacting with the quantum memory for later use and/or operations. Entangled photon P1 is directed towards a Bell state measurement device or element 544C where P1 will interact with a photon from quantum memory QM4. Quantum memory QM4 is controlled by controller 526A to emit a photon when directed by processor 207. The photon from quantum memory QM4 is directed through optional delay element 547 to Bell state measurement device or element 544C to interact with photon P1. Delay elements 547 (which may be for example optical delay lines, quantum memories, slow light medium, etc.) are components that operate to ensure timely photon interaction on Bell state measurement device or element 544A, 544B, 544C, and 544D. After interaction on Bell state measurement device or element 544C the entangled photon P1 and the photon from quantum memory QM4 are measured by measurement devices/photon detectors 545 (considered to be part of the Bell state measurement device or element).

Either the optional common entangled photon source 511 or the entangled photon source 511A will emit an entangled photon P2 towards Bell state measurement device or element 544B where entangled photon P2 will interfere with a photon from quantum memory QM2. Quantum memory QM2 is controlled by controller 526B to emit a photon when directed by computer/processor 211. The photon from quantum memory QM2 may be directed through optional delay element 547 to Bell state measurement device or element 544B to interact with entangled photon P2. After interaction on Bell state measurement device or element 544B the entangled photon P2 and the photon from quantum memory QM2 are measured by photon detectors/measurement devices 545 (considered to be part of the Bell state measurement device or element). Subsequent to the measurements of the entangled photon P1 with the photon from QM4 and entangled photon P2 with the photon from QM2 the entanglement of P1-P2 will be transferred to quantum memories QM2 and QM4 due to the properties of entanglement.

Either the optional common entangled photon source 511 or the entangled photon source 511B will emit an entangled photon P3 towards a Bell state measurement device or element 544D where P3 will interact with a photon from quantum memory QM3 (after passage through an optional delay element 547). Quantum memory QM3 being directed by controller 526A to emit a photon when instructed by processor 207. After interaction between the photon P3 and the photon from quantum memory QM3 on Bell state measurement device or element 544D the entangled photon P3 and the photon from QM3 are measured by measurement devices/photon detectors 545 (considered to be part of the Bell state measurement device or element).

Referring again to FIG. 23, either the optional common entangled photon source 511 or the entangled photon source 511B will emit an entangled photon P4 toward Bell state measurement device or element 544A where P4 will interact with a photon from quantum memory QM1. Quantum memory QM1 is controlled by controller 526B to emit a photon when directed by computer 211. The photon from QM1 is directed through optional delay element 547 to Bell state measurement device or element 544A to interact with photon P4. After interaction on Bell state measurement device or element 544A the entangled photon P4 and the photon from QM2 are measured by measurement devices/photon detectors 545 (considered to be part of the Bell state measurement device or element.).

Subsequent to the interaction of the entangled photon P3 with the photon from QM3 and entangled photon P4 with the photon from QM1 the entanglement of P3-P4 will be transferred to quantum memories QM1 and QM3 due to the properties of quantum entanglement.

Quantum memory element 546A provides photons from quantum memory QM3 and quantum memory QM4. Positioned between the sender processor 207 and the quantum memory element 546B is a controller 526A that controls the outputting of photons from the quantum memory element 546A in a similar manner to the shutter 525 that optionally accompanies preferred embodiment 503; i.e., controller 526A operates to prevent the passage of photons from quantum memory element 546A at predetermined times as controlled by processor 207. A photon from quantum memory QM3 passes through delay element 520 towards beam splitter 251. Delay elements 520 and 521 (which may be for example optical delay lines, quantum memories, slow light medium, etc.) are components that operate to ensure timely photon interaction on beam splitters 251 and 81 respectively. A joint measurement at beam splitter 251 is performed with a photon from quantum memory QM4. When the photons from QM3 and QM4 are measured or absorbed by detectors 252,253 the quantum state is transferred to the quantum memories QM1, QM2 and entangling them by the process of entanglement swapping. The receiver may perform a measurement at Bell state measurement device or element 82 and the results of that measurement are recorded by processor/computer 211. The sender may then repeat the steps until a sequence of encoded data has been transmitted.

Controller 526A also regulates the passage of photon from QM3 and/or QM4 which prevents interaction with element 251 and prevents a swap of entanglement from quantum memories QM3-QM4 to quantum memories QM1-QM2. Through the operation of controller 526A, the sender operates to perform a joint measurement between photons from QM3 and QM4 or to block photon interaction on 251. When a measurement is performed with quantum memories QM1 and QM2 they will either be correlated or uncorrelated, depending upon whether the shutter 525 or 526A is in an open or closed position. Using the variable pulsing like effect of controller 526A, the transfer of information may include encodings such as Morse code or ASCII.

### Cloud Computing

An alternate embodiment comprises a system for quantum cloud computing in support of tactical intelligence operations and other operations. Utilizing more than one computer processor and computing resources to solve a problem nearly simultaneously is referred to as parallel processing. Even though the processors are relatively far apart, they can be connected by communications systems, networks and links to enable problem solving; also know as distributed computing. The collection of the distributed computing resources is often called “cloud computing.” Resources may include, but are not limited to quantum and classical computer nodes, quantum and classical memory, quantum and classical computer codes, quantum and classical storage, quantum and classical communications, and the like.

D-Wave and PiCloud have announced a joint venture to develop cloud computing software for remote access to one or more D-Wave quantum computers at a center or centers. The D-Wave/PiCloud quantum computing cloud is for a central computing resource available remotely. The communications between the quantum computers and the remote devices in this instance are classical.

One problem is that it is not designed or built to be used in support of tactical operations, intelligence or otherwise. Tactical communications resources are different from commercial enterprises which depend heavily on stationary infrastructure support. A tactical environment has a connectivity which needs to be ad-hoc and continually changing to account for mobility. Bandwidth is often restricted because of the smaller throughput of fielded system vs. commercial infrastructure supported systems.

A new method for quantum cloud computing improves security and compression between the nodes by applying the methods and techniques of quantum security and compression of data in transmission described in U.S. patent application Ser. No. 12/705,566 entitled “Quantum Based Information Transmission System and Method,” filed Feb. 12, 2010, by Ronald E. Meyers and Keith S. Deacon (and issued Aug. 6, 2013 as U.S. Pat. No. 8,503,885 ('885 patent) (ARL-04-62CIP1) (herein incorporated by reference) to provide the communications links between quantum computing or classical computing nodes operating in a tactical environment. As described in the '885 patent, the information sent to each location at each step in the process depends of the information previously measured by one or more receivers in the preceding step or steps.

### Entanglement Swapping

As described herein, entanglement swapping may be applied to information transfer, sharing, or communication without the need for a classical communications channel. Optionally, this can be accomplished without the sender or receiver having access to information or resources held by the other.

Entanglement swapping is a quantum process by which particles that are not entangled become entangled with each other. For example, consider that particles 1 (P1) and 2 (P2) are entangled with each other and that particles 3 (P3) and 4 (P4) are entangled with each other. To entangle P1 and P4, particles P2 and P3 are interfered on a beam splitter and then are measured. The interference and measurement swaps the entanglements P1-P2 and P3-P4 to P1-P4. Particles P2 and P3 are also affected by the measurement device and may be absorbed. The process of entanglement swapping has previously been verified. See, e.g., J.-W. Pan, D. Bouwmeester, H. Weinfurter, and A. Zeilinger, “Experimental Entanglement Swapping: Entangling Photons That Never Interacted,” Physical Review Letters 80, 3891-3894 May (1998), which described a process of entanglement swapping with experimental verification using entangled photons. Swapping may be considered as the teleportation of an unknown photon/particle state onto another photon/particle.

Thus far, relatively few applications have found uses for entanglement swapping. Potential applications for entanglement swapping in quantum technology include quantum computing, quantum communications and quantum imaging. There are potentially many benefits to using entanglement swapping for quantum imaging that have not yet been described or exploited. The reason for this is that entanglement swapping has required high precision in its implementation and great expense for equipment that achieves the high precision. The lack of robust applications for entanglement swapping has been another drawback to its implementation in technology. This technology is being miniaturized in solid state devices and some components are being tested on chips. These quantum chips, can generated entangled particles and perform interference operations and measurements of quantum states.

It would be beneficial to have an entanglement swapping application that is robust and can be implemented with both available and evolving technologies. One way to make entanglement swapping useful would be to apply it information transfer, sharing, or communication without the need for a classical communications channel. For example, the current Internet, radio, and telephone are generally considered to be a classical communications channels. Another way to make entanglement swapping useful would be to be able to transfer, share or communicate by quantum means without the sender or receiver needing access to information or resources held by the other. For example, the sender having access to photons P2, P3 and the receiver having access to photons P1, P4 is sufficient to transfer information from sender to receiver. Repetition of this process allows the transfer of images without sending classical information and by only sharing entanglement. This type of communication of information, such as data and/or images, would be difficult to detect by an external observer since there would be no particle or radiation going between the sender and the receiver that which an observer would be able to sense and follow. Military and domestic applications requiring stealth and/or security would benefit from this capability.

Benefits of entanglement swapping for quantum imaging may include performing an entanglement swap to optimize photon detection efficiency while simultaneously optimizing transmission properties from an illumination source to a target. Another benefit is that an entanglement swap may be used to measure absorption maps of a target without the need to measure reflected photons. Furthermore, entanglement swapping may be used to help compute the product of the absorption values at two locations on a target. Using the environment to enable entanglement swapping would provide a direct and remote measurement on the environment. For example, absorption of photons by a remote target can be sensed by the enabling of quantum swapping of entangled particles which can be measured remotely without need for the return of photons from the target. It should be noted that besides images of absorption fields of targets any property can be imaged by enabling quantum swapping when the quantum particle is sensitive to the effects of object. Furthermore, with time sequencing this provides range information from, for example, the source of entangled quantum particles to target features. It should be further realized that the source or sources of the entangled quantum particles need not be located with the equipment used to direct particles towards a target (sender) or located with the equipment that measured those entangled particles that never directly interacted with the target (receiver). For example, the source or sources of the entangled particles may be on a satellite that would send the entangled particle pairs to the “sender” equipment and “receiver” equipment. Alternately, both the sender and receiver may have a single entangled quantum particle source and each shares one particle of their entangled particle pairs with the other. The identification of which particles are entangled with each other relative to initial entangled pair creation times may be achieved using an auxiliary time stamp, e.g. a laser pulse encoded with time information for each entangled photon pair created, that propagates with each particle of each entangled particle pair. Although not obvious, we consider it possible to use thermal light photon number fluctuations and their correlations and quantum illumination for variations of teleportation and swapping in our current inventions with swapping. Further benefits of entanglement swapping applied to quantum imaging using measurements of reflected photons may include application to quantum imaging of remote targets and microscopy with the images being generated for the user at a distant location with entangled photons that did not interact directly with the target. The reflected photons may be further used to compute the product of reflectance or the product of reflected intensities of at least two locations on the target. Current imaging systems such as cameras are dependent on producing imaging using photons that have directly interacted with the target. The sharing of images taken by a camera normally requires communication by electromagnetic radiation that takes specific paths to communicate a facsimile of the image between sender and receiver. Even quantum teleportation may require a classical communication channel using electromagnetic radiation that takes specific paths to communicate. Entanglement swapping could be applied to quantum teleportation to replace the classical channel. The two bit Bell state measurement between the information quantum state (qubit) and one particle of the entangled particle pair could be transmitted to the receiver by manipulation of the Bell state of the entangled particles undergoing the quantum swapping to be the same Bell state that was measured for the teleportation. The receiver would then be able to measure the swapped Bell state and have the two bits to modulate the particle with the teleported information to recover the information qubit to complete the teleportation process. Alternatively, a sequence of on-off swapping representing the two bits could be used to transfer the information to the receiver to use to recover the teleported information qubit.

Representation of the on-off swapping may be accomplished by choosing to swap quantum entanglement with particles possessing a second quantum property. For photons this second quantum property may be, for example, wavelength where the first quantum property conveying the information may be, for example, polarization. Choosing to entanglement swap between two sets of entangled particles with distinct second quantum properties allows for a positive valued discrimination of not only those cases where swapping is enabled by a shutter being open (“on”) but a positive valued discrimination where swapping is in the “off” state. This would improve the transfer of information where there may be a high loss of entangled particles between the entanglement sources and the receiver. In that case 0 or off settings may be over reported due to that loss whereas when two properties are being used, one to represent the “on” or open case and the other quantum property representing the “off” or closed case loss of quantum particles from the entanglement source to the receiver would typically be the same for both quantum properties and potential over representation of the “off” case reduced. An alternate method to realize the transfer of information by quantum means from a sender to a receiver would be to send the values of 1 or 0 (zero) in a sequence that would correspond to a predetermined code. The individual values of 1 or 0 would be accomplished by a combination of “on” and “off” operations assigned to represent 1 and a separate combination of “on” and “off” operations assigned to represent 0. A particularly robust implementation of this alternate method was experimentally verified by the inventors and goes as follows. To turn “on”, for example, (a) the sender would operate on their portions of a sequence of entangled quantum particles with the shutter or other device operating to enable swapping of entanglement between the sender's quantum particles and the receiver's quantum particles, i.e. an “on” state, from time T1 to time T2. This would be followed by (b) operations on their portions of a sequence of entangled particles with the shutter or other device operating to disable swapping of entanglement between the sender's quantum particles and the receiver's quantum particles, i.e. an “off” state, from time T2 to time T3. Finally, (c) the sender would repeat the operations of step (a) from time T3 to time T4. The receiver would then make three sets of coincident measurements from time T1 to time T2, time T2 to time T3, and time T3 to time T4. Then the number of coincidences measured during T1 to T2 would be added to the number of coincidences measured to the number of coincidences measurements made during T3 to T4 and then subtract twice the number of coincidence measurements made during T2 to T3. This value would then be divided by its absolute value. The receiver computed value of 1 would indicate that the sender has transferred to the receiver a “1” value. To transfer a 0 value the sender would (d) operate on their portions of a sequence of entangled particles with the shutter or other device operating to disable swapping of entanglement between the senders particles and the receivers particles, i.e. an “off” state, from time T5 to T6 followed by (e) operations on their portions of a sequence of entangled particles with the shutter or other devices operating to enable swapping of entanglement between the senders particles and the receivers particles, i.e. an “on” state, from time T6 to T7. Finally, (f) the sender would repeat operations on their portions of a sequence of entangled particles with the shutter or other device operating to disable swapping of entanglement between the sender's particles and the receiver's particles from time T7 to time T8. The receiver would then make three sets of coincident measurements from time T5 to time T6, time T6 to time T7, and time T7 to time T8. Then the number of coincidences measured during T5 to T6 would be added to the number of coincidences measured during T7 to T8 and then twice the number of coincidence measurements made during T6 to T7 would be subtracted. This value would then be divided by its absolute value. The value computed would be −1. When the value is −1, then the number 1 is added to give the value 0. Thus sequences of values of 1 and 0 can be sent between sender and receiver. This method is robust in practice since it can work even when there is experimental noise or drift in coincidence counts. As observed our experiments, the on operations tend to give higher coincidence counts than nearby in time off operations. Analogously, off operations tend to give less coincidence counts than nearby in time on operations. This result is sufficient to verify the non-local quantum transfer of information between sender and receiver by embodiments of our inventions. It would be beneficial to use entanglement swapping to communicate images or quantum images that does not require a classical communications channel to complete the transfer of images between a sender and a distant user at the receiver in order to avoid having the classical communications channel blocked which would also block image communication. This means to transmit the two bit measurement is stealthier and faster and does not require the transmission of energy or particles between the sender and receiver that would ordinarily carry that information. Communication information transfer using entanglement swapping would be an entirely quantum process. Another embodiment would employ enabling, partially enabling, or disabling the swapping of entanglement to transfer from a sender to a receiver an “analog” type signal. The enabling, partially enabling, or disabling of an entanglement swap may be accomplished through the use of delay lines or similar components. A delay line is typically used to ensure entangled particle overlap on a beam splitter or other device to maximize the probability to achieve a swap of entanglement. For example, an optical delay line is a device that precisely controls the distances that a photon travels through the device. By varying the distance the photon travels one controls the delay time through the device. Delay lines may also be used instead to minimize quantum particle overlap on the beam splitter to disable the entanglement swap. The overlap of the entangled particles can be controlled and/or modulated from fully overlapped to non-overlapped which allows for analog type signals to be transmitted. In the case of constructive interference the coincidence rate measured by the receiver will be enhanced when there is a high degree of overlap and the coincidence rate measured by the receiver will be decreased when there is a small degree of overlap. In the case of destructive interference, the measured coincidence rate by the receiver is decreased when there is a high degree of overlap and increased when the degree of overlap decreases. The constructive or destructive interference is related to the Bell state of the entangled particles interacting on a beam splitter. This effect is similar to Hong-Ou-Mandel interference [Hong, C. K.; Ou, Z. Y. & Mandel, L. (1987), “Measurement of subpicosecond time intervals between two photons by interference”. Phys. Rev. Lett. 59 (18): 2044-2046]. In the limit of fully overlapped entangled particles this could be considered a binary “on” and when completely non-overlapped as a binary “off”. Control of entanglement to transfer information from a sender to a receiver may be accomplished in a variety of ways. The process of control of the entanglement that enables the transfer the properties of entanglement from one pair of entangled photons to a second pair of entangled photons is often called entanglement swapping. In the case of using entangled photons for entanglement swapping, one way would be for the sender to control the reception of one or more of the entangled photons. This type control may be accomplished through the use of “interrupt” type components such as shutters or switches to fully block or unblock the reception of those photons. It is also appreciated that controlling the probability of an entanglement swap to transfer “analog” type information from a sender to a receiver may be accomplished through the use of components such as delay lines. In this case, the delay line is controlled to vary the degree of entangled photon overlap and interference on a beam splitter type device. A delay line is typically used to ensure entangled particle overlap on a beam splitter or other device to maximize the probability to achieve a swap of entanglement. For example, an optical delay line is a device that precisely controls the distance and therefore the time of travel through the device. That is, the device can be used to delay the time of arrival of a photon to the output port of the device. By varying the distance the photon travels one controls the time of travel through the device. Delay lines may also be used instead to minimize quantum particle overlap on the beam splitter to disable the entanglement swap. Other types of devices such as variable attenuators may also be used to control in a continuous manner the probability of an entanglement swap. The speed of quantum information has been recently been reported as being greater than or equal to 1.37*10⁴ times the speed of light. See, J. Yin et al., “Lower Bound on the Speed of Nonlocal Correlations without Locality and Measurement Choice Loopholes,” Physical Review Letters 110, 260407 (2013). The benefits of utilizing swapping in the process of quantum communications is that communications would be at the speed of the quantum information even if it is faster than the speed of light which can be beneficial for many applications. Computers and processor are used to control sending and receiving of the information using entanglement swapping.

### Frequency Conversion

Over short transmission distances photons of different frequencies may propagate satisfactorily for quantum communications between the sender and the receiver. However, over longer distances photons at some frequencies may be susceptible to appreciable absorption by the transmission media such as optical fiber, the atmosphere, or water. If the photon is absorbed then the quantum information associated with that photon would be lost. One way to extend the distance over which quantum information may be transmitted through a media is to convert the frequency of the photon carrying the quantum information to a frequency which is less readily absorbed. See Shahriar, et al, “Connecting processing-capable quantum memories over telecommunication links via quantum frequency conversion,” J. Phys. B: At. Mol. Opt. Phys. 45 (2012) 124018. A difficulty in doing this is that conventional frequency conversion methods tend to destroy the quantum information. In the following an invention is described to convert photon frequency while preserving the quantum information associated with that photon. A preferred embodiment is directed to mitigation of transmission loss; specifically towards mitigating the transmission loss of photon based qubits when propagating through absorbing and transmitting media and improving the efficiency for the detection of a photon based qubit. As an example, for a photon based qubit propagating through a typical optical fiber there are minima of attenuation for frequencies corresponding to 1310 nm and 1550 nm wavelengths. Other media such as the atmosphere or underwater would have different transmission properties that make it advisable to convert the frequency of the photon based qubit to minimize absorption and scattering losses along the path from the sender to the receiver.

A further advantage to be attained with frequency conversion is for detection efficiency. Many silicon based photon detectors have peak detection efficiencies at frequencies corresponding to approximately 780 nm wavelengths. However, for example cold atom ensembles or ion quantum systems, have peak emissions at frequencies corresponding to wavelengths for instance at 240 nm for one type of quantum system to 1400 nm for another type of quantum system.

In practice, one means by which frequency conversion of a photon based qubit would be to 1) convert the frequency of the photon based qubit to a frequency optimized for transmission through the media between the sender and the receiver; 2) the receiver would then convert the frequency of the transmitted qubit to a frequency optimized for their detection system.

Generally speaking, transmission of quantum information, or qubits, over long distances or in challenging environments is problematic. To mitigate absorption or scattering losses inherent in long distance transmission of quantum information the choice of an appropriate photon frequency or wavelength for transmission is desirable. Typically frequency/wavelength conversion for lasers is accomplished using the non-linear processes of Sum Frequency Generation (SFG) or Difference Frequency Generation (DFG). To bridge the difference in wavelength between photons suited for fiber-based communication and the photons emitted and absorbed by the atomic memories, two strategies have been demonstrated. One strategy is sum-frequency generation (SFG) and difference-frequency generation (DFG) which are second-order nonlinear processes that must satisfy energy conservation and phase matching conditions. For sum-frequency generation (SFG) the processes involves three frequencies interacting in a non-linear crystal subject to the condition ν₁+ν₂=ν₃ where ν₁ is the frequency of the photon that one wants to change to a more desirable frequency (ν₃) and a pump source at frequency ν₂. Similarly in difference-frequency generation the conservation condition is ν₁−ν₂=ν₃. The nonlinear crystals used typically have phase matching conditions where the momentum and polarization of the light interacting with the crystal must be considered. Typically, in order to preserve quantum state information, which is often encoded in the polarization of a single photon, the wavefunction of that single photon needs to be split into orthogonal polarization components and each component would then be frequency individually before the wavefunctions are recombined for transmission or interaction with some device.

Difference-frequency generation and Sum Frequency Generation typically occur in materials with large χ² such as periodically-poled lithium niobate (PPLN) and conversion efficiencies can approach 100%. Another proven method to bridge the wavelength gap is the third-order nonlinear process of four-wave mixing (FWM). Under the correct conditions a near-IR photon can be converted to a telecom wavelength photon via four-wave mixing using two pump lasers and an atomic ensemble. Cold Rb atoms in a magneto-optical trap (MOT) combined with the correct pump lasers can achieve high efficiency four-wave mixing with very little noise added to the signal. See in this regard, A Quantum Network with Atoms and Photons (QNET-AP), by Ronald E. Meyers, et al., US Army Research Laboratory, Adelphi, Md. 20783, Proc. SPIE 8518, Quantum Communications and Quantum Imaging X, 85180G (Oct. 17, 2012); doi:10.1117/12.97414, herein incorporated by reference.

It is to be appreciated that frequency conversion may also be done to transform the frequency of light from some quantum system that may be difficult to manipulate or detect into another frequency where those operations, such as photon detection are more efficiently accomplished {see L. Ma, et al., “Single photon frequency up-conversion and its applications,” Proc. SPIE 8163 81630N (2011)}. The non-linear media used may be bulk crystals such as BBO or LBO, newer periodically poled media such as periodically poled lithium niobate (PPLN), or even nonlinear interactions in doped optical fibers. Each type of nonlinear media must be engineered to meet the requirements of the particular application, i.e. what frequencies to be converted between, what polarizations and what momentum are to be phase matched. A further concern with many non-linear crystals is their inherent property of birefringence. This birefringence property leads to a delay in the time it takes one polarization to travel across these crystals relative to a different polarization. With respect to quantum frequency conversion, any such delay must be accounted for and corrected or quantum information would be lost in the frequency conversion process. A further motivation to perform quantum frequency conversion would be to mitigate temporal dispersion effects which would typically lead to timing and synchronization problems between a sender and a receiver.

### Quantum Channel

A quantum communications channel, or quantum channel, is a communications channel that can preserve quantum information such as a) the horizontal and vertical amplitudes of a photon polarization based qubit or b) the entanglement between two qubits of quantum information. Examples of quantum channels may include fiber optics for single/entangled photon propagation, and free-space propagation for single/entangled photons. Another distinction between a quantum channel and a classical channel is that information sent via a quantum channel need not travel along a well defined path from the sender to a receiver by some underlying physical carrier particle, e.g., electrons or photons. Quantum teleportation is one example of a quantum channel where the state of an information qubit is transferred directly to the receiver and where the reliever needs two bits of information transferred along a classical channel that contain instructions for the receiver to use on measuring the teleported information qubit that recovers the state of the initial information qubit.

### Quantum Memory/Quantum Repeater

As used herein, a quantum repeater is a quantum memory coupled to at least one other quantum memory. The quantum memories may be composed of atoms, ions, nitrogen-vacancy (NV) diamonds, quantum dots, superconducting quantum interference devices (SQUIDs), or other systems capable of representing and storing quantum states. Quantum memories can be entangled with each other and transfer of information from one such quantum memory node to another quantum memory node is accomplished with Bell measurements and transmission of two bits over classical, i.e. fiber optic, electronic, wireless radio, free-space optical, or quantum communications channels representing the result of the Bell measurement. Quantum memories, as used herein, are typically manipulated using a series of pulses that adjust a particular quantum state within the material that constitutes the quantum memory. See for example Sangouard, et al., “Quantum repeaters based on atomic ensembles and linear optics,” Review of Modern Physics, 83, 1, pp 33-80 (2011). These pulses may include laser, radio frequency, microwave, voltage, current, etc. pulse sequences on the material that makes up the quantum memory to perform reset, “write”, and “read” operations. A reset or initialization operation involves a sequence of pulses that would establish a specified superposition of the quantum state or qubit of the quantum memory. The write operation would consist of a sequence of pulses that allows the quantum memory state to be accessed for an external qubit value to be stored in the quantum memory. Similarly, the read operation is a sequence of pulses that causes the state of the quantum memory to be removed from the quantum memory as a photon or some other quantum particle to be measured. The quantum memories may be composed of atoms, ions, nitrogen-vacancy (NV) diamonds, quantum dots, superconducting quantum interference devices (SQUIDs), or other systems capable of representing and storing quantum states. Quantum memories may be used for applications such as quantum information processing where multiple operations for a quantum algorithm maybe performed on the stored quantum state, entanglement swapping, and storage of entangled photon pairs while maintaining their entanglement. It is to be further noted that quantum memories may store entangled photon pairs and preserve the entanglement of those photon pair. Challenges are presented in the transmission and exfiltration of quantum information, or qubits, over long distances or in challenging environments. To overcome the absorption or scattering losses inherent in long distance transmission of quantum information networks of quantum repeaters have been proposed to entangle remote quantum memories because Quantum information is typically fragile and not readily amplified. Entanglement is established between distant locations though a chain of entanglement swapping processes between nearby entanglement resources that ultimately leave the quantum particles at the ends of the chain entangled with each other even when the probability to directly entangle the two quantum particles is vanishingly small due to cumulative absorption and scattering losses between them. By swapping entanglement between nearby nodes losses due to absorption and scattering are greatly reduced.

### Quantum Teleportation

Quantum teleportation, as used herein, refers to the transfer of quantum information (a qubit) from one location to another without that qubit being transmitted directly through the space between the sender and the receiver. As an example, this can be accomplished by the sender and the receiver each possessing one photon of an entangled photon pair. In other words, they are often said to be sharing the entangled photon pair quantum state. When the sender wishes to send a qubit by quantum teleportation the sender performs a Bell measurement with sender's photon of the shared entangled photon pair and the qubit to be transferred to the receiver. A Bell state measurement with photons may use a beam splitter to interfere the photons and their wavefunctions prior to being measured with photon detectors. The outcome of the Bell measurement will be sent to the receiver over classical channels and consists of two bits. Embodiments of our invention replace the classical channel with quantum channels. When the receiver gets the two bits the receiver then applies to their photon of the of the initially shared entangled photon one of four unitary operations depending upon what the two bits indicate. The sender and receiver each may be said to operate on one half of an entangled photon pair system or in other words half of an entangled quantum system or entangled system. Typically these operations can be represented by a matrix and correspond to the Identity matrix and three other matrices. For example,

$$I = \vert \begin{matrix}1 & 0 \\ 0 & 1\end{matrix} \vert , T 1 = \vert \begin{matrix}1 & 0 \\ 0 & - 1\end{matrix} \vert , T 2 = \vert \begin{matrix}0 & 1 \\ 1 & 0\end{matrix} \vert , and T 3 = \vert \begin{matrix}0 & - 1 \\ 1 & 0\end{matrix} \vert .$$

The matrices are called unitary because they do not change the length, \sqrt{a²+b²}, of the vector that the matrix multiplies. After this operation, the receiver will possess the quantum information of the qubit that the sender transmitted. The unitary operation may be performed by an element comprising, for example, a half wave plate and a quarter wave plate. For example, if the identity matrix is to be applied, nothing is done with the remaining portion of the initially shared entangled state. If the two bits indicate that the matrix T2 is to be applied the half wave plate will perform a ninety degree rotation. If T1 is to be applied, then two suitable quarter waveplate operations will be performed. If T3 is to be applied, then two suitable quarter wave plate operations followed by a suitable half wave plate operation will be performed.

Quantum teleportation may operate in non-line-of-sight (NLOS) configurations where one or both of the entanglement resources are distributed to senders and receivers where there is no direct path from the entangled resource source. In the case of entangled photon transmission in the atmosphere this feature may be enabled for example by using scattering and photons with a wavelength in the ultraviolet wavelength bands. After the distribution of the entanglement resources the teleportation process would proceed as described above. In the current invention the outcome of the Bell measurement (a first measured Bell state) between the information qubit and one photon of an entangled pair of photons can be transferred to the receiver in the following ways (a) the classical channel as described above, (b) generation of a Bell state using a second entangled particle source and appropriate modulators such as electro-optics for photons that is the same as the measured Bell state and transferring this new entangled photon pair to the receiver for measurement to recreate the information qubit, (c) utilizing an entanglement swapping process to transfer the first measured Bell state to the receiver wherein the first measured Bell state is generated using appropriate modulators, (d) utilization of an on-off entanglement swapping information encoding, (e) if an up-conversion Bell state measurement process for photon based teleportation is used then the unconverted photon may be transferred to the receiver on a path that is specific to the measured value; this path could then be interfered with the remaining photon of the first entangled pair on, for instance a hologram where the specific measurement outcome paths are directed towards the hologram and interact with the remaining entangled photon, the interaction then directing the remaining entangled photon towards appropriate waveguides and/or polarization and phase modulators to recreate the information qubit, and other means apparent to those skilled in the art.

As used herein the terminology “Bell measurement” or Bell State measurement” is a joint quantum-mechanical measurement of two qubits or photons that determines the Bell state (one of four possible states) of the two qubits or photons.

As used herein, the terminology Bell state measurement device or element comprises, for example, a beam splitter and at least two detectors.

As used herein, the terminology Bell state “two bit measurement” refers to the two bits of data associated with representing a Bell state measurement outcome.

As used herein, the term “quantum state tomography” refers to a method of verifying a quantum state. Quantum tomography or quantum state tomography refers to the process of reconstructing the quantum state (density matrix) by measurements. Measurements that are tomographically complete; i.e., provide all the information about the state, are sometimes called a quorum.

A photonic element is needed to receive quantum particles and enable interference between the received quantum particles. For example, a photonic element may have two inputs and two outputs. Quantum particles entering such a photonicelement will a) a quantum particle enters at input 1 and a quantum particle enters at input 2 and both particles then exit from output 1, b) a quantum particle enters at input 1 and a quantum particle enters at input 2 and both particles then exit from output 2, c) a quantum particle entering at input 1 will exit output 1 and a quantum particle entering input 2 will exit output 2, or d) a quantum particle entering input 1 will exit output 2 and a quantum particles entering input 2 will exit output 1. This allows for two alternative but indistinguishable ways to measure a joint detection of two input quantum particles. An optical 50/50 beam splitter is an example of a component that may be used as a photonic element for entangled and non-entangled photons. The beam splitter is a traditional element to enable interference between two quantum particle probability amplitudes. However, there are many other photonic elements used individually or in combination that are not traditionally described as beam splitters but can enable interference. These include but are not limited to, optical elements for photons such as half-silvered mirrors, pellicle beam splitters, 2×2 fiber couplers, N×M fiber couplers, etched photonic chips, waveguides, polarizing beam splitters, Wollaston prisms, Glan-Thomson prisms, holograms, photonic crystals, a thin film coating of silver on glass, and the like. It must be noted that when only a single input, i.e. a quantum particle entering at input 1 or input 2, is provided to an interference element the interference or photonic element then acts as a beam splitter where the quantum particle probability amplitude is directed into two or more output paths, e.g. output 1 or output 2. It is to be further appreciated that charged or neutral quantum particles such as neutral atoms, ions, electrons, neutrons, may require other interference or photonic elements that are appropriate for those types of quantum particles.

With respect to the terminology “entanglement swapping,” a simplified example is if a first particle or photon is entangled with a second particle and the second particle is teleported to a third particle (or photon), afterwards, the first particle (or photon) is entangled with the third particle (or photon).

The terminology “computer” as used herein means processor, microprocessor, CPU, multiprocessor, personal computer, quantum computer, or any device which has the capability of performing the functions of a computer. The terminology “processor” as used herein means as used herein means computer, microprocessor, CPU, multiprocessor, personal computer or any device which has the capability of performing the functions of a computer.

As used herein the terminology “unitary transformation device” relates to a device that performs a unitary transformation operation on the entangled state. As an example, the identity function is trivially a unitary operator and rotations in R2 are a nontrivial example of unitary operators. Rotations do not change the length of a vector or the angle between 2 vectors.

The terminology “interrupt” as used herein relates to a switch, shutter, electronic, optical, or other delay, or any device which has the capability to start or stop a signal.

As used herein the terminology “sender” relates to a “transmitter” or “broadcaster” of information.

Measurement of a photon by a detector typically entails the absorption of the photon by a photo-sensitive material. The photo-sensitive material would then typically produce an excess charge or change in current that would be recorded as a detection of a photon. As such, some embodiments of the current invention illustrated in FIGS. 18-23 would only require that the two photons be absorbed after interaction on the beam splitter to complete the swap of entanglement to the remaining two photons. It should be further appreciated that communication of data from a sender to a receiver in the presence of noise can be better represented by correlation measurements between two detectors than measurement by either of the detectors separately. Single photon measurements may be subject to a variety of noise from sources such as quantum noise, stray light scattering, and detector noise. Joint detection or coincidence measurements which include correlation measurements and Bell state measurements, etc., largely reduce the effects of this type of noise that would otherwise degrade the data, signal or message that would be communicated. While it is not generally appreciated in this area, corrections can also be made to the coincidence measurements by first determining the background level of coincidence detections and compensating for this background by incorporating the single photon measurements as described in R. Meyers, et al., U.S. patent application Ser. Nos. 14/303,078 and 14/461,625, herein incorporated by reference. Interpretations of measurements between at least two detectors such as in coincidence measurements can be improved by monitoring the single photon measurement counts and scaling by incorporating the single photon counts. For example, for photon number resolving detectors, the subtraction of the product of a relevant time average of the single photon counts from the relevant time average of the product of the single photon counts may improve the fidelity of the information received by the receiver that was sent by the sender. Also periods of high coincidence measurements with low single photon counts may indicate periods where there is low background noise and where signals can be received with higher fidelity.

As used herein the terminology correlated means that the correlation value is non-zero, i.e. positive or negative, and uncorrelated means that the correlation value is zero.

The foregoing description is illustrative of particular embodiments of the invention, but is not meant to be a limitation upon the practice thereof. The following claims, including all equivalents thereof, are intended to define the scope of the invention.

1. A system for communicating data comprising:
a sender subsystem;
a receiver subsystem;
at least one data input configured to input data into the sender subsystem; at least one entangled photon source configured to output entangled photon pairs; first photons of the pairs of entangled photons outputted by the at least one photon source being processed by one of the sender or receiver subsystem; second photons of the pairs of entangled photons being processed by the other of the sender or receiver subsystem;
a photonic element configured to receive the first photons of the pairs of entangled photons and enable interference therebetween;
at least one absorber configured to absorb the first photons of the pairs of entangled photons after passage through the photonic element, the absorbance of the first photons of the pairs of entangled photons operating to transfer the properties of the entanglement to the second photons of the pairs of entangled photons; and
a Bell state measurement element operatively associated with the receiver subsystem; the Bell state measurement element configured to measure the second photons of the pairs of entangled photons.

2. The system of claim 1 wherein one of the emission of pairs of entangled photons by the at least one entangled photon source or the reception of first photons of the pairs of entangled photons by the photonic element is controllable to enable the transmission of a message.

3. The system of claim 2 wherein the photonic element comprises a first beam splitter and wherein the at least one absorber comprises at least one detector, the at least one detector configured to measure the Bell state of the first photons of the pairs of entangled photons passing through the first beam splitter, the measured Bell state correlating to the Bell state measured by the Bell state measurement element operatively associated with the receiver.

4. The system of claim 2 further comprising an interrupt operatively associated with the photonic element configured to prevent one or more of the first photons of the pairs of entangled photons from being inputted into the photonic element; the interrupt being adapted to be controlled by an operator or computer to transmit an encoded message.

5. The system of claim 2 wherein the interrupt is a shutter device which is configured to prevent photons from being inputted into a photonic element, the shutter device being adapted to be controlled by one of an operator or computer to transmit an encoded message.

6. The system of claim 1 further comprising at least one processor, and wherein the sender subsystem further comprises at least one processor operatively associated with the interrupt and the at least one detector, and the receiver subsystem comprises at least one processor operatively associated with the Bell state measurement element.

7. The system of claim 1 wherein the sender subsystem and receiver subsystem each further comprises at least one delay element, the at least one delay element configured to delay photons such that photons emitted from the at least one entangled photon source at different times are inputted synchronously into the photonic element operatively associated with the sender and the Bell state measurement element operatively associated with the receiver.

8. The system of claim 1 wherein the at least one entangled photon source comprises first and second entangled photon sources, the first entangled photon source being operatively associated with the sender subsystem and the second entangled photon source being operatively associated with the receiver subsystem, and wherein the at least one absorber comprises at least one detector configured to measure the Bell state, and wherein the measurement of the Bell state of the first photons of the pairs of entangled photons occurs at substantially the same time as the measurement by the Bell state measurement element operatively associated with the receiver subsystem; and wherein delay elements are positioned within at least one of the sender or receiver subsystems to ensure coincidence of measurements of the respective Bell states.

9. The system of claim 1 wherein the sender subsystem further comprises a second beam splitter operatively associated with the at least one entangled photon source, the second beam splitter configured to split the first photons into first and second paths, the first and second paths operating to pass photons from the second beam splitter to the first beam splitter, the second path comprising a first delay element, the first delay element being configured such that first photons from the first and second paths enter the first beam splitter synchronously; and wherein the receiver subsystem further comprises a third beam splitter operatively associated with the at least one entangled photon source the third beam splitter configured to split the second photons into third and fourth paths, the third and fourth paths operating to pass photons from the third beam splitter to the Bell state measurement element operatively associated with the receiver subsystem, the fourth path comprising a second delay element, the second delay element being configured such that second photons from the third and fourth paths enter the Bell State measurement element synchronously.

10. The system of claim 1 wherein the sender subsystem further comprises a second beam splitter and wherein the second beam splitter is configured to split the second photons of the entangled photon pairs into first and second paths, the second path including a delay element, the delay element configured to delay photons such that first photons from the first and second paths enter the first beam splitter synchronously

11. A system for communicating data comprising:
a transmitter subsystem;
a receiver subsystem;
at least one data input configured to input data into the transmitter subsystem; first, second and third entangled photon sources configured to output entangled photon pairs; first photons of the pairs of entangled photons outputted by the first, second and third entangled photon sources being processed by one of the transmitter or receiver subsystems; second photons of the pairs of entangled photons outputted by the first, second and third entangled photon sources being processed by the other of the transmitter or receiver subsystems;
a first Bell state measurement element operatively associated with the transmitter; the first Bell state measurement element configured to measure the first photons of the pairs of entangled photons from the first and second entangled photon sources;
a second Bell state measurement element operatively associated with the receiver system; the Bell state measurement element configured to measure the second photons of the pairs of entangled photons from the first and second entangled photon sources;
a data source for the input of information;
a third Bell state measurement element operatively associated with the transmitter, receiver and the data source, the third Bell state measurement element operative to measure photons representing data from the data source in conjunction with the one of pairs of photons from the third photon source;
a unitary transform device operatively associated with the receiver subsystem, the unitary transform device configured to receive the other of the pairs of photons from the third entangled photon source and to output photons representing data from the data source; and
an output measurement element operatively associated with the receiver; the output measurement element configured to measure the outputted photons from the unitary transform device representing data from the data source

12. The system of claim 11 further comprising at least one processor operatively connected to the unitary transform device and the second Bell state measurement element wherein upon being measured at the Bell state measurement element the entanglement is transferred from the first of the first photons of the pairs of entangled photons from the first and second photon sources to the second photons of the pairs of entangled photons from the first and second photon sources, and wherein the second Bell state measurement element measures the results of the swapped entanglement and transfers the results to the at least one processor which supplies the Bell state measured by the second Bell state measurement element to the unitary transform device which is used to output data from the data source.

13. The system of claim 11 wherein the photons from the first, second and third entangled photon sources are synchronously emitted.

14. The system of claim 11 further comprising at least one processor and an interrupt controlled by the at least one processor configured to prevent one or more of the first photons of the pairs of entangled photons from being measured by the first Bell state measurement device, the interrupt being operable to send an encoded message from the sender subsystem to the receiver subsystem.

15. A system for communicating data comprising:
a transmitter subsystem;
a receiver subsystem;
a data source configured to input information in the form of qubits; the information to be transmitted from the transmitter to the receiver subsystem;
at least one entangled photon source configured to output entangled photon pairs; first photons of the at least one entangled photon sources being inputted into the transmitter subsystem and second photons of the at least one entangled photon source being inputted into to the receiver subsystem;
a first photonic element having two inputs; one input configured for input of a qubit from the data source and one input configured for input of a first photons of pairs of entangled photons from the at least one entangled photon source; the first photonic element having two outputs;
first and second Bell state measurement elements operatively associated with the transmitter subsystem, each having first and second inputs and each of the first inputs operatively connected to one of the output ports of the first photonic element; the second inputs of the first and second Bell state measurement elements configured to receive first photons from the at least one entangled photon source;
at least one processor operatively associated with the receiver subsystem; and
at least one receiver Bell state measurement element operatively associated with the receiver subsystem; the at least one receiver Bell state measurement element configured to receive as an input at least one of the second photons of the pairs of photons from the at least one entangled photon source and provide a measurement to the at least one processor;
whereby through the process of entanglement swapping, information is transferred from the first photons to the second photons of the pairs of photons from the at least one entangled photon source, and though measurement by the at least one receiver Bell state measurement element, information is transferred from the transmitter to the receiver subsystem.

16. The system of claim 15 where the first photonic element is a beam splitter and wherein the first and second Bell state measurement devices each comprise at least one beam splitter and at least two detectors.

17. The system of claim 15 wherein the receiver subsystem comprises a unitary transform device operatively associated with the at least one processor, the unitary transform device configured to receive as input second photons of the pairs of photons from the at least one entangled photon source; the second photons having swapped entanglement from the first photons of the pairs of photons from the at least one entangled photon source, such that qubits of data are transferred from the transmitter subsystem to the receiver subsystem through the process of swapped entanglement.

18. The system of claim 15 further comprising at least one unitary transform device operatively associated with the at least one processor, the at least one processor being configured to receive input from the at least one receiver Bell state measurement element, and wherein the at least one entangled photon source configured to output entangled photon pairs comprises first, second and third entangled photon sources; first photons of the first entangled photon source being inputted into the photonic element and the second photons of the first entangled photon source being inputted into a unitary transform device, the unitary transform device being configured to enable the output of the information contained in the qubit in conjunction with the at least one processor.

19. The system of claim 15 further comprising a unitary transform device, and wherein the at least one entangled photon source configured to output entangled photon pairs comprises first, second and third entangled photon sources,
second photons of the pairs of entangled photons from the first entangled photon source being inputted into the unitary transform device;
first photons of the second entangled photon source being inputted into the first Bell state measurement element and the second photons of the second entangled photon source being inputted into the receiver Bell state measurement device, and
first photons of third entangled photon source being inputted the second Bell state measurement element and second photons of the third entangled photon source being inputted into the at least one receiver Bell State measurement element;
whereby upon measurement at the second Bell state measurement element of the first photons of the first entangled photon source and the first photons of the third entangled photon source; entanglement is swapped to the second photons of the first entangled photon source at the unitary transform device and the second photons of the second and third entangled photon sources inputted into the receiver Bell state measurement element; and the unitary transform device processes the information contained in the second photons from the first entangled photon source in conjunction with information outputted from the receiver Bell state measurement device to derive the information contained in the qubits.

20. The system of claim 15 further comprising at least one delay element controlled by the at least one processor, and wherein the first, second and receiver Bell state measurement devices are synchronously operated, and wherein the at least one processor comprises at least one first processor operatively associated with the transmitter subsystem and at least one second processor operatively associated with the receiver subsystem and wherein the first and second processors operate to control the at least one delay element.
